(19) United States
(12) Patent Application Publication
(10) Pub. No.: US 2026/0300062 A1
(43) Pub. Date: Oct. 1, 2026

(54) SYSTEM AND METHOD FOR FACILITATING DIAGNOSTICS RELATED TO A USER DEVICE

(71) Applicant: Apkudo, Inc., Baltimore, MD (US)

(72) Inventor: Joshua S. MATTHEWS, Baldwin, MD (US)

(21) Appl. No.: 19/578,516

(22) Filed: Mar. 25, 2026

Related U.S. Application Data
(60) Provisional application No. 63/779,804, filed on Mar. 28, 2025.

(51) Int. Cl. G06F 11/00; G06F 11/22

(52) U.S. Cl. CPC G06F 11/008; G06F 11/2284

(57) ABSTRACT

A user device includes a processor configured to execute instructions that cause the user device to obtain device-related information from a subsystem while operating in a post-boot environment. The processor is further configured to predict, based on the device-related information, an anomaly with respect to a first subsystem while operating in the post-boot environment. The processor is further configured to store the predicted anomaly as device anomaly information in a non-volatile memory portion accessible in a pre-boot environment where a pre-boot diagnostic application executes. The processor is further configured to obtain, via the pre-boot diagnostic application, the device anomaly information from the non-volatile memory portion while running in the pre-boot environment.

### CROSS-REFERENCE TO RELATED APPLICATIONS

This application claims priority to U.S. Provisional Application No. 63/779,804, titled SYSTEM AND METHOD FOR FACILITATING DIAGNOSTICS RELATED TO A USER DEVICE, filed Mar. 28, 2025, which is hereby incorporated by reference in its entirety.

### FIELD OF INVENTION

The present disclosure relates to diagnostic systems for electronic devices, and more particularly to systems and methods for predicting device anomalies through behavioral analysis of subsystem interactions, storing predicted anomalies in protected non-volatile memory that persists through factory resets, and retrieving diagnostic information in a pre-boot environment.

### BACKGROUND

User devices, such as smartphones, tablets, and other portable electronic devices, have become integral tools for communication, productivity, and entertainment. As these devices are used extensively in daily activities, they may encounter various anomalies or issues that affect their performance and functionality. Diagnosing such anomalies can be challenging, particularly when a failing subsystem does not directly report its own malfunction. Many traditional diagnostic methods rely on error codes, system logs, or user-reported symptoms to determine the cause of an anomaly. However, some anomalies occur without triggering an explicit error message, making them difficult to detect through conventional approaches. For example, a touchscreen that intermittently fails to register touch signals may not generate an explicit error code, and a battery that drains unexpectedly may not report a fault even when abnormal power consumption patterns suggest an underlying issue.

Traditional hardware tests, such as component self-tests or built-in diagnostics, have limitations in their ability to detect certain types of anomalies. These tests often check whether a component is functioning at a given moment but may fail to recognize problems that emerge under specific conditions or after prolonged use. Some anomalies arise gradually as wear-and-tear affects performance over time, making them difficult to diagnose through a single point-in-time test. Without mechanisms to analyze how different subsystems interact over time, many problems may remain undiagnosed until complete failure occurs.

When users or technicians encounter persistent anomalies, they often attempt various troubleshooting steps to restore normal operation. If simpler fixes, such as restarting the device or clearing temporary data, fail to resolve the problem, a factory reset is often performed. A factory reset can be a useful troubleshooting tool, but it also erases user data, system logs, and settings, which can make diagnosing the original problem more difficult. For example, a user may reset their device in response to frequent application crashes, slow performance, or unresponsive behavior, but by doing so, they may inadvertently erase diagnostic data that could have provided insight into the underlying issue.

Factory resets are also commonly used by service technicians to eliminate software conflicts, third-party applications, or custom settings that may be contributing to a malfunction. Additionally, specialized diagnostic tools may require the device to be in its factory-default state to function properly. While factory resets help create a clean testing environment, they also pose challenges in preserving diagnostic data across resets. Without mechanisms to securely store and retrieve diagnostic information, valuable context about how and why a failure may have occurred can be lost.

Some user devices may maintain an activity log within non-volatile memory that is preserved during a factory reset. This activity log may include user actions or actions performed by components of the user device. However, such activity logs may also include personally identifiable information or other sensitive information, which may be available to vendors performing repairs, raising privacy concerns. Balancing the preservation of diagnostic information with user privacy presents ongoing challenges in the field of device diagnostics.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a user device is provided. The user device includes a processor configured to execute instructions that cause the user device to obtain device-related information from a subsystem of the user device while the user device is operating in a post-boot environment. The processor is further configured to execute instructions that cause the user device to predict, based on the device-related information from the subsystem of the user device, an anomaly with respect to a first subsystem of the user device while the user device is operating in the post-boot environment. The processor is further configured to execute instructions that cause the user device to store the predicted anomaly as device anomaly information in a portion of non-volatile memory of the user device, the non-volatile memory portion being accessible in a pre-boot environment in which a pre-boot diagnostic application executes. The processor is further configured to execute instructions that cause the user device to obtain, via the pre-boot diagnostic application, the device anomaly information from the non-volatile memory portion while the user device is running in the pre-boot environment.

According to other aspects of the present disclosure, the user device may include one or more of the following features. The subsystem may provide input to, process outputs from, or respond to the first subsystem. The user device may be further caused to process an output of the first subsystem, the output provided as an input to the subsystem, and the device-related information may be obtained based on the processing of the input received from the first subsystem at the subsystem. The user device may be further caused to detect, based on the processed output, an artifact in the input to the subsystem, wherein the device-related information is obtained based on the detection of the artifact. The device-related information may comprise an output from the subsystem, and the user device may be further caused to determine an inconsistency between the output of the subsystem and an action or an inaction of the first subsystem, wherein the anomaly with respect to the first subsystem is predicted based on the determined inconsistency while the user device is running in the post-boot environment. The user device may be further caused to determine a difference between a first action pattern or a first inaction pattern and a second action pattern or a second inaction pattern related to the first subsystem, wherein the first action pattern or the first inaction pattern reflects the most recent actions or most recent inactions related to the first subsystem, and the second action pattern or the second inaction pattern reflects prior actions or prior inactions related to the first subsystem, wherein the anomaly with respect to the first subsystem is predicted based on the device-related information and the determined difference while the user device is running in the post-boot environment. The device-related information may comprise an output from the subsystem, and the anomaly with respect to the first subsystem may be predicted based on the output of the subsystem and the determined difference while the user device is running in the post-boot environment. The output of the subsystem may indicate a potential cause of the determined difference, wherein the anomaly with respect to the first subsystem is predicted based on the potential cause indication and the determined difference while the user device is running in the post-boot environment. The subsystem may be a subsystem different from the first subsystem for which the anomaly is predicted. The subsystem may comprise the first subsystem for which the anomaly is predicted. The user device may be further caused to perform an automated test on the user device while obtaining the device anomaly information from the non-volatile memory portion in the pre-boot environment. The user device may be further caused to reduce overall power consumption via a power management subsystem while the user device is running in the pre-boot environment such that most components of the user device are unpowered. The user device may be further caused to provide, via a power management subsystem, power to the non-volatile memory portion while a second non-volatile memory portion and most components remain unpowered, enabling retrieval of the device anomaly information from the non-volatile memory portion. The user device may be further caused to detect an auxiliary device while the non-volatile memory portion and most components remain unpowered, wherein, upon detecting the auxiliary device, power is provided to the non-volatile memory portion while the second non-volatile memory portion and most components remain unpowered, enabling retrieval of the device anomaly information. The auxiliary device may comprise an auxiliary memory, and the user device may be further caused to store, via the pre-boot diagnostic application, the device anomaly information on the auxiliary memory while running in the pre-boot environment. The user device may be further caused to detect installation or retrieval of an application for installation on the user device, obtain, in response, a predictive-analysis-related update related to the application from a remote computer system via a network, and predict the anomaly based on the device-related information and the predictive-analysis-related update while running in the post-boot environment.

According to another aspect of the present disclosure, a method of facilitating diagnostics related to a user device is provided. The method is implemented by a processor executing computer program instructions. The method includes obtaining device-related information from a subsystem of the user device while the user device is operating in a post-boot environment. The method further includes predicting, based on the device-related information, an anomaly in a first subsystem of the user device while the user device is running in the post-boot environment. The method further includes storing the predicted anomaly as device anomaly information in a portion of non-volatile memory accessible in a pre-boot environment in which a pre-boot diagnostic application executes. The method further includes obtaining, via the pre-boot diagnostic application, the device anomaly information from the non-volatile memory while the user device is running in the pre-boot environment.

According to other aspects of the present disclosure, the method may include one or more of the following features. The method may further comprise processing an output of the first subsystem that is provided as an input to the subsystem, wherein the device-related information is obtained from the processing of the output received from the first subsystem at the subsystem. The device-related information may comprise an output from a subsystem, and the method may further comprise determining an inconsistency between the output of the subsystem and an action or an inaction of the first subsystem, wherein the anomaly with respect to the first subsystem is predicted based on the determined inconsistency while the user device is running in the post-boot environment. The device-related information may comprise an output from the subsystem that indicates a potential cause of a determined difference, and the method may further comprise determining a difference between a first action pattern or a first inaction pattern related to the first subsystem and a second action pattern or a second inaction pattern related to the first subsystem, wherein the first action pattern or first inaction pattern reflects the most recent actions or most recent inactions related to the first subsystem, and the second action pattern or second inaction pattern reflects prior actions or prior inactions related to the first subsystem, and wherein the anomaly with respect to at least the first subsystem is predicted based on the potential cause and the determined difference while the user device is running in the post-boot environment.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a system for facilitating diagnostics related to a user device, in accordance with an embodiment.

FIG. 2 illustrates a system depicting a device diagnostics use case, according to aspects of the present disclosure.

FIG. 3 illustrates a flowchart of a method of facilitating diagnostics related to a user device, according to an embodiment.

FIG. 4 illustrates a flowchart of a method of obtaining device anomaly information from a portion of non-volatile memory of a user device, in accordance with an embodiment.

FIG. 5 illustrates a flowchart of a method of facilitating diagnostics related to a user device via predictive-analysis-related updates, according to aspects of the present disclosure.

FIG. 6 illustrates a block diagram of a computing device that may be used to implement a user device, server, or auxiliary device described herein, in accordance with one or more embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for facilitating diagnostics related to a user device, such as a smartphone, tablet, or other electronic device. User devices may encounter various anomalies or issues during operation that require diagnostics to ensure proper performance. In some instances, when a user device is returned for repair or service, a factory reset may have been performed by the user in an attempt to resolve an issue, or a factory reset may be performed by a technician as part of a repair process. A factory reset may clear non-default data from the user device, which may make accurate diagnosis of the user device more challenging after the factory reset has been performed.

The systems and methods described herein may address challenges associated with diagnosing user devices by predicting device anomalies through behavioral analysis while the user device is operating in a post-boot environment. In some cases, a behavioral analysis component may analyze how different subsystems of the user device interact and respond to one another under various conditions. The behavioral analysis component may monitor signals from subsystems that provide input to, process outputs from, or respond to other subsystems under analysis. When a subsystem deviates from expected behavior, such deviation may indicate an underlying anomaly. By leveraging information from multiple subsystems, the systems and methods described herein may enable detection of anomalies that might otherwise go unnoticed until complete failure occurs.

In some cases, the systems and methods described herein may store data related to a detected or predicted anomaly in a designated portion of non-volatile memory that remains intact even if the user device undergoes a factory reset. Storing anomaly data in such a protected memory portion may ensure that diagnostic information is preserved and accessible when needed, rather than being erased along with user data during a factory reset. The stored anomaly data may include details about an affected subsystem, a nature of the anomaly, and behavioral patterns leading up to the anomaly.

In some cases, when the user device enters a pre-boot environment, a diagnostic application may retrieve stored anomaly information from the protected non-volatile memory portion. Retrieval of anomaly information in the pre-boot environment may allow for assessment of device health before a full operating system loads. Such capability may enable technicians or automated systems to assess device health even if a user has performed a factory reset on the user device. By making anomaly data available in a structured manner, the systems and methods described herein may improve troubleshooting for user devices, including user devices that have undergone a factory reset.

In some cases, the systems and methods described herein may encrypt diagnostic data to protect user privacy. Encryption may be performed using a public/private keypair, where a private key is stored on the user device and deleted upon factory reset, ensuring that previous user data cannot be accessed by a subsequent user. In some cases, a dual key encryption approach may be employed, where one key allows a secure cloud service to decrypt and analyze behavioral data, and a second on-device keypair may be generated with each factory reset or for each user, allowing inspection of behavioral data on a per-user basis. Such encryption approaches may ensure that user privacy is protected while maintaining integrity of diagnostic insights.

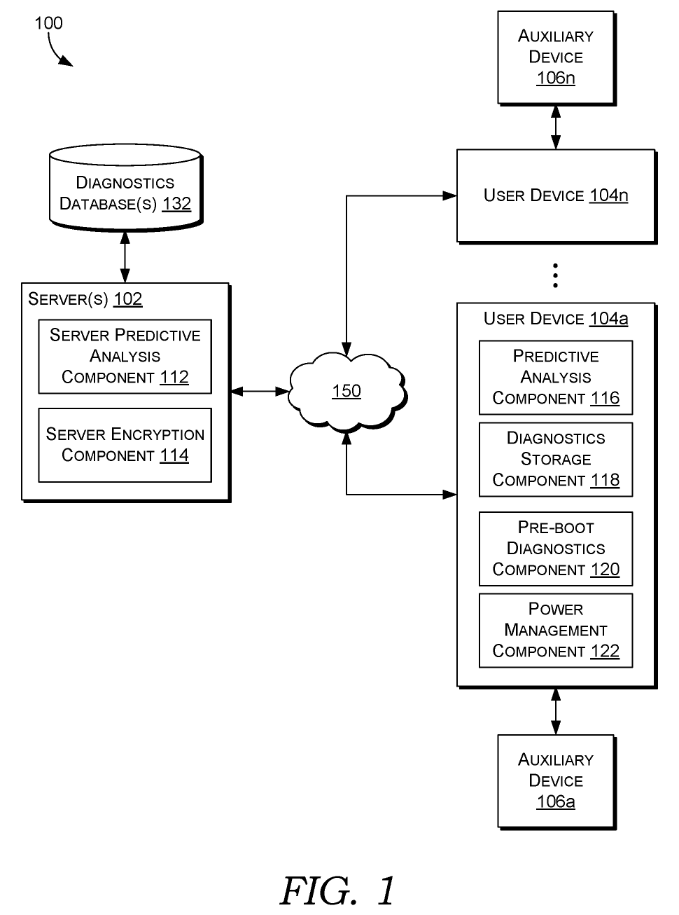

Referring to FIG. 1, a system 100 for facilitating diagnostics related to a user device is illustrated in accordance with one or more embodiments. The system 100 may include a server 102, a user device 104a, a user device 104n, an auxiliary device 106a, an auxiliary device 106n, a diagnostics database 132, and a network 150. The network 150 may interconnect various components of the system 100 to enable communication and data exchange between the server 102, the user devices 104a and 104n, and other components of the system 100. The network 150 may comprise wired or wireless communication technologies, including Ethernet, fiber optics, coaxial cable, WiFi, Bluetooth, near field communication, or other communication technologies.

With continued reference to FIG. 1, the server 102 may include a server predictive analysis component 112 and a server encryption component 114. The server predictive analysis component 112 may manage predictive-analysis-related updates, such as behavioral or predictive specification files, supplemental behavioral or predictive specification files, or other updates. In some cases, the server predictive analysis component 112 may push one or more predictive-analysis-related updates to the user devices 104a and 104n via the network 150 to update respective predictive analysis components or other components of the user devices 104a and 104n. In some cases, the server predictive analysis component 112 may detect installation or download of one or more applications on the user device 104a or the user device 104n, and, responsive to such detection, may cause one or more predictive-analysis-related updates related to the installed or downloaded applications to be pushed to the respective user device.

The server encryption component 114 may handle encryption-related operations for the system 100. In some cases, the server encryption component 114 may securely store public keys associated with individual user devices. The server encryption component 114 may enable the server 102 to decrypt and analyze diagnostic data that has been encrypted by the user devices 104a and 104n. As further shown in FIG. 1, the diagnostics database 132 may be connected to the server 102 and may store diagnostic information, public keys, and other data associated with user devices in the system 100. The diagnostics database 132 may enable the server 102 to retain long-term access to diagnostic data, allowing authorized services to analyze behavioral trends over time.

The user device 104a and the user device 104n may each comprise electronic devices such as smartphones, tablets, personal computers, smart watches, extended reality devices, Internet of Things devices, laptop computers, mobile phones, wearable computers, personal digital assistants, or other computing devices. Users may utilize the user devices 104a and 104n to interact with the server 102, the auxiliary devices 106a and 106n, or other components of the system 100 via the network 150.

The auxiliary device 106a may be connected to the user device 104a, and the auxiliary device 106n may be connected to the user device 104n. The auxiliary devices 106a and 106n may each comprise an auxiliary memory for storing device anomaly information obtained from a respective user device. In some cases, the auxiliary devices 106a and 106n may be storage devices such as USB drives, external hard drives, computers, other mobile devices, or cloud-based diagnostic systems. The auxiliary devices 106a and 106n may store computer program instructions for automated tests that are executed when a user device establishes connection with a respective auxiliary device. In some cases, the auxiliary devices 106a and 106n may be detected via physical connection, such as USB or other ports, or via proximity-based communication, such as Bluetooth, NFC, or other short-range wireless technologies. In some cases, the auxiliary devices 106a and 106n may obtain encrypted diagnostic data from respective user devices and transmit the encrypted diagnostic data to the server 102 via the network 150 for decryption.

With continued reference to FIG. 1, the user device 104a may include a predictive analysis component 116, a diagnostics storage component 118, a pre-boot diagnostics component 120, and a power management component 122. While the user device 104a is shown with these internal components in FIG. 1, the user device 104n may include similar internal components and functionality as the user device 104a.

The predictive analysis component 116 may obtain device-related information related to the user device 104a via one or more subsystems of the user device 104a. In some cases, the predictive analysis component 116 may obtain the device-related information from the subsystems, work with the subsystems to obtain the device-related information, or otherwise obtain the device-related information via the subsystems. In some cases, the predictive analysis component 116 may comprise at least a part of the subsystems. In some cases, the predictive analysis component 116 may comprise at least a subsystem separate from and external to the subsystems, where the predictive analysis component 116 obtains the device-related information from the subsystems.

The predictive analysis component 116 may predict, based on the device-related information, one or more device anomalies with respect to at least a first subsystem of the user device 104a. In some cases, the device-related information may be obtained, and the device anomalies may be predicted based on the device-related information while the user device 104a is running in a post-boot environment in which an operating system of the user device 104a executes. The device-related information may comprise outputs from the subsystems, outputs of the first subsystem, information indicating artifacts in the first subsystem outputs, information indicating errors, information indicating potential causes of artifacts, anomalies, errors, or pattern changes, or other device-related information. The predicted device anomalies may comprise software-related issues, hardware-related issues, or other anomalies with respect to the first subsystem of the user device 104a, such as user interface anomalies, camera anomalies, touch screen anomalies, or other anomalies.

As further shown in FIG. 1, the diagnostics storage component 118 may cause the predicted device anomalies to be stored as device anomaly information in a portion of non-volatile memory of the user device 104a. In some cases, the non-volatile memory portion may be accessible in a pre-boot environment in which a pre-boot diagnostic application executes. In some cases, the non-volatile memory portion may be a restricted memory portion such that information stored on the non-volatile memory portion is preserved during a factory reset of the user device 104a. In some cases, the user device 104a may be programmed to restrict read access to the non-volatile memory portion, such as preventing read access by any application or user while the user device 104a is in a post-boot environment, or limiting read access to applications or users with root permission. In some cases, the user device 104a may be programmed to restrict write access to the non-volatile memory portion, such as preventing write access by any application or user while the user device 104a is in a post-boot environment, or limiting write access to applications or users with root permissions.

In some cases, the diagnostics storage component 118 may encrypt device anomaly information or other information such that the device anomaly information is stored as an encrypted version on the non-volatile memory portion of the user device 104a. The device anomaly information or other information to be stored on the non-volatile memory portion may be encrypted in accordance with one or more encryption schemes such as a public key encryption scheme, a symmetric key encryption scheme, or other encryption schemes.

With continued reference to FIG. 1, the pre-boot diagnostics component 120 may comprise a diagnostic application, such as a pre-boot diagnostic application or other diagnostic application. The pre-boot diagnostics component 120 may obtain the device anomaly information or other stored information from the non-volatile memory portion via the diagnostic application in the pre-boot environment. When a vendor or other entity uses the pre-boot diagnostics component 120 to obtain the device anomaly information from the non-volatile memory portion of the user device 104a, the device anomalies of the device anomaly information may already be predicted in the context of the post-boot environment in which the device anomalies occurred and during, at, or around the time at which the device anomalies occurred. The predicted device anomalies may be used to diagnose or supplement diagnostics performed on the user device 104a by the vendor.

In some cases, the pre-boot diagnostics component 120 may detect the auxiliary device 106a while the non-volatile memory portion and most components of the user device 104a are unpowered. The auxiliary device 106a may be detected as being physically connected to the user device 104a or as being in proximity to the user device 104a, such as within a Bluetooth range or other proximity. In some cases, the pre-boot diagnostics component 120 may perform one or more automated tests on the user device 104a while obtaining device anomaly information from the non-volatile memory portion in the pre-boot environment and while providing the device anomaly information to a destination such as the auxiliary device 106a.

The power management component 122 may provide power to components of the user device 104a and may manage power distribution during various operating states of the user device 104a. In some cases, the power management component 122 may provide substantially less overall power to components of the user device 104a while the user device 104a is running in a pre-boot environment. Pursuant to power management by the power management component 122, most components of the user device 104a may be unpowered when the user device 104a is running in the pre-boot environment. In some cases, substantially more components of the user device 104a may be unpowered than components of the user device 104a that are powered while the user device 104a is running in the pre-boot environment.

In some cases, the power management component 122 may provide power to the non-volatile memory portion of the user device 104a while another portion of the non-volatile memory and most components of the user device 104a are unpowered to enable information to be obtained from the non-volatile memory portion. Responsive to the user device 104a being turned on, the power management component 122 may power the non-volatile memory portion while another portion of the non-volatile memory and most components of the user device 104a remain unpowered. In some cases, responsive to detection of the auxiliary device 106a by the pre-boot diagnostics component 120, the power management component 122 may provide power to the non-volatile memory portion while another non-volatile memory portion and most components of the user device 104a remain unpowered. In some cases, the power management component 122 may power the non-volatile memory portion and components of the user device 104a that are used for operations related to obtaining and transmitting device anomaly information from the non-volatile memory portion to a destination, operations related to performing power management, and operations related to one or more automated tests to be performed in the pre-boot environment, while other components of the user device 104a remain unpowered.

The user device described herein may take various forms depending on the particular application and use case. In some cases, the user device may take the form of a personal computer (PC). In some cases, the user device may take the form of a smart phone. In some cases, the user device may take the form of a smart watch. In some cases, the user device may take the form of an extended reality (XR) device, which may include virtual reality devices, augmented reality devices, or mixed reality devices. In some cases, the user device may take the form of an Internet of Things (IoT) device. In some cases, the user device may take the form of a laptop computer. In some cases, the user device may take the form of a tablet computer. In some cases, the user device may take the form of a wearable computer. In some cases, the user device may take the form of a personal digital assistant (PDA). In some cases, the user device may take the form of a satellite positioning system device, such as a global positioning system (GPS) device. The systems and methods described herein may be applicable to any of these user device form factors, as each form factor may include subsystems that interact with one another and may benefit from behavioral analysis and anomaly prediction as described herein.

The auxiliary device described herein may be implemented in various configurations depending on the particular diagnostic application and operational requirements. In some cases, the auxiliary device may be implemented as a dedicated diagnostic tool that is designed and configured for the purpose of retrieving diagnostic data from user devices and performing diagnostic operations. A dedicated diagnostic tool may include specialized hardware and software components that are optimized for interfacing with user devices in pre-boot environments and for processing device anomaly information.

In some cases, the auxiliary device may be implemented as a general-purpose computer with diagnostic software. The general-purpose computer may be a desktop computer, a laptop computer, or another computing device that executes diagnostic software applications capable of communicating with user devices, retrieving device anomaly information from non-volatile memory portions of user devices, and processing or analyzing the retrieved diagnostic data. The diagnostic software may be installed on the general-purpose computer and may provide a user interface for technicians or other users to interact with the diagnostic functionality.

In some cases, the auxiliary device may be implemented as a specialized docking station. The specialized docking station may provide a physical interface for receiving and connecting to user devices, and may include circuitry and components for establishing communication with user devices in pre-boot environments. The specialized docking station may be configured to automatically initiate diagnostic data retrieval operations when a user device is placed in or connected to the docking station.

In some cases, the auxiliary device may be implemented as a handheld diagnostic scanner. The handheld diagnostic scanner may be a portable device that technicians or service personnel can carry and use to connect to user devices in various locations. The handheld diagnostic scanner may include a display for presenting diagnostic information, input controls for initiating diagnostic operations, and communication interfaces for connecting to user devices via wired or wireless connections.

In some cases, the auxiliary device may be implemented as a cloud-connected gateway device. The cloud-connected gateway device may serve as an intermediary between user devices and remote server systems, facilitating the transfer of diagnostic data from user devices to cloud-based services for storage, analysis, or decryption. The cloud-connected gateway device may include network connectivity capabilities for communicating with remote servers and may relay encrypted diagnostic data to appropriate cloud services.

In some cases, the auxiliary device may be a storage device such as a USB drive. The USB drive may be connected to a user device via a USB port, and the user device may detect the USB drive and transfer device anomaly information from a non-volatile memory portion to the USB drive for subsequent retrieval and analysis. In some cases, the auxiliary device may be an external hard drive that provides larger storage capacity for storing diagnostic data from multiple user devices or for storing more comprehensive diagnostic information from a single user device.

In some cases, the auxiliary device may be a cloud-based diagnostic system. The cloud-based diagnostic system may comprise remote computing resources that communicate with user devices via network connections to retrieve, store, and analyze diagnostic data. The cloud-based diagnostic system may provide centralized storage and processing capabilities for diagnostic information from multiple user devices, and may enable remote access to diagnostic data by authorized technicians or service personnel.

The auxiliary device described herein may connect to the user device through various physical and wireless connection methods depending on the particular diagnostic application, the capabilities of the user device, and the operational requirements of the diagnostic session.

In some cases, the auxiliary device may connect to the user device through a USB Type-A physical connection. USB Type-A connectors may provide a standardized interface for establishing communication between the auxiliary device and the user device, and may enable data transfer for retrieving device anomaly information from a non-volatile memory portion of the user device. In some cases, the auxiliary device may connect to the user device through a USB Type-C physical connection. USB Type-C connectors may provide a reversible connection interface and may support higher data transfer rates compared to other USB connector types, which may facilitate faster retrieval of diagnostic data from the user device.

In some cases, the auxiliary device may connect to the user device through a Lightning connector physical connection. Lightning connectors may be used with user devices that incorporate Lightning ports, and may provide a physical interface for establishing communication between the auxiliary device and the user device during diagnostic operations. In some cases, the auxiliary device may connect to the user device through proprietary diagnostic ports. Proprietary diagnostic ports may be designed and configured by a device manufacturer for diagnostic purposes, and may provide specialized interfaces that enable access to diagnostic functionality or protected memory regions of the user device that may not be accessible through standard consumer-facing ports.

In some cases, the auxiliary device may connect to the user device through JTAG/SWD debug interfaces. JTAG (Joint Test Action Group) interfaces and SWD (Serial Wire Debug) interfaces may provide low-level access to hardware components and memory regions of the user device, and may enable diagnostic operations that require direct hardware-level communication. JTAG/SWD debug interfaces may be used for diagnostic sessions that require access to firmware-level functionality or for retrieving diagnostic data from user devices that are unable to boot into higher-level operating environments.

In some cases, the auxiliary device may connect to the user device through wireless connection methods. In some cases, the auxiliary device may connect to the user device through a Bluetooth Low Energy (BLE) wireless connection. BLE may provide a low-power wireless communication protocol that enables the auxiliary device to establish communication with the user device without requiring a physical cable connection. BLE connections may be suitable for diagnostic operations where power consumption is a consideration or where physical access to ports of the user device is limited.

In some cases, the auxiliary device may connect to the user device through a Bluetooth Classic wireless connection. Bluetooth Classic may provide higher data throughput compared to BLE, and may be suitable for diagnostic operations that involve transfer of larger amounts of diagnostic data from the user device to the auxiliary device. In some cases, the auxiliary device may connect to the user device through a Wi-Fi Direct wireless connection. Wi-Fi Direct may enable peer-to-peer wireless communication between the auxiliary device and the user device without requiring an intermediate wireless access point, and may provide higher data transfer rates compared to Bluetooth connections.

In some cases, the auxiliary device may connect to the user device through a Zigbee wireless connection. Zigbee may provide a low-power wireless communication protocol that may be suitable for diagnostic operations in environments where multiple devices are networked together or where mesh networking capabilities are desired. In some cases, the auxiliary device may connect to the user device through proprietary short-range radio protocols. Proprietary short-range radio protocols may be designed and implemented by device manufacturers to provide specialized wireless communication capabilities for diagnostic purposes, and may offer features or security characteristics that are tailored to particular diagnostic applications.

The auxiliary device may be detected by the user device through various detection methods. In some cases, the auxiliary device may be detected via physical connection through USB or other ports. When the auxiliary device is physically connected to a port of the user device, the user device may detect the presence of the auxiliary device through electrical signaling on the port interface, and may initiate diagnostic operations responsive to the detection. In some cases, the auxiliary device may be detected via proximity-based communication such as Bluetooth, NFC (Near Field Communication), or other short-range wireless technologies. Proximity-based detection may enable the user device to detect the presence of the auxiliary device when the auxiliary device is within a communication range of the user device, and may initiate diagnostic operations without requiring a physical cable connection between the auxiliary device and the user device.

The connection establishment between the auxiliary device and the user device may require authentication to prevent unauthorized access to diagnostic data stored on the user device. Authentication mechanisms may ensure that diagnostic data, including device anomaly information stored in protected non-volatile memory portions, is accessible only to authorized auxiliary devices and authorized personnel operating such auxiliary devices.

In some cases, the connection establishment between the auxiliary device and the user device may require authentication through hardware tokens. A hardware token may be a physical device or component that stores authentication credentials or cryptographic keys used to verify the identity or authorization status of the auxiliary device. The hardware token may be integrated into the auxiliary device, or the hardware token may be a separate component that is connected to or associated with the auxiliary device during diagnostic operations. When the auxiliary device attempts to establish a connection with the user device, the user device may request authentication information from the hardware token, and the user device may verify the authentication information before permitting access to diagnostic data. In some cases, the hardware token may store a unique identifier, a digital certificate, or cryptographic key material that is used in the authentication process. The hardware token may be configured such that the authentication credentials stored on the hardware token cannot be easily copied or extracted, which may help prevent unauthorized auxiliary devices from gaining access to diagnostic data.

In some cases, the connection establishment between the auxiliary device and the user device may require authentication through cryptographic challenges. A cryptographic challenge may involve the user device generating a challenge value, such as a random number or nonce, and transmitting the challenge value to the auxiliary device. The auxiliary device may process the challenge value using a cryptographic key or algorithm to generate a response value, and the auxiliary device may transmit the response value back to the user device. The user device may verify the response value by performing a corresponding cryptographic operation, and the user device may permit access to diagnostic data if the response value is verified as correct. In some cases, the cryptographic challenge may be based on symmetric key cryptography, where both the user device and the auxiliary device share a secret key that is used to generate and verify challenge responses. In some cases, the cryptographic challenge may be based on asymmetric key cryptography, where the auxiliary device uses a private key to generate a response and the user device uses a corresponding public key to verify the response. Cryptographic challenge authentication may help ensure that the auxiliary device possesses appropriate cryptographic credentials before the user device permits access to device anomaly information or other diagnostic data.

In some cases, the connection establishment between the auxiliary device and the user device may require authentication through biometric verification. Biometric verification may involve capturing biometric data from a user or technician who is operating the auxiliary device, and verifying the captured biometric data against stored biometric templates or reference data. In some cases, biometric verification may be performed by the auxiliary device, where the auxiliary device includes biometric sensors for capturing biometric data and processing components for performing biometric matching. In some cases, biometric verification may be performed by the user device, where biometric data captured by the auxiliary device is transmitted to the user device for verification. Biometric data used for verification may include fingerprint data, facial recognition data, iris scan data, voice recognition data, or other biometric modalities. Biometric verification may help ensure that diagnostic data is accessible only when an authorized individual is present and operating the auxiliary device, which may provide an additional layer of security beyond device-level authentication. In some cases, biometric verification may be combined with other authentication mechanisms, such as hardware tokens or cryptographic challenges, to provide multi-factor authentication for accessing diagnostic data.

The non-volatile memory portion described herein may be implemented using various memory technologies depending on the particular application, performance requirements, and design considerations of the user device.

In some cases, the non-volatile memory portion may be implemented using embedded Multi-Media Controller (eMMC) flash memory technology. eMMC flash memory may integrate flash memory and a flash memory controller into a single package, which may simplify integration into user device designs. eMMC flash memory may provide a standardized interface for accessing stored data, and may be suitable for storing device anomaly information in a protected memory region that remains accessible in pre-boot environments.

In some cases, the non-volatile memory portion may be implemented using Universal Flash Storage (UFS) technology. UFS technology may provide higher data transfer rates compared to eMMC flash memory, and may support full-duplex operation that enables simultaneous read and write operations. UFS technology may be suitable for applications where faster retrieval of device anomaly information from the non-volatile memory portion is desired, such as when performing diagnostic operations that involve transfer of larger amounts of diagnostic data.

In some cases, the non-volatile memory portion may be implemented using NOR flash memory technology. NOR flash memory may provide execute-in-place capability, which may enable code to be executed directly from the memory without requiring the code to be copied to a separate working memory. NOR flash memory may provide fast random read access times, which may be beneficial for retrieving device anomaly information during pre-boot diagnostic operations. NOR flash memory may be suitable for storing firmware code and diagnostic data that is accessed during early boot stages of the user device.

In some cases, the non-volatile memory portion may be implemented using NAND flash memory technology. NAND flash memory may provide higher storage density compared to NOR flash memory, which may enable storage of larger amounts of device anomaly information and historical behavioral data. NAND flash memory may be organized in pages and blocks, and may provide efficient sequential read and write operations. NAND flash memory may be suitable for applications where storage capacity for diagnostic data is a consideration.

In some cases, the non-volatile memory portion may be implemented using Magnetoresistive Random Access Memory (MRAM) technology. MRAM technology may store data using magnetic states rather than electrical charges, which may provide non-volatility without requiring periodic refresh operations. MRAM technology may provide fast read and write access times, and may offer high endurance for write operations compared to flash memory technologies. MRAM technology may be suitable for applications where frequent updates to device anomaly information are performed, as MRAM may tolerate a larger number of write cycles without degradation.

In some cases, the non-volatile memory portion may be implemented using Ferroelectric RAM (FeRAM) technology. FeRAM technology may store data using ferroelectric materials that maintain polarization states in the absence of applied voltage. FeRAM technology may provide fast write speeds and low power consumption during write operations. FeRAM technology may offer high endurance for write operations, which may be beneficial for applications where device anomaly information is updated frequently during normal operation of the user device.

In some cases, the non-volatile memory portion may be implemented using Resistive RAM (ReRAM) technology. ReRAM technology may store data by changing the resistance of a dielectric material between conductive electrodes. ReRAM technology may provide high storage density and may offer scalability advantages for future device designs. ReRAM technology may provide fast switching speeds and may be suitable for applications where rapid storage of device anomaly information is desired during detection of anomalous subsystem behavior.

The non-volatile memory portion described herein may be configured in various arrangements depending on the particular security requirements, design considerations, and hardware architecture of the user device.

In some cases, the non-volatile memory portion may be configured as a dedicated hardware partition that is physically isolated from main storage of the user device. A physically isolated hardware partition may comprise a separate memory region that is distinct from memory regions used for storing user data, application data, and operating system files. Physical isolation may be achieved through hardware-level separation, where the dedicated hardware partition is implemented using separate memory cells, separate address spaces, or separate memory controllers that are distinct from those used for main storage. Physical isolation may help ensure that device anomaly information stored in the dedicated hardware partition is not affected by operations performed on main storage, such as factory reset operations that erase user data from main storage. Physical isolation may also help prevent unauthorized access to device anomaly information by applications or processes that have access to main storage, as the physically isolated partition may not be addressable through standard storage interfaces used by the operating system.

In some cases, the non-volatile memory portion may be configured as a logically partitioned region within the same storage medium with hardware-enforced access controls. A logically partitioned region may share the same physical storage medium as main storage, such as the same flash memory chip or the same storage controller, but may be defined as a separate logical partition with distinct access permissions. Hardware-enforced access controls may be implemented through memory protection mechanisms that restrict which processes, applications, or operating modes can read from or write to the logically partitioned region. In some cases, hardware-enforced access controls may be implemented through a memory management unit (MMU) or a memory protection unit (MPU) that enforces access permissions based on the current execution context or privilege level. In some cases, hardware-enforced access controls may be implemented through storage controller firmware that validates access requests to the logically partitioned region and permits access only when appropriate authentication or authorization conditions are satisfied. Hardware-enforced access controls may help ensure that device anomaly information stored in the logically partitioned region is accessible in pre-boot environments while remaining protected from unauthorized access during normal post-boot operation of the user device.

In some cases, the non-volatile memory portion may be implemented as a separate discrete memory chip on a printed circuit board of the user device. A separate discrete memory chip may be a physically distinct integrated circuit component that is mounted on the printed circuit board alongside other components of the user device, such as a main processor, main storage chips, and peripheral interface chips. The separate discrete memory chip may be connected to other components of the user device through dedicated signal traces on the printed circuit board, and may be accessed through a dedicated interface that is separate from interfaces used for accessing main storage. Implementation as a separate discrete memory chip may provide physical separation between device anomaly information and user data stored in main storage, as the separate discrete memory chip may be manufactured, tested, and configured independently from main storage components. In some cases, the separate discrete memory chip may be selected to have characteristics that are suited for storing diagnostic data, such as high write endurance, fast access times, or low power consumption during read operations in pre-boot environments. The separate discrete memory chip may be positioned on the printed circuit board in a location that facilitates access during diagnostic operations, and may be connected to power management circuitry that enables selective powering of the separate discrete memory chip while other components of the user device remain unpowered.

The predictive analysis component described herein may employ various algorithmic approaches for detecting and predicting device anomalies. The selection of a particular algorithmic approach or combination of approaches may depend on the type of anomaly being detected, the characteristics of the subsystem being monitored, the computational resources available on the user device, and the desired balance between detection sensitivity and false positive rates.

In some cases, the predictive analysis component may employ rule-based systems that compare subsystem outputs against predefined threshold values for anomaly detection. A rule-based system may define a set of rules that specify conditions under which subsystem behavior is considered anomalous. Each rule may include one or more threshold values that represent boundaries between normal and anomalous behavior for a particular subsystem output or metric. When the predictive analysis component obtains device-related information from a subsystem, the predictive analysis component may compare the obtained information against the predefined threshold values specified in the rules. If a subsystem output exceeds an upper threshold value or falls below a lower threshold value, the rule-based system may determine that an anomaly condition exists and may generate a corresponding anomaly prediction. Rule-based systems may be configured with threshold values that are determined through empirical testing, manufacturer specifications, or analysis of historical subsystem behavior data. In some cases, threshold values may be adjusted over time based on observed subsystem behavior or based on predictive-analysis-related updates received from a remote server.

In some cases, the predictive analysis component may employ statistical methods to identify deviations from baseline behavior. Statistical methods may analyze subsystem outputs over time to establish baseline behavioral patterns and may detect anomalies when current behavior deviates from the established baseline by a statistically significant amount. In some cases, the predictive analysis component may employ moving averages to smooth subsystem output data and to identify trends or shifts in subsystem behavior. A moving average may calculate an average value of subsystem outputs over a sliding window of time, and the predictive analysis component may compare current subsystem outputs against the moving average to detect deviations. In some cases, the predictive analysis component may employ standard deviation analysis to quantify the variability of subsystem outputs and to identify outputs that fall outside expected ranges. Standard deviation analysis may establish a range of expected values based on historical subsystem behavior, and subsystem outputs that fall more than a specified number of standard deviations from a mean value may be flagged as anomalous. In some cases, the predictive analysis component may employ regression models to identify relationships between subsystem outputs and to detect anomalies when observed relationships deviate from expected patterns. A regression model may be trained on historical subsystem data to learn expected relationships between variables, and the predictive analysis component may use the regression model to predict expected subsystem outputs based on current conditions and to detect anomalies when actual outputs differ from predicted outputs.

In some cases, the predictive analysis component may employ machine learning classifiers for detecting and predicting device anomalies. Machine learning classifiers may be trained on datasets that include examples of normal subsystem behavior and examples of anomalous subsystem behavior, and the trained classifiers may be used to classify current subsystem behavior as normal or anomalous. In some cases, the predictive analysis component may employ decision tree classifiers. A decision tree classifier may represent a series of decision rules organized in a tree structure, where each internal node represents a test on a subsystem output attribute, each branch represents an outcome of the test, and each leaf node represents a classification result indicating normal or anomalous behavior. In some cases, the predictive analysis component may employ random forest classifiers. A random forest classifier may comprise an ensemble of decision trees, where each decision tree is trained on a different subset of training data or a different subset of features, and the random forest classifier may aggregate predictions from the individual decision trees to produce a final classification result. In some cases, the predictive analysis component may employ support vector machine classifiers. A support vector machine classifier may identify a hyperplane in a feature space that separates normal subsystem behavior from anomalous subsystem behavior, and the support vector machine classifier may classify current subsystem behavior based on which side of the hyperplane the current behavior falls. In some cases, the predictive analysis component may employ neural network classifiers. A neural network classifier may comprise multiple layers of interconnected nodes that process subsystem output data through a series of transformations, and the neural network classifier may be trained to recognize patterns in subsystem behavior that are indicative of anomalies. Neural network classifiers may be capable of learning complex nonlinear relationships between subsystem outputs and anomaly conditions.

In some cases, the predictive analysis component may employ time-series analysis techniques for detecting temporal anomalies in subsystem behavior. Time-series analysis techniques may analyze sequences of subsystem outputs collected over time to identify patterns, trends, and anomalies that manifest in the temporal domain. In some cases, the predictive analysis component may employ autoregressive integrated moving average (ARIMA) models for time-series analysis. An ARIMA model may capture temporal dependencies in subsystem output data by modeling current values as a function of past values and past prediction errors. The predictive analysis component may use an ARIMA model to forecast expected future subsystem outputs based on historical patterns, and the predictive analysis component may detect anomalies when actual subsystem outputs deviate from the forecasted values by more than a specified threshold. In some cases, the predictive analysis component may employ exponential smoothing techniques for detecting temporal anomalies. Exponential smoothing may assign exponentially decreasing weights to older observations, giving more weight to recent subsystem outputs while still incorporating information from historical data. The predictive analysis component may use exponential smoothing to generate smoothed estimates of subsystem behavior and to detect anomalies when current outputs deviate from the smoothed estimates.

In some cases, the predictive analysis component may employ unsupervised clustering algorithms that group behavioral patterns and flag outliers as potential anomalies. Unsupervised clustering algorithms may analyze subsystem output data without requiring labeled examples of normal and anomalous behavior, which may be beneficial when labeled training data is not available or when new types of anomalies may emerge that were not represented in historical training data. Clustering algorithms may group subsystem behavioral patterns into clusters based on similarity, where patterns within a cluster are more similar to each other than to patterns in other clusters. The predictive analysis component may identify outlier patterns that do not fit well into any cluster or that are distant from cluster centers, and the predictive analysis component may flag such outlier patterns as potential anomalies. Unsupervised clustering may enable the predictive analysis component to detect anomalies that represent novel or previously unseen behavioral patterns.

In some cases, the predictive analysis component may employ ensemble methods that combine multiple algorithmic approaches to improve prediction accuracy and reduce false positives. An ensemble method may aggregate predictions from multiple individual algorithms, where each individual algorithm may have different strengths and weaknesses in detecting particular types of anomalies. By combining predictions from multiple algorithms, an ensemble method may achieve more robust anomaly detection than any single algorithm alone. In some cases, an ensemble method may use voting-based aggregation, where each individual algorithm provides a classification of normal or anomalous, and the ensemble method determines a final classification based on a majority vote or weighted vote of the individual classifications. In some cases, an ensemble method may use averaging-based aggregation, where each individual algorithm provides a confidence score or probability estimate for an anomaly, and the ensemble method determines a final score by averaging the individual scores. In some cases, an ensemble method may use stacking, where predictions from multiple individual algorithms are provided as inputs to a meta-algorithm that learns how to combine the individual predictions to produce a final classification. Ensemble methods may help reduce false positive rates by requiring agreement among multiple algorithms before classifying subsystem behavior as anomalous, and ensemble methods may help improve detection sensitivity by leveraging the complementary strengths of different algorithmic approaches.

The behavioral analysis described herein may monitor different combinations and configurations of device subsystems depending on the particular diagnostic application, the architecture of the user device, and the types of anomalies being detected. The monitoring configuration may be tailored to balance comprehensive anomaly detection with efficient use of computational resources and power consumption on the user device.

In some cases, the system may implement hierarchical monitoring where primary subsystems are continuously monitored while secondary subsystems are monitored only when triggered by specific events. Hierarchical monitoring may organize subsystems into tiers based on factors such as the likelihood of anomalies occurring in each subsystem, the impact of anomalies on device functionality, or the frequency with which each subsystem is used during normal device operation. Primary subsystems in a hierarchical monitoring configuration may include subsystems that are used frequently during normal device operation or subsystems where anomalies may have significant impact on user experience. The predictive analysis component may continuously collect device-related information from primary subsystems and may continuously analyze the collected information for indications of anomalous behavior. Secondary subsystems in a hierarchical monitoring configuration may include subsystems that are used less frequently or subsystems where anomalies may have less immediate impact on device functionality. The predictive analysis component may monitor secondary subsystems only when triggered by specific events, such as when a user initiates an operation that involves the secondary subsystem, when an anomaly detected in a primary subsystem suggests a potential issue with a related secondary subsystem, or when a scheduled diagnostic check is performed. Hierarchical monitoring may reduce computational overhead and power consumption by focusing continuous monitoring resources on primary subsystems while still enabling detection of anomalies in secondary subsystems when appropriate triggering events occur.

In some cases, the system may employ adaptive monitoring that adjusts the frequency and depth of subsystem analysis based on device usage patterns, battery level, or processor load. Adaptive monitoring may dynamically modify monitoring parameters in response to changing conditions on the user device, which may enable the system to balance anomaly detection capabilities with resource constraints. In some cases, adaptive monitoring may adjust the frequency of subsystem analysis based on device usage patterns. When the user device is being actively used, adaptive monitoring may increase the frequency of subsystem analysis to provide more timely detection of anomalies that may affect the user experience. When the user device is idle or in a low-activity state, adaptive monitoring may decrease the frequency of subsystem analysis to conserve power and computational resources. In some cases, adaptive monitoring may adjust the frequency of subsystem analysis based on battery level. When the battery level of the user device is high, adaptive monitoring may perform more frequent or more comprehensive subsystem analysis. When the battery level of the user device is low, adaptive monitoring may reduce the frequency or depth of subsystem analysis to extend battery life and ensure that sufficient power remains available for user-initiated operations. In some cases, adaptive monitoring may adjust the frequency or depth of subsystem analysis based on processor load. When the processor of the user device has available capacity, adaptive monitoring may perform more comprehensive analysis of subsystem behavior. When the processor is heavily loaded with user applications or system processes, adaptive monitoring may reduce the depth of analysis or defer non-urgent analysis tasks to avoid impacting device responsiveness.

The monitoring may be configured to focus on specific categories of subsystems depending on the types of anomalies being detected and the diagnostic objectives. In some cases, the monitoring may be configured to focus on input subsystems of the user device. Input subsystems may include subsystems that receive input from a user or from the external environment and that provide input data to other components of the user device for processing. In some cases, the monitoring may focus on a touchscreen subsystem that detects touch input from a user on a display surface of the user device. Monitoring of the touchscreen subsystem may involve analyzing touch event data, touch coordinates, touch pressure, and touch timing to detect anomalies such as unresponsive regions of the touchscreen, erratic touch detection, or drift in touch coordinate accuracy. In some cases, the monitoring may focus on button subsystems that detect physical button presses on the user device. Monitoring of button subsystems may involve analyzing button press events, button release events, and timing characteristics to detect anomalies such as stuck buttons, intermittent button failures, or degraded button responsiveness. In some cases, the monitoring may focus on a microphone subsystem that captures audio input from the environment. Monitoring of the microphone subsystem may involve analyzing audio signal characteristics, signal-to-noise ratios, and frequency response to detect anomalies such as microphone degradation, audio distortion, or interference from other device components.

In some cases, the monitoring may be configured to focus on output subsystems of the user device. Output subsystems may include subsystems that present information to a user or that produce outputs that are perceptible to a user or to the external environment. In some cases, the monitoring may focus on a display subsystem that presents visual information to a user. Monitoring of the display subsystem may involve analyzing display brightness, color accuracy, pixel functionality, and refresh characteristics to detect anomalies such as dead pixels, color shifts, backlight irregularities, or display flickering. In some cases, the monitoring may focus on speaker subsystems that produce audio output. Monitoring of speaker subsystems may involve analyzing audio output characteristics, frequency response, and distortion levels to detect anomalies such as speaker degradation, audio crackling, or reduced output volume. In some cases, the monitoring may focus on haptic feedback subsystems that produce tactile feedback to a user. Monitoring of haptic feedback subsystems may involve analyzing vibration patterns, vibration intensity, and timing accuracy to detect anomalies such as weak haptic response, irregular vibration patterns, or haptic motor failures.

In some cases, the monitoring may be configured to focus on communication subsystems of the user device. Communication subsystems may include subsystems that enable the user device to communicate with external devices, networks, or services. In some cases, the monitoring may focus on a cellular subsystem that provides cellular network connectivity. Monitoring of the cellular subsystem may involve analyzing signal strength, connection stability, data throughput, and call quality metrics to detect anomalies such as degraded cellular reception, frequent connection drops, or reduced data transfer rates. In some cases, the monitoring may focus on a Wi-Fi subsystem that provides wireless local area network connectivity. Monitoring of the Wi-Fi subsystem may involve analyzing signal strength, connection stability, data throughput, and authentication success rates to detect anomalies such as Wi-Fi connectivity issues, reduced range, or interference susceptibility. In some cases, the monitoring may focus on a Bluetooth subsystem that provides short-range wireless connectivity for connecting to peripheral devices. Monitoring of the Bluetooth subsystem may involve analyzing pairing success rates, connection stability, and data transfer reliability to detect anomalies such as Bluetooth pairing failures, connection instability, or reduced communication range. In some cases, the monitoring may focus on an NFC subsystem that provides near field communication capabilities. Monitoring of the NFC subsystem may involve analyzing read and write success rates, communication range, and transaction completion rates to detect anomalies such as NFC read failures or reduced communication reliability. In some cases, the monitoring may focus on a GPS subsystem that provides satellite-based positioning capabilities. Monitoring of the GPS subsystem may involve analyzing position accuracy, time to first fix, satellite acquisition rates, and position stability to detect anomalies such as degraded positioning accuracy, slow satellite acquisition, or position drift.

In some cases, the monitoring may be configured to focus on sensor subsystems of the user device. Sensor subsystems may include subsystems that measure physical quantities or environmental conditions and that provide sensor data to other components of the user device. In some cases, the monitoring may focus on an accelerometer subsystem that measures acceleration forces acting on the user device. Monitoring of the accelerometer subsystem may involve analyzing acceleration readings, noise levels, and calibration accuracy to detect anomalies such as sensor drift, noisy readings, or calibration errors. In some cases, the monitoring may focus on a gyroscope subsystem that measures rotational motion of the user device. Monitoring of the gyroscope subsystem may involve analyzing angular velocity readings, drift rates, and calibration accuracy to detect anomalies such as gyroscope drift, noisy readings, or calibration degradation. In some cases, the monitoring may focus on a magnetometer subsystem that measures magnetic field strength and direction. Monitoring of the magnetometer subsystem may involve analyzing magnetic field readings, calibration accuracy, and interference susceptibility to detect anomalies such as magnetometer calibration errors, interference from device components, or degraded compass accuracy. In some cases, the monitoring may focus on a barometer subsystem that measures atmospheric pressure. Monitoring of the barometer subsystem may involve analyzing pressure readings, noise levels, and calibration accuracy to detect anomalies such as sensor drift, noisy readings, or calibration errors that may affect altitude estimation. In some cases, the monitoring may focus on a proximity sensor subsystem that detects the presence of nearby objects. Monitoring of the proximity sensor subsystem may involve analyzing detection accuracy, response timing, and threshold calibration to detect anomalies such as false detections, missed detections, or degraded detection range. In some cases, the monitoring may focus on an ambient light sensor subsystem that measures ambient light levels. Monitoring of the ambient light sensor subsystem may involve analyzing light level readings, response characteristics, and calibration accuracy to detect anomalies such as sensor degradation, inaccurate readings, or slow response to changing light conditions.

In some cases, the monitoring may be configured to focus on power subsystems of the user device. Power subsystems may include subsystems that manage power storage, power delivery, and power consumption within the user device. In some cases, the monitoring may focus on a battery management subsystem that monitors and manages the battery of the user device. Monitoring of the battery management subsystem may involve analyzing battery voltage, battery current, charge level estimation, battery temperature, and charge cycle counts to detect anomalies such as abnormal battery drain, degraded battery capacity, battery swelling indicators, or charging irregularities. In some cases, the monitoring may focus on charging circuitry that manages the charging of the battery from external power sources. Monitoring of charging circuitry may involve analyzing charging current, charging voltage, charging efficiency, and thermal characteristics during charging to detect anomalies such as slow charging, charging interruptions, overheating during charging, or charging port degradation. In some cases, the monitoring may focus on power distribution subsystems that deliver power from the battery to various components of the user device. Monitoring of power distribution subsystems may involve analyzing voltage levels, current consumption, and power efficiency across different power rails to detect anomalies such as excessive power consumption by particular components, voltage regulation issues, or power delivery failures that may affect device stability or performance.

The comparison between first and second action or inaction patterns described herein may employ various analytical methods depending on the particular diagnostic application, the characteristics of the subsystem being analyzed, and the types of behavioral changes being detected.

In some cases, the comparison between first and second action or inaction patterns may employ direct numerical comparison of pattern metrics such as frequency, duration, or intensity. Direct numerical comparison may involve calculating quantitative metrics that characterize each action or inaction pattern and comparing the calculated metrics between the first pattern and the second pattern. Frequency metrics may quantify how often particular actions or inactions occur within a pattern, such as the number of touch events per unit time on a touchscreen subsystem or the number of button presses per day on a button subsystem. Duration metrics may quantify the length of time associated with particular actions or inactions, such as the duration of individual touch events, the time between consecutive actions, or the total time spent in particular operational states. Intensity metrics may quantify the magnitude or strength of particular actions, such as touch pressure on a pressure-sensitive touchscreen, acceleration magnitude detected by an accelerometer subsystem during movement events, or signal strength levels during communication subsystem operations. The predictive analysis component may calculate differences between corresponding metrics of the first pattern and the second pattern, and the predictive analysis component may determine that an anomaly exists when the calculated differences exceed specified threshold values. Direct numerical comparison may provide a straightforward approach for detecting changes in subsystem behavior that manifest as measurable changes in frequency, duration, or intensity of actions or inactions.

In some cases, the comparison between first and second action or inaction patterns may employ statistical hypothesis testing to determine if observed differences are significant. Statistical hypothesis testing may provide a framework for evaluating whether differences between the first pattern and the second pattern are likely to represent genuine changes in subsystem behavior or whether the differences may be attributable to normal variation in subsystem outputs. A statistical hypothesis test may formulate a null hypothesis that the first pattern and the second pattern represent samples from the same underlying behavioral distribution, and the test may evaluate evidence against the null hypothesis based on the observed pattern data. In some cases, the predictive analysis component may employ t-tests to compare mean values of pattern metrics between the first pattern and the second pattern. In some cases, the predictive analysis component may employ chi-square tests to compare frequency distributions of categorical pattern characteristics between the first pattern and the second pattern. In some cases, the predictive analysis component may employ non-parametric tests such as Mann-Whitney U tests or Kolmogorov-Smirnov tests when pattern data does not conform to assumptions required by parametric tests. The predictive analysis component may calculate a p-value or test statistic that quantifies the probability of observing the measured differences under the null hypothesis, and the predictive analysis component may determine that an anomaly exists when the p-value falls below a specified significance threshold. Statistical hypothesis testing may help reduce false positive anomaly detections by distinguishing statistically significant behavioral changes from normal variation in subsystem behavior.

In some cases, the comparison between first and second action or inaction patterns may employ dynamic time warping for comparing patterns that may be temporally shifted or scaled. Dynamic time warping may be an algorithm that measures similarity between two temporal sequences that may vary in timing or speed. When comparing action or inaction patterns, the first pattern and the second pattern may represent sequences of actions or inactions that occur over time, and the timing of corresponding actions or inactions may not align precisely between the two patterns. Dynamic time warping may align the first pattern and the second pattern by warping the time axis of one or both patterns to minimize a distance measure between corresponding elements of the aligned patterns. The dynamic time warping algorithm may find an optimal alignment that accounts for temporal shifts, where corresponding actions or inactions may occur at different absolute times in the two patterns, and temporal scaling, where the rate at which actions or inactions occur may differ between the two patterns. The predictive analysis component may calculate a dynamic time warping distance that quantifies the dissimilarity between the first pattern and the second pattern after optimal alignment, and the predictive analysis component may determine that an anomaly exists when the dynamic time warping distance exceeds a specified threshold. Dynamic time warping may be beneficial for detecting anomalies in subsystem behavior where the temporal characteristics of actions or inactions may vary due to factors such as user behavior variations, environmental conditions, or gradual changes in subsystem performance, while still enabling detection of substantive changes in the underlying pattern structure.

In some cases, the comparison between first and second action or inaction patterns may employ correlation analysis to identify relationships between patterns across different subsystems. Correlation analysis may examine how action or inaction patterns in one subsystem relate to action or inaction patterns in other subsystems, and may detect anomalies when expected correlations between subsystem patterns change. In normal operation, actions or inactions in one subsystem may be correlated with actions or inactions in related subsystems due to functional dependencies, shared usage contexts, or causal relationships between subsystem operations. The predictive analysis component may calculate correlation coefficients that quantify the strength and direction of relationships between pattern metrics from different subsystems. In some cases, the predictive analysis component may calculate Pearson correlation coefficients to measure linear relationships between pattern metrics. In some cases, the predictive analysis component may calculate Spearman rank correlation coefficients to measure monotonic relationships between pattern metrics without assuming linearity. The predictive analysis component may compare correlation values calculated from the first pattern with correlation values calculated from the second pattern, and the predictive analysis component may determine that an anomaly exists when correlations between subsystem patterns change by more than a specified amount. Correlation analysis may enable detection of anomalies that affect relationships between subsystems, such as when a failing subsystem no longer responds appropriately to inputs from related subsystems or when a subsystem begins exhibiting behavior that is inconsistent with the behavior of subsystems with which the failing subsystem normally operates in coordination.

In some cases, the comparison between first and second action or inaction patterns may employ trend analysis to detect gradual changes over extended time periods. Trend analysis may examine how pattern characteristics change over time to identify gradual degradation, drift, or progressive changes in subsystem behavior that may not be apparent when comparing only two discrete patterns. The predictive analysis component may analyze a sequence of patterns collected over an extended time period to identify trends in pattern metrics. In some cases, the predictive analysis component may fit trend lines or regression models to pattern metric values over time to quantify the rate and direction of change in subsystem behavior. In some cases, the predictive analysis component may employ moving average techniques to smooth pattern metric values and to identify underlying trends that may be obscured by short-term variation. In some cases, the predictive analysis component may employ change point detection algorithms to identify points in time at which the trend in pattern metrics changes, which may indicate the onset of a subsystem anomaly or a change in subsystem operating conditions. Trend analysis may enable detection of anomalies that develop gradually over time, such as progressive wear of mechanical components, gradual degradation of sensor accuracy, or slow drift in calibration parameters. By analyzing trends over extended time periods, the predictive analysis component may detect anomalies at earlier stages before the anomalies progress to the point of causing noticeable functional impairment.

In some cases, the system may maintain multiple historical baselines representing different usage contexts and may select an appropriate baseline for comparison based on current context. Different usage contexts may be associated with different expected patterns of subsystem behavior, and comparing current behavior against an inappropriate baseline may result in false positive or false negative anomaly detections. Usage contexts may include temporal contexts such as weekday versus weekend usage patterns, daytime versus nighttime usage patterns, or workday versus holiday usage patterns. Usage contexts may include location-based contexts such as home location usage patterns, work location usage patterns, or travel usage patterns. Usage contexts may include activity-based contexts such as usage patterns during voice calls, usage patterns during media playback, usage patterns during navigation, or usage patterns during gaming. The system may collect and store historical pattern data separately for each usage context, and the system may build separate baseline behavioral models for each usage context. When comparing current subsystem behavior against historical baselines, the system may determine the current usage context based on factors such as current time, current location, current device activity, or other contextual indicators. The system may select the historical baseline that corresponds to the determined current usage context, and the system may compare current subsystem behavior against the selected context-appropriate baseline. By selecting context-appropriate baselines for comparison, the system may reduce false positive anomaly detections that might otherwise occur when normal context-dependent behavioral variations are compared against baselines from different contexts, and the system may improve detection of genuine anomalies by comparing current behavior against baselines that represent expected behavior for the current usage context.

The behavioral analysis described herein may incorporate environmental context data to improve anomaly detection accuracy. Environmental factors may influence subsystem behavior in ways that affect the interpretation of device-related information and the prediction of device anomalies. By incorporating environmental context data into the behavioral analysis, the predictive analysis component may distinguish between subsystem behavior variations that are attributable to environmental conditions and subsystem behavior variations that are indicative of genuine anomalies.

In some cases, the behavioral analysis may incorporate ambient temperature measured by device sensors as environmental context data. User devices may include temperature sensors that measure the temperature of device components, the temperature of the device housing, or the ambient temperature of the environment surrounding the user device. Ambient temperature may affect the performance characteristics of various subsystems of the user device. Battery subsystems may exhibit different discharge rates, charging characteristics, and capacity at different ambient temperatures. Display subsystems may exhibit different brightness levels, response times, and color characteristics at different ambient temperatures. Processor subsystems may exhibit different performance levels and thermal throttling behavior at different ambient temperatures. The predictive analysis component may obtain ambient temperature measurements from temperature sensors of the user device and may incorporate the ambient temperature measurements into the behavioral analysis. When analyzing subsystem behavior for anomaly detection, the predictive analysis component may consider the ambient temperature at which the subsystem behavior was observed and may adjust the interpretation of subsystem outputs based on expected temperature-dependent behavior variations.

In some cases, the behavioral analysis may incorporate atmospheric pressure as environmental context data. User devices may include barometer sensors that measure atmospheric pressure. Atmospheric pressure may vary based on altitude, weather conditions, and other environmental factors. Atmospheric pressure measurements may provide context for interpreting subsystem behavior, particularly for subsystems that are sensitive to pressure variations or for subsystems whose behavior may be correlated with altitude or weather conditions. The predictive analysis component may obtain atmospheric pressure measurements from barometer sensors of the user device and may incorporate the atmospheric pressure measurements into the behavioral analysis.

In some cases, the behavioral analysis may incorporate humidity levels inferred from sensor behavior as environmental context data. While user devices may not include dedicated humidity sensors in all configurations, humidity levels may be inferred from the behavior of other sensors or subsystems that are affected by humidity. Humidity may affect the performance of certain subsystems, such as touchscreen subsystems where moisture on the display surface may affect touch detection accuracy, or communication subsystems where humidity may affect antenna performance. The predictive analysis component may infer humidity levels based on patterns in sensor behavior that correlate with humidity conditions, and the predictive analysis component may incorporate the inferred humidity levels into the behavioral analysis.

In some cases, the behavioral analysis may incorporate geographic location as environmental context data. User devices may include positioning subsystems, such as GPS subsystems, that determine the geographic location of the user device. Geographic location may provide context for interpreting subsystem behavior, as certain locations may be associated with particular environmental conditions, network characteristics, or usage patterns. The predictive analysis component may obtain geographic location information from positioning subsystems of the user device and may incorporate the geographic location information into the behavioral analysis. Geographic location information may enable the predictive analysis component to identify location-specific patterns in subsystem behavior and to distinguish between anomalies that occur at specific locations and anomalies that occur regardless of location.

In some cases, the behavioral analysis may incorporate altitude as environmental context data. Altitude may be determined based on atmospheric pressure measurements from barometer sensors, based on geographic location information combined with terrain data, or based on other altitude determination methods. Altitude may affect the performance of certain subsystems, such as battery subsystems where reduced atmospheric pressure at higher altitudes may affect battery behavior, or communication subsystems where altitude may affect signal propagation characteristics. The predictive analysis component may obtain altitude information and may incorporate the altitude information into the behavioral analysis.

In some cases, the behavioral analysis may incorporate network connectivity conditions as environmental context data. Network connectivity conditions may include characteristics of cellular network connections, Wi-Fi network connections, or other network connections available to the user device. Network connectivity conditions may include signal strength, network type, data throughput rates, latency, packet loss rates, and connection stability. Network connectivity conditions may affect the behavior of communication subsystems and may also affect the behavior of applications and services that depend on network connectivity. The predictive analysis component may obtain network connectivity condition information from communication subsystems of the user device and may incorporate the network connectivity condition information into the behavioral analysis. Network connectivity conditions may provide context for interpreting subsystem behavior, as certain subsystem behaviors may be expected or normal under particular network conditions while the same behaviors may be anomalous under different network conditions.

In some cases, the behavioral analysis may incorporate time of day as environmental context data. Time of day may be associated with different usage patterns, different environmental conditions, and different expected subsystem behaviors. Daytime usage patterns may differ from nighttime usage patterns, and subsystem behavior that is normal during one time period may be anomalous during another time period. The predictive analysis component may obtain time of day information from a clock or timing subsystem of the user device and may incorporate the time of day information into the behavioral analysis. Time of day information may enable the predictive analysis component to apply time-appropriate behavioral baselines when analyzing subsystem behavior for anomaly detection.

In some cases, the system may correlate anomalies with environmental conditions to identify environment-specific issues. Environment-specific issues may include performance degradation that occurs at extreme temperatures, connectivity problems that occur in specific geographic locations, or other anomalies that are associated with particular environmental conditions. The predictive analysis component may analyze relationships between detected or predicted anomalies and the environmental conditions that were present when the anomalies occurred. When an anomaly is detected or predicted, the predictive analysis component may record the environmental context data that was present at the time of the anomaly, including ambient temperature, atmospheric pressure, humidity levels, geographic location, altitude, network connectivity conditions, and time of day. The predictive analysis component may analyze patterns in the recorded environmental context data across multiple anomaly occurrences to identify correlations between anomalies and environmental conditions. When a correlation is identified between an anomaly and a particular environmental condition, the predictive analysis component may determine that the anomaly is an environment-specific issue that occurs under the correlated environmental condition. Identification of environment-specific issues may enable more accurate diagnosis of device anomalies by providing information about the environmental conditions under which the anomalies occur.

In some cases, historical environmental data may be stored alongside anomaly information to provide context for diagnostic analysis. When device anomaly information is stored in a non-volatile memory portion of the user device, the environmental context data that was present at the time of the anomaly may be stored together with the anomaly information. The stored environmental context data may include ambient temperature measurements, atmospheric pressure measurements, inferred humidity levels, geographic location information, altitude information, network connectivity condition information, and time of day information that were recorded at the time the anomaly was detected or predicted. When device anomaly information is retrieved from the non-volatile memory portion during diagnostic operations, the stored environmental context data may be retrieved together with the anomaly information. The stored environmental context data may provide context for interpreting the anomaly information and may assist technicians or automated diagnostic systems in understanding the conditions under which the anomaly occurred. Historical environmental data stored alongside anomaly information may enable identification of patterns in anomaly occurrence that are related to environmental conditions, and may support diagnosis of environment-specific issues that may not be reproducible under different environmental conditions.

In some cases, the system may adjust anomaly detection thresholds based on current environmental conditions to reduce false positives. Subsystem behavior may vary with environmental conditions in ways that are normal and expected, and fixed anomaly detection thresholds may result in false positive anomaly detections when subsystem behavior varies due to environmental factors rather than due to genuine anomalies. The predictive analysis component may maintain environment-dependent threshold values that specify different anomaly detection thresholds for different environmental conditions. When analyzing subsystem behavior for anomaly detection, the predictive analysis component may determine the current environmental conditions based on environmental context data obtained from sensors and subsystems of the user device. The predictive analysis component may select anomaly detection thresholds that are appropriate for the determined current environmental conditions, and the predictive analysis component may apply the selected thresholds when evaluating whether subsystem behavior is anomalous. By adjusting anomaly detection thresholds based on current environmental conditions, the system may reduce false positive anomaly detections that might otherwise occur when normal environment-dependent behavioral variations are evaluated against thresholds that are not appropriate for the current environmental conditions.

The encryption of diagnostic data described herein may employ various cryptographic schemes depending on the particular security requirements, performance considerations, and computational resources available on the user device.

In some cases, the encryption of diagnostic data may employ symmetric encryption using Advanced Encryption Standard (AES). AES is a block cipher algorithm that encrypts data in fixed-size blocks using a symmetric key, where the same key is used for both encryption and decryption operations. The encryption of diagnostic data may employ AES with a 128-bit key length, which may provide a balance between security strength and computational efficiency suitable for user devices with limited processing resources. In some cases, the encryption of diagnostic data may employ AES with a 192-bit key length, which may provide increased security strength compared to 128-bit keys while maintaining reasonable computational requirements. In some cases, the encryption of diagnostic data may employ AES with a 256-bit key length, which may provide a higher level of security strength for applications where protection of diagnostic data against advanced cryptographic attacks is a consideration. The selection of AES key length may depend on the sensitivity of the diagnostic data being encrypted, the expected lifetime of the encrypted data, and the computational capabilities of the user device. AES encryption may be performed on device anomaly information before the device anomaly information is stored in a non-volatile memory portion of the user device, and decryption may be performed when the device anomaly information is retrieved during diagnostic operations.

In some cases, the encryption of diagnostic data may employ elliptic curve cryptography (ECC) for more efficient key generation and storage. ECC is an asymmetric cryptographic approach that bases security on the algebraic structure of elliptic curves over finite fields. ECC may provide equivalent security strength to other asymmetric cryptographic approaches, such as RSA, while using shorter key lengths. Shorter key lengths in ECC may result in reduced storage requirements for cryptographic keys, reduced computational requirements for key generation and cryptographic operations, and reduced bandwidth requirements for transmitting keys or encrypted data. ECC may be suitable for user devices where storage space, processing power, or communication bandwidth are constrained resources. When ECC is employed for encryption of diagnostic data, a public/private keypair may be generated using elliptic curve algorithms, where the public key may be used for encrypting diagnostic data and the private key may be used for decrypting the encrypted diagnostic data. ECC key generation may be performed on the user device, and the generated keys may be stored in secure storage locations on the user device or transmitted to remote systems as appropriate for the particular encryption scheme being employed.

In some cases, the encryption of diagnostic data may employ hybrid encryption schemes that combine symmetric and asymmetric encryption for improved performance. Hybrid encryption schemes may leverage the strengths of both symmetric and asymmetric cryptographic approaches while mitigating the limitations of each approach when used alone. Symmetric encryption algorithms such as AES may provide efficient encryption and decryption of large amounts of data, but symmetric encryption requires secure distribution of the symmetric key to all parties that need to encrypt or decrypt the data. Asymmetric encryption algorithms such as ECC or RSA may provide secure key distribution without requiring a pre-shared secret, but asymmetric encryption may be computationally more expensive than symmetric encryption for encrypting large amounts of data. A hybrid encryption scheme may use asymmetric encryption to securely encrypt and distribute a symmetric key, and may use symmetric encryption to encrypt the diagnostic data using the distributed symmetric key. When encrypting diagnostic data using a hybrid encryption scheme, a symmetric key may be generated for encrypting the diagnostic data, the diagnostic data may be encrypted using the symmetric key and a symmetric encryption algorithm such as AES, and the symmetric key may be encrypted using an asymmetric encryption algorithm and a public key of a recipient. The encrypted diagnostic data and the encrypted symmetric key may be stored together or transmitted together, and a recipient possessing the corresponding private key may decrypt the symmetric key and then use the decrypted symmetric key to decrypt the diagnostic data. Hybrid encryption schemes may provide efficient encryption of diagnostic data while enabling secure key distribution through asymmetric cryptographic mechanisms.

In some cases, the encryption of diagnostic data may employ homomorphic encryption that allows certain computations to be performed on encrypted data without decryption. Homomorphic encryption is a form of encryption that permits computations to be carried out on ciphertext, generating an encrypted result which, when decrypted, matches the result of operations performed on the plaintext. Homomorphic encryption may enable analysis or processing of encrypted diagnostic data without requiring the diagnostic data to be decrypted, which may preserve privacy of the diagnostic data during analysis operations. In some cases, partially homomorphic encryption schemes may be employed that support a limited set of operations on encrypted data, such as addition or multiplication operations. In some cases, somewhat homomorphic encryption schemes may be employed that support a limited number of both addition and multiplication operations on encrypted data. In some cases, fully homomorphic encryption schemes may be employed that support arbitrary computations on encrypted data. When homomorphic encryption is employed for diagnostic data, device anomaly information may be encrypted using a homomorphic encryption scheme before storage or transmission. A remote server or other computing system may perform analysis operations on the encrypted device anomaly information without decrypting the device anomaly information, and the results of the analysis operations may be returned in encrypted form. The encrypted analysis results may be decrypted by an authorized party possessing the appropriate decryption key. Homomorphic encryption may enable cloud-based analysis of diagnostic data while maintaining privacy of the underlying device anomaly information.

Key derivation for encryption of diagnostic data may utilize various hardware-based security mechanisms depending on the security architecture and hardware capabilities of the user device. Hardware-based security mechanisms may provide protected environments for generating, storing, and using cryptographic keys, which may help protect keys from extraction or unauthorized access by software running on the user device.

In some cases, key derivation may utilize hardware-based secure elements for encryption key management. A secure element is a tamper-resistant hardware component that provides secure storage and processing capabilities for sensitive data such as cryptographic keys. A secure element may be implemented as a dedicated integrated circuit chip that is separate from a main processor of the user device, or a secure element may be implemented as a secure partition within a system-on-chip that includes the main processor. The secure element may include secure storage for cryptographic keys, a cryptographic processor for performing cryptographic operations using the stored keys, and security mechanisms that protect against physical and logical attacks. When key derivation utilizes a secure element, cryptographic keys for encrypting diagnostic data may be generated within the secure element, stored within the secure element, and used for cryptographic operations within the secure element. The cryptographic keys may not be exposed outside the secure element in unencrypted form, which may help protect the keys from extraction by malicious software or physical attacks. The secure element may perform encryption operations on diagnostic data using the stored keys, or the secure element may derive session keys that are provided to other components of the user device for performing encryption operations.

In some cases, key derivation may utilize Trusted Platform Modules (TPM) for encryption key management. A TPM is a hardware component that provides cryptographic functions and secure storage for cryptographic keys and other sensitive data. A TPM may be implemented as a discrete chip on a printed circuit board of the user device, or a TPM may be implemented as firmware running in a trusted execution environment. A TPM may provide functions for generating cryptographic keys, for sealing data such that the data can only be unsealed when the system is in a particular state, and for attesting to the configuration and integrity of the system. When key derivation utilizes a TPM, cryptographic keys for encrypting diagnostic data may be generated by the TPM and stored within the TPM. The TPM may provide key derivation functions that derive encryption keys from master keys stored within the TPM, and the derived keys may be used for encrypting diagnostic data. The TPM may bind encryption keys to particular system states, such that the keys are accessible only when the user device is in a pre-boot environment or when the user device has booted with a verified software configuration. TPM-based key management may provide hardware-rooted security for encryption keys used to protect diagnostic data.

In some cases, key derivation may utilize ARM TrustZone technology for encryption key management. ARM TrustZone is a hardware security technology that partitions processor resources into a secure world and a normal world, where the secure world provides a trusted execution environment that is isolated from software running in the normal world. ARM TrustZone may be implemented in processors based on ARM architecture, which may be used in various user devices such as smartphones, tablets, and other mobile devices. When key derivation utilizes ARM TrustZone technology, cryptographic keys for encrypting diagnostic data may be generated and stored within the secure world provided by TrustZone. Key derivation operations and encryption operations may be performed by trusted applications running in the secure world, and the cryptographic keys may not be accessible to software running in the normal world. ARM TrustZone may provide isolation between the secure world and the normal world through hardware mechanisms that control access to memory regions, peripherals, and processor states. TrustZone-based key management may enable secure handling of encryption keys on user devices that include ARM-based processors with TrustZone support.

In some cases, the system may implement key rotation policies where encryption keys are periodically regenerated. Key rotation involves replacing existing encryption keys with newly generated keys at specified intervals or upon occurrence of specified events. Key rotation may help limit the impact of potential key compromise by ensuring that any compromised key is valid only for a limited period of time or for a limited amount of encrypted data. When key rotation policies are implemented, the system may generate new encryption keys at periodic intervals, such as daily, weekly, or monthly intervals, or the system may generate new encryption keys upon occurrence of events such as factory resets, user changes, or detection of potential security incidents. When new encryption keys are generated, diagnostic data that was encrypted with previous keys may be re-encrypted with the new keys, or the previous keys may be retained in secure storage to enable decryption of previously encrypted diagnostic data while new diagnostic data is encrypted with the new keys. Key rotation policies may specify the frequency of key rotation, the conditions under which key rotation is triggered, and the handling of previously encrypted data when keys are rotated. Implementation of key rotation policies may enhance the security of encrypted diagnostic data by limiting the exposure associated with any individual encryption key.

In some cases, the system may implement hierarchical key structures where master keys protect session-specific encryption keys. A hierarchical key structure organizes encryption keys into multiple levels, where keys at higher levels of the hierarchy are used to protect keys at lower levels of the hierarchy. A master key may be a key at the top level of the hierarchy that is used to encrypt or derive other keys in the hierarchy. Session-specific encryption keys may be keys at lower levels of the hierarchy that are used to encrypt diagnostic data for particular sessions, time periods, or categories of data. When hierarchical key structures are implemented, a master key may be generated and stored in a secure location, such as within a secure element, TPM, or TrustZone secure world. Session-specific encryption keys may be derived from the master key or may be generated independently and then encrypted using the master key. Diagnostic data may be encrypted using session-specific encryption keys, and the encrypted session-specific keys may be stored alongside the encrypted diagnostic data or in a separate key storage location. To decrypt diagnostic data, the master key may be used to decrypt or derive the session-specific encryption key, and the session-specific encryption key may then be used to decrypt the diagnostic data. Hierarchical key structures may provide flexibility in key management by enabling rotation or revocation of session-specific keys without requiring changes to the master key, and may provide security benefits by limiting the exposure of the master key to key management operations rather than direct data encryption operations.

In some cases, a diagnostics storage component of a user device may generate an on-device public/private keypair after each factory reset of the user device. The on-device public/private keypair may be used to encrypt diagnostic data in a manner that ensures user privacy while allowing controlled access to behavioral insights. When a factory reset is performed on the user device, the diagnostics storage component may generate a new public/private keypair that is associated with the post-reset state of the user device. The newly generated keypair may be used to encrypt device anomaly information and other diagnostic data that is collected after the factory reset. By generating a new keypair after each factory reset, the system may ensure that diagnostic data encrypted with the new keypair is cryptographically distinct from diagnostic data that was encrypted with keypairs generated prior to the factory reset.

In some cases, the diagnostics storage component may generate an on-device public/private keypair separately for each user on the user device. When multiple users are configured on the user device, each user may be associated with a distinct public/private keypair that is generated when the user account is created or when the user first accesses the user device. Diagnostic data collected during a particular user’s session may be encrypted using the keypair associated with that user. By generating separate keypairs for each user, the system may ensure that diagnostic data from one user’s session is cryptographically isolated from diagnostic data from other users’ sessions on the same user device.

Upon factory reset or user change, a private key of the on-device public/private keypair may be deleted from the user device. Deletion of the private key may ensure that previously encrypted diagnostic data cannot be decrypted locally by a new user or after a reset of the user device. When the private key is deleted, the encrypted diagnostic data that was encrypted using the corresponding public key may remain stored in a non-volatile memory portion of the user device, but the encrypted diagnostic data may not be decryptable on the user device because the private key that is required for decryption is no longer present on the user device. A new user who accesses the user device after a factory reset or user change may not be able to decrypt diagnostic data that was encrypted by a previous user, as the private key associated with the previous user’s keypair may have been deleted. Deletion of the private key upon factory reset or user change may provide a privacy safeguard that prevents subsequent users from accessing diagnostic information that was collected during previous users’ sessions.

In some cases, a public key of the on-device public/private keypair may also be deleted from the user device upon reset. When both the private key and the public key are deleted from the user device upon reset, neither key may remain available for decryption locally on the user device. Deletion of both keys may ensure that the user device does not retain any cryptographic material that could be used to access previously encrypted diagnostic data. By deleting both the private key and the public key upon reset, the system may provide a complete separation between diagnostic data from different users or from different sessions separated by factory resets.

In some cases, the system may employ a dual-key encryption model to provide different levels of access to diagnostic data. Under the dual-key encryption model, two separate encryption mechanisms may be used for encrypting diagnostic data. A first encryption mechanism may use a cloud-based public key that allows only a remote computer system to decrypt behavioral data. The cloud-based public key may be associated with a corresponding private key that is stored securely on the remote computer system and that is not stored on the user device. Diagnostic data encrypted using the cloud-based public key may be decryptable only by the remote computer system that possesses the corresponding private key. The remote computer system may decrypt and analyze behavioral data dating back to when the user device was first manufactured, as the cloud-based encryption mechanism may be independent of factory resets and user changes that occur on the user device. The cloud-based encryption mechanism may enable long-term diagnostic analysis by authorized services while ensuring that the diagnostic data is not accessible to users or other parties who do not have access to the private key stored on the remote computer system.

A second encryption mechanism in the dual-key encryption model may use an on-device public/private keypair that is regenerated on every factory reset or user change. The on-device keypair may be used to encrypt diagnostic data in a manner that allows the current user to access and inspect behavioral data from the current user’s own session. When a factory reset is performed or when a user change occurs, the on-device keypair may be regenerated, which may result in deletion of the previous keypair and generation of a new keypair. Diagnostic data encrypted with the new on-device keypair may be accessible to the current user, while diagnostic data encrypted with previous on-device keypairs may not be accessible to the current user because the private keys associated with the previous keypairs may have been deleted. The dual-key encryption model may ensure that users can decrypt and inspect behavioral data from their own sessions while preventing users from accessing historical diagnostic data from previous users or from factory reset sessions that occurred prior to the current user’s session.

In some cases, the user device may provide functionality through an application or other user interface that allows a current user to access and inspect the current user’s own encrypted diagnostic data. The application or user interface may provide controls for viewing device anomaly information, behavioral patterns, and other diagnostic data that was collected during the current user’s session. The application or user interface may use the private key of the on-device keypair associated with the current user to decrypt diagnostic data for display to the current user. The application or user interface may restrict access to diagnostic data such that the current user can view only diagnostic data that was encrypted with the current user’s keypair, and the application or user interface may not provide access to diagnostic data that was encrypted with keypairs associated with previous users or previous sessions. By providing user access to diagnostic data through an application or user interface, the system may enable users to retain control and visibility over behavioral insights collected from the users’ own devices while preventing access to historical diagnostic data from previous users or factory reset sessions.

The device anomaly information stored in a non-volatile memory portion of a user device may be structured in various formats depending on the particular storage requirements, retrieval performance considerations, and interoperability requirements of the diagnostic system.

In some cases, the device anomaly information may be structured using binary-encoded records with fixed-length fields for efficient storage and retrieval. Binary-encoded records may represent anomaly data using sequences of bytes that encode data values in a compact binary representation rather than in human-readable text formats. Fixed-length fields may allocate a predetermined number of bytes for each data field within a record, regardless of the actual value stored in the field. When device anomaly information is structured using binary-encoded records with fixed-length fields, each anomaly record may occupy the same number of bytes in storage, which may simplify storage management and enable direct calculation of record positions within the storage area. Fixed-length fields may enable efficient random access to individual records, as the position of any record may be calculated by multiplying the record index by the fixed record size. Binary encoding may reduce storage space requirements compared to text-based formats by representing numeric values, identifiers, and other data in compact binary representations. Binary-encoded records with fixed-length fields may be suitable for applications where storage efficiency and retrieval performance are considerations, and where the structure of anomaly data is well-defined and consistent across records.

In some cases, the device anomaly information may be structured using variable-length records with type-length-value (TLV) encoding for flexibility. TLV encoding is a data encoding scheme where each data element is represented by a type field that identifies the type of data, a length field that specifies the size of the data value, and a value field that contains the actual data. Variable-length records may accommodate data fields of varying sizes, which may provide flexibility to store anomaly data that varies in size or structure across different anomaly types or different subsystems. When device anomaly information is structured using TLV encoding, each data element within an anomaly record may be preceded by type and length fields that describe the element. The type field may identify the semantic meaning of the data element, such as an anomaly identifier, a timestamp, a subsystem identifier, or a sensor reading. The length field may specify the number of bytes occupied by the value field, which may vary depending on the particular data being stored. TLV encoding may enable storage of anomaly records that include different combinations of data fields, as the presence and size of each field may be indicated by the type and length fields rather than by fixed positions within the record. TLV encoding may provide extensibility, as new data field types may be added to the encoding scheme without requiring changes to the structure of existing records. Variable-length records with TLV encoding may be suitable for applications where flexibility in anomaly data structure is desired, or where different types of anomalies may include different data fields.

In some cases, the device anomaly information may be structured using JSON format for interoperability. JSON (JavaScript Object Notation) is a text-based data interchange format that represents data as collections of name-value pairs and ordered lists of values. JSON format may provide human-readable representation of anomaly data, which may facilitate debugging, inspection, and manual analysis of stored anomaly information. JSON format may be widely supported by software libraries and tools across different programming languages and platforms, which may facilitate interoperability between the user device and external diagnostic systems, auxiliary devices, or remote servers that process anomaly data. When device anomaly information is structured using JSON format, each anomaly record may be represented as a JSON object containing named fields for anomaly attributes such as anomaly identifiers, timestamps, subsystem identifiers, severity levels, and other data. JSON format may support nested data structures, which may enable representation of complex anomaly data that includes hierarchical relationships or collections of related values. JSON format may be suitable for applications where interoperability with external systems is a consideration, or where human readability of stored anomaly data is desired.

In some cases, the device anomaly information may be structured using Protocol Buffers format for interoperability. Protocol Buffers is a binary serialization format that encodes structured data according to a schema definition. Protocol Buffers format may provide compact binary representation of anomaly data while maintaining schema-based structure that enables interoperability between systems that share the schema definition. When device anomaly information is structured using Protocol Buffers format, a schema definition may specify the structure of anomaly records, including the data fields, field types, and field identifiers. Anomaly data may be serialized according to the schema definition into a binary representation that may be more compact than text-based formats such as JSON. Protocol Buffers format may support schema evolution, where new fields may be added to the schema while maintaining compatibility with data serialized according to earlier versions of the schema. Protocol Buffers format may be suitable for applications where compact storage and efficient serialization and deserialization are considerations, and where schema-based interoperability between the user device and external systems is desired.

In some cases, the device anomaly information may be structured using MessagePack format for interoperability. MessagePack is a binary serialization format that provides compact representation of data structures similar to those representable in JSON format. MessagePack format may encode data in a binary representation that may be more compact than JSON while maintaining compatibility with JSON data models. When device anomaly information is structured using MessagePack format, anomaly records may be represented using data structures such as maps and arrays that correspond to JSON objects and arrays, but the data may be encoded in a compact binary representation rather than in text format. MessagePack format may provide faster serialization and deserialization compared to text-based formats, which may be beneficial for applications where performance of storage and retrieval operations is a consideration. MessagePack format may be suitable for applications where compact storage, efficient serialization, and compatibility with JSON-like data models are considerations.

In some cases, the device anomaly information may be stored using circular buffer implementations that automatically overwrite oldest entries when storage is full. A circular buffer is a data structure that uses a fixed-size buffer as if the buffer were connected end-to-end, where new data is written to the buffer sequentially and writing wraps around to the beginning of the buffer when the end is reached. When device anomaly information is stored using a circular buffer implementation, the non-volatile memory portion allocated for anomaly storage may be treated as a circular buffer. New anomaly records may be written to the buffer at a current write position, and the write position may advance after each write operation. When the write position reaches the end of the allocated storage area, the write position may wrap around to the beginning of the storage area. When the circular buffer is full and new anomaly records are written, the new records may overwrite the oldest records that were previously stored in the buffer. Circular buffer implementations may provide automatic management of storage space by ensuring that the most recent anomaly records are retained while older records are automatically discarded when storage capacity is exhausted. Circular buffer implementations may be suitable for applications where storage space for anomaly data is limited and where retention of the most recent anomaly information is prioritized over retention of older anomaly information.

In some cases, the device anomaly information may be stored using indexed database structures that enable efficient querying of specific anomaly types. An indexed database structure may organize anomaly records in a manner that supports efficient retrieval of records based on query criteria such as anomaly type, affected subsystem, time range, or severity level. When device anomaly information is stored using an indexed database structure, one or more indexes may be maintained that map query key values to the locations of anomaly records that match the key values. An index on anomaly type may enable efficient retrieval of all anomaly records of a particular type without requiring a scan of all stored records. An index on affected subsystem identifier may enable efficient retrieval of all anomaly records associated with a particular subsystem. An index on timestamp may enable efficient retrieval of anomaly records within a specified time range. Indexed database structures may support complex queries that combine multiple criteria, such as retrieving anomaly records of a particular type that occurred within a specified time range and that are associated with a particular subsystem. Indexed database structures may be suitable for applications where efficient querying of anomaly data based on various criteria is desired, or where diagnostic operations involve selective retrieval of anomaly records that match specific query conditions.

The stored anomaly data may include various data fields that characterize detected or predicted anomalies and that provide context for diagnostic analysis. In some cases, the stored anomaly data may include anomaly identifiers that uniquely identify each anomaly record. An anomaly identifier may be a numeric value, a string value, or another identifier format that distinguishes each anomaly record from other anomaly records stored in the non-volatile memory portion. Anomaly identifiers may enable references to specific anomaly records and may support tracking of individual anomalies across diagnostic operations.

In some cases, the stored anomaly data may include timestamps with millisecond or microsecond precision that indicate when anomalies were detected or predicted. A timestamp may record the date and time at which an anomaly was detected or predicted by a predictive analysis component of the user device. Timestamps with millisecond precision may record time values with resolution of one-thousandth of a second, which may enable correlation of anomalies with other events that occurred at similar times. Timestamps with microsecond precision may record time values with resolution of one-millionth of a second, which may enable more precise temporal correlation of anomalies with subsystem events or sensor readings. High-precision timestamps may be beneficial for analyzing sequences of events that occur in rapid succession or for correlating anomalies with specific subsystem operations that occur at precise times.

In some cases, the stored anomaly data may include affected subsystem identifiers that indicate which subsystem or subsystems are associated with each anomaly. An affected subsystem identifier may be a numeric code, a string name, or another identifier format that identifies a subsystem of the user device. When an anomaly is predicted with respect to a particular subsystem, the identifier of the affected subsystem may be stored as part of the anomaly record. Affected subsystem identifiers may enable filtering and retrieval of anomaly records associated with specific subsystems, and may assist diagnostic analysis by indicating which subsystems may require attention or further testing.

In some cases, the stored anomaly data may include severity levels that indicate the seriousness or urgency of each anomaly. A severity level may be a numeric value or a categorical value that classifies anomalies according to their potential impact on device functionality, user experience, or device reliability. Severity levels may range from low severity for minor anomalies that may not significantly affect device operation to high severity for anomalies that may indicate imminent failure or significant functional impairment. Severity levels may be assigned by a predictive analysis component based on the characteristics of the detected or predicted anomaly, the affected subsystem, and the potential consequences of the anomaly. Severity levels may enable prioritization of diagnostic attention and may assist technicians or automated diagnostic systems in focusing on the most significant anomalies.

In some cases, the stored anomaly data may include confidence scores that indicate the certainty or reliability of anomaly predictions. A confidence score may be a numeric value that quantifies the degree of confidence that a predictive analysis component has in a predicted anomaly. Confidence scores may be expressed as percentages, probabilities, or other numeric scales that indicate the likelihood that a predicted anomaly represents a genuine issue rather than a false positive detection. Confidence scores may be calculated based on the strength of evidence supporting the anomaly prediction, the consistency of anomaly indicators across multiple subsystems, or the historical accuracy of similar predictions. Confidence scores may assist diagnostic analysis by indicating which anomaly predictions are most reliable and which predictions may warrant additional verification or testing.

In some cases, the stored anomaly data may include raw sensor readings at the time of anomaly detection. Raw sensor readings may comprise data values obtained from sensors or subsystems of the user device at the time when an anomaly was detected or predicted. Raw sensor readings may include accelerometer readings, gyroscope readings, temperature readings, battery voltage readings, signal strength readings, or other sensor data that was captured contemporaneously with the anomaly detection. Storage of raw sensor readings may provide detailed context for diagnostic analysis by preserving the actual subsystem outputs that were observed when the anomaly was detected. Raw sensor readings may enable reconstruction of device state at the time of anomaly detection and may support detailed analysis of the conditions that led to the anomaly.

In some cases, the stored anomaly data may include references to related anomalies. A reference to a related anomaly may be an anomaly identifier or other reference value that links an anomaly record to one or more other anomaly records that are related to the anomaly. Related anomalies may include anomalies that occurred at similar times, anomalies that affect the same or related subsystems, anomalies that may have a common cause, or anomalies that may be part of a sequence of events leading to a failure condition. References to related anomalies may enable diagnostic analysis to identify patterns across multiple anomalies and to understand relationships between different anomaly occurrences. References to related anomalies may support identification of root causes that manifest as multiple related anomalies across different subsystems or at different times.

The diagnostic data stored in a non-volatile memory portion of a user device may be compressed using various algorithms to maximize the amount of information that can be retained within the available storage space. The selection of a compression algorithm or combination of algorithms may depend on the type of diagnostic data being compressed, the fidelity requirements for the data, the computational resources available on the user device, and the amount of storage space available for diagnostic data.

In some cases, the diagnostic data may be compressed using lossless compression algorithms that preserve complete data fidelity. Lossless compression algorithms reduce the size of data without losing any information, such that the original data can be exactly reconstructed from the compressed data through a decompression operation. Lossless compression may be suitable for diagnostic data where preservation of exact values is desired, such as anomaly identifiers, timestamps, subsystem identifiers, and other data fields where any loss of precision may affect the accuracy or usefulness of the diagnostic information.

In some cases, the diagnostic data may be compressed using LZ4 lossless compression. LZ4 is a lossless compression algorithm that provides fast compression and decompression speeds while achieving reasonable compression ratios. LZ4 may be suitable for applications where compression and decompression performance is a consideration, such as when diagnostic data is frequently written to or read from the non-volatile memory portion. The fast decompression speed of LZ4 may enable efficient retrieval of diagnostic data during pre-boot diagnostic operations where minimizing retrieval time is desired.

In some cases, the diagnostic data may be compressed using Zstandard lossless compression. Zstandard is a lossless compression algorithm that provides a configurable tradeoff between compression ratio and compression speed. Zstandard may achieve higher compression ratios than LZ4 at comparable decompression speeds, which may enable storage of more diagnostic data within a given storage space. Zstandard may support multiple compression levels that allow selection of a compression configuration that balances compression ratio against compression speed based on the particular requirements of the diagnostic application.

In some cases, the diagnostic data may be compressed using DEFLATE lossless compression. DEFLATE is a lossless compression algorithm that combines LZ77 compression with Huffman coding. DEFLATE may provide good compression ratios for various types of data and may be widely supported across different software platforms and tools. DEFLATE compression may be suitable for diagnostic data that may be transferred to external systems or auxiliary devices that support DEFLATE decompression.

In some cases, the diagnostic data may be compressed using lossy compression for sensor data where some precision loss is acceptable. Lossy compression algorithms reduce the size of data by discarding some information, such that the original data cannot be exactly reconstructed from the compressed data. Lossy compression may achieve higher compression ratios than lossless compression by accepting some loss of precision or detail in the compressed data. Lossy compression may be suitable for sensor data where the exact original values are not required for diagnostic purposes and where approximate values provide sufficient information for anomaly detection and diagnostic analysis. Sensor data that may be suitable for lossy compression may include accelerometer readings, gyroscope readings, temperature readings, and other sensor measurements where small variations in precision may not significantly affect diagnostic utility. When lossy compression is applied to sensor data, the compression algorithm may reduce the precision of sensor values, may downsample sensor data by retaining only a subset of measurements, or may apply other techniques that reduce data size while preserving the general characteristics of the sensor data that are relevant for diagnostic analysis.

In some cases, the diagnostic data may be compressed using delta encoding that stores only changes from previous records. Delta encoding is a compression technique that represents data as differences relative to a reference value or a previous data value rather than as absolute values. When diagnostic data includes sequences of records that are collected over time, consecutive records may contain values that are similar to one another, and storing the differences between consecutive values may require less storage space than storing the absolute values of each record. When delta encoding is applied to diagnostic data, a first record in a sequence may be stored as an absolute value, and subsequent records may be stored as delta values that represent the difference between each record and the preceding record. To reconstruct the original data, the delta values may be applied sequentially starting from the initial absolute value. Delta encoding may be effective for diagnostic data that exhibits temporal continuity, such as sensor readings that change gradually over time or subsystem state information that remains relatively stable between changes. Delta encoding may reduce storage requirements by representing small changes using fewer bits than would be required to represent the full absolute values.

In some cases, the diagnostic data may be compressed using dictionary-based compression optimized for the specific vocabulary of anomaly descriptions. Dictionary-based compression is a compression technique that replaces recurring patterns or strings in the data with references to entries in a dictionary that stores the patterns or strings. When diagnostic data includes textual descriptions, identifiers, or other data that uses a limited vocabulary of recurring terms, dictionary-based compression may achieve efficient compression by storing each unique term once in a dictionary and replacing occurrences of the term in the data with shorter references to the dictionary entry. A dictionary for compressing diagnostic data may be optimized for the specific vocabulary used in anomaly descriptions, subsystem identifiers, error messages, and other textual content that appears in diagnostic records. The dictionary may include entries for common anomaly type names, subsystem names, severity level descriptors, and other terms that appear frequently in diagnostic data. When diagnostic data is compressed using the optimized dictionary, occurrences of dictionary terms in the data may be replaced with compact references to the corresponding dictionary entries, which may reduce the storage space required for the diagnostic data. The dictionary may be stored in the non-volatile memory portion along with the compressed diagnostic data, or the dictionary may be predefined and stored separately such that the same dictionary is used for compression and decompression operations.

In some cases, the diagnostic data may be compressed using semantic compression that extracts and stores only the most diagnostically relevant features from raw data. Semantic compression is a compression approach that analyzes the semantic content of data to identify and retain information that is relevant for the intended use of the data while discarding information that is less relevant. When semantic compression is applied to diagnostic data, the compression process may analyze raw sensor readings, subsystem outputs, and other data to extract features that are relevant for anomaly detection and diagnostic analysis. Features that may be extracted through semantic compression may include statistical summaries of sensor data such as mean values, variance, minimum and maximum values, and trend indicators. Features may include event indicators that identify occurrences of specific conditions or state changes. Features may include pattern descriptors that characterize the shape or structure of temporal data sequences. The extracted features may be stored in place of the raw data, which may reduce storage requirements while preserving the information that is most useful for diagnostic purposes. Semantic compression may enable storage of diagnostic information from extended time periods by retaining compact feature representations rather than voluminous raw data. The specific features extracted through semantic compression may be selected based on the types of anomalies being detected and the diagnostic analyses that will be performed on the stored data.

In some cases, the system may implement adaptive compression that selects algorithms based on data characteristics and available storage space. Adaptive compression may dynamically choose compression algorithms or compression parameters based on analysis of the data being compressed and based on the current state of storage resources on the user device. When adaptive compression is implemented, the system may analyze characteristics of diagnostic data before compression to determine which compression algorithm or combination of algorithms may be most effective for the particular data. Data characteristics that may be analyzed may include the type of data, the statistical properties of data values, the presence of recurring patterns, and the degree of similarity between consecutive records. Based on the analyzed data characteristics, the adaptive compression system may select a compression algorithm that is suited for the particular characteristics of the data. For example, data with high temporal continuity may be compressed using delta encoding, data with recurring textual patterns may be compressed using dictionary-based compression, and data where some precision loss is acceptable may be compressed using lossy compression.

Adaptive compression may also consider available storage space when selecting compression algorithms or parameters. When available storage space in the non-volatile memory portion is plentiful, adaptive compression may select compression algorithms or parameters that prioritize compression and decompression speed over compression ratio, as achieving maximum compression may be less important when storage space is not constrained. When available storage space is limited, adaptive compression may select compression algorithms or parameters that prioritize compression ratio over speed, as reducing the size of stored data may be more important than minimizing compression time when storage space is scarce. Adaptive compression may monitor the amount of storage space consumed by diagnostic data and the amount of storage space remaining in the non-volatile memory portion, and adaptive compression may adjust compression algorithm selection or compression parameters as storage utilization changes over time. By adapting compression behavior based on data characteristics and storage availability, the system may balance storage efficiency, compression performance, and data fidelity according to the current conditions and requirements of the diagnostic application.

The pre-boot diagnostic environment described herein may be implemented at various levels of a boot sequence of a user device depending on the particular diagnostic requirements, the hardware architecture of the user device, and the level of access required for diagnostic operations.

In some cases, the pre-boot diagnostic environment may be implemented within a primary bootloader of the user device. The primary bootloader, which may also be referred to as a first-stage bootloader, may be the first software component that executes when the user device is powered on or reset. The primary bootloader may be stored in a read-only memory or in a protected region of non-volatile memory that is accessible immediately upon power-on. Implementation of the pre-boot diagnostic environment within the primary bootloader may enable diagnostic operations to begin at the earliest possible point in the boot sequence, before any other software components have loaded or executed. The primary bootloader may include code for accessing a non-volatile memory portion where device anomaly information is stored, code for communicating with an auxiliary device to transfer diagnostic data, and code for performing basic diagnostic tests on hardware components of the user device. Implementation within the primary bootloader may provide access to diagnostic functionality even when higher-level software components, such as secondary bootloaders or operating systems, are corrupted or unable to load. The primary bootloader implementation may be suitable for diagnostic scenarios where access to diagnostic data is required regardless of the state of other software components on the user device.

In some cases, the pre-boot diagnostic environment may be implemented within a secondary bootloader of the user device. A secondary bootloader may be a software component that is loaded and executed by the primary bootloader after the primary bootloader completes initial hardware initialization. The secondary bootloader may provide more extensive functionality than the primary bootloader, as the secondary bootloader may have access to additional hardware resources and may execute from faster memory after being loaded by the primary bootloader. Implementation of the pre-boot diagnostic environment within the secondary bootloader may enable more comprehensive diagnostic capabilities compared to implementation within the primary bootloader, as the secondary bootloader may have access to device drivers, file system support, and other functionality that may not be available in the primary bootloader. The secondary bootloader may include a diagnostic mode that can be activated to perform diagnostic operations, retrieve device anomaly information from a non-volatile memory portion, communicate with auxiliary devices, and execute automated diagnostic tests. Implementation within the secondary bootloader may provide a balance between early access to diagnostic functionality and availability of more extensive software capabilities for diagnostic operations.

In some cases, the pre-boot diagnostic environment may be implemented within a dedicated diagnostic partition that loads before a main operating system of the user device. A dedicated diagnostic partition may be a separate partition on a storage device of the user device that contains a minimal software environment configured for diagnostic purposes. The dedicated diagnostic partition may be loaded by a bootloader when diagnostic mode is activated, and the dedicated diagnostic partition may execute instead of or before the main operating system. The dedicated diagnostic partition may contain a minimal operating environment that includes drivers for accessing storage, communication interfaces, display, and other hardware components that are used during diagnostic operations. The dedicated diagnostic partition may include diagnostic applications for retrieving device anomaly information from a protected non-volatile memory portion, for communicating with auxiliary devices, for performing automated diagnostic tests, and for presenting diagnostic information to technicians or users. Implementation within a dedicated diagnostic partition may provide a self-contained diagnostic environment that is isolated from the main operating system, which may enable diagnostic operations to proceed even when the main operating system is corrupted, misconfigured, or otherwise unable to boot. The dedicated diagnostic partition may be protected from modification by normal operating system operations, which may help ensure that the diagnostic environment remains functional and available when needed.

In some cases, the pre-boot diagnostic environment may be implemented within UEFI (Unified Extensible Firmware Interface) applications. UEFI is a specification that defines a software interface between an operating system and platform firmware, and UEFI provides an environment in which applications can execute before an operating system loads. UEFI applications may be executable programs that run within the UEFI environment and that have access to UEFI services for interacting with hardware, accessing storage, and performing other operations. Implementation of the pre-boot diagnostic environment as a UEFI application may enable diagnostic operations to execute within a standardized firmware environment that provides consistent interfaces across different hardware platforms that support UEFI. A UEFI diagnostic application may access device anomaly information stored in a non-volatile memory portion through UEFI storage protocols, may communicate with auxiliary devices through UEFI communication protocols, and may perform diagnostic tests using UEFI services for hardware access. UEFI applications may be stored on a system partition of a storage device and may be launched by UEFI firmware during the boot process or in response to user input. Implementation within UEFI applications may be suitable for user devices that use UEFI firmware and may provide a portable diagnostic environment that can operate across different UEFI-compatible platforms.

In some cases, the pre-boot diagnostic environment may be implemented within a minimal recovery operating system. A minimal recovery operating system may be a lightweight operating system that provides basic functionality for system recovery, maintenance, and diagnostic operations. The minimal recovery operating system may be stored on a dedicated partition of a storage device or may be loaded from an external source such as an auxiliary device. The minimal recovery operating system may include a kernel, device drivers for hardware components of the user device, and diagnostic utilities for retrieving device anomaly information, performing diagnostic tests, and communicating with external systems. Implementation within a minimal recovery operating system may provide more extensive diagnostic capabilities compared to bootloader-based or UEFI-based implementations, as the minimal recovery operating system may support more sophisticated software applications, file system access, network communication, and user interface functionality. The minimal recovery operating system may be designed to boot quickly and to operate with minimal resource requirements, which may enable diagnostic operations to proceed even on user devices with limited available resources or with hardware issues that prevent normal operating system boot. The minimal recovery operating system may provide a familiar operating environment for technicians who perform diagnostic operations, which may facilitate efficient diagnostic workflows.

The pre-boot diagnostic environment may support different levels of functionality depending on the particular implementation level. Implementations within the primary bootloader may support simple memory read operations for retrieving device anomaly information from a non-volatile memory portion and basic communication operations for transferring diagnostic data to an auxiliary device. Implementations within secondary bootloaders, dedicated diagnostic partitions, UEFI applications, or minimal recovery operating systems may support more extensive functionality, including full diagnostic test execution, comprehensive hardware testing, detailed diagnostic reporting, and interactive diagnostic interfaces. The level of functionality supported by a particular implementation may depend on the software capabilities available at that level of the boot sequence, the hardware resources that are initialized and accessible at that level, and the design objectives for the diagnostic environment.

The pre-boot diagnostic environment may be entered through various methods depending on the particular implementation, the hardware capabilities of the user device, and the diagnostic scenario.

In some cases, the pre-boot diagnostic environment may be entered through specific hardware button combinations. A hardware button combination may involve pressing and holding one or more physical buttons on the user device during power-on or during a specific phase of the boot sequence. The bootloader or firmware of the user device may monitor the state of physical buttons during boot and may detect when a specific button combination is pressed. When the specific button combination is detected, the bootloader or firmware may divert the boot process to enter the pre-boot diagnostic environment instead of proceeding with normal boot to the main operating system. Different button combinations may be defined for entering different modes or for accessing different diagnostic functions. The specific button combination required to enter the pre-boot diagnostic environment may be documented for technicians or service personnel who perform diagnostic operations. Entry through hardware button combinations may provide a reliable method for accessing the pre-boot diagnostic environment that does not depend on software functionality beyond the bootloader or firmware that monitors button state during boot.

In some cases, the pre-boot diagnostic environment may be entered through detection of an auxiliary device. When the user device is powered on or reset, the bootloader or firmware may check for the presence of an auxiliary device connected to the user device through a physical port or through a wireless communication interface. If an auxiliary device is detected, the bootloader or firmware may enter the pre-boot diagnostic environment to enable diagnostic operations with the auxiliary device. Detection of the auxiliary device may be performed by checking for electrical signals on a physical port, by attempting to establish communication with a device on a communication interface, or by receiving a beacon or announcement from an auxiliary device over a wireless communication protocol. Entry through auxiliary device detection may enable automated diagnostic workflows where connecting an auxiliary device to a user device automatically initiates diagnostic operations without requiring manual button presses or other user input. Entry through auxiliary device detection may be suitable for diagnostic scenarios where user devices are processed in batches or where diagnostic operations are performed by automated systems.

In some cases, the pre-boot diagnostic environment may be entered through receipt of specific commands over a communication interface. A communication interface may include a serial port, a USB port, a network interface, or another communication channel through which the user device can receive commands from an external system. The bootloader or firmware of the user device may monitor the communication interface during boot for receipt of specific commands that indicate that the pre-boot diagnostic environment should be entered. When a specific command is received, the bootloader or firmware may enter the pre-boot diagnostic environment and may establish a communication session with the external system that sent the command. Entry through command-based methods may enable remote initiation of diagnostic operations, where an external system can command a user device to enter the pre-boot diagnostic environment without requiring physical access to the user device for button presses or auxiliary device connection. Command-based entry may be suitable for diagnostic scenarios involving networked devices, devices in remote locations, or devices that are integrated into larger systems where physical access may be limited.

In some cases, the pre-boot diagnostic environment may be entered through automatic entry upon detection of critical system failures. The bootloader or firmware of the user device may monitor for conditions that indicate critical system failures during the boot process, such as repeated boot failures, corruption of operating system files, hardware initialization failures, or other conditions that prevent normal boot completion. When a critical system failure is detected, the bootloader or firmware may automatically enter the pre-boot diagnostic environment to enable diagnostic operations and to provide access to device anomaly information that may assist in diagnosing the cause of the failure. Automatic entry upon critical system failure may ensure that diagnostic capabilities remain accessible even when the user device is unable to boot normally, which may be particularly valuable for diagnosing issues that prevent normal device operation. The criteria for detecting critical system failures and triggering automatic entry into the pre-boot diagnostic environment may be configurable, and the bootloader or firmware may maintain a count of consecutive boot failures or other metrics that are used to determine when automatic entry should occur.

The power management during pre-boot diagnostic operations described herein may be configured with various power states, power sources, and power control mechanisms depending on the particular diagnostic requirements, the hardware architecture of the user device, and the operational constraints of the diagnostic scenario.

In some cases, the system may implement multiple power domains that can be independently controlled. A power domain may be a group of hardware components or subsystems that share a common power supply and that can be powered on or powered off as a unit. Independent control of multiple power domains may enable selective powering of specific subsystems that are required for particular diagnostic tests while other subsystems remain unpowered. When the user device enters a pre-boot diagnostic environment, a power management subsystem may selectively enable power domains that contain components needed for the diagnostic operations being performed. For example, a power domain containing a non-volatile memory portion where device anomaly information is stored may be powered to enable retrieval of the device anomaly information, while power domains containing display subsystems, communication subsystems, or other subsystems that are not needed for the particular diagnostic operation may remain unpowered. A power domain containing a communication interface used to connect with an auxiliary device may be powered to enable transfer of diagnostic data to the auxiliary device, while power domains containing subsystems that are not involved in the data transfer may remain unpowered. Independent control of power domains may reduce overall power consumption during pre-boot diagnostic operations by ensuring that power is supplied only to components that are actively being used for diagnostic purposes. Independent power domain control may also enable diagnostic testing of specific subsystems by powering the subsystem under test while keeping other subsystems unpowered, which may help isolate the behavior of the subsystem under test from potential interference or interactions with other subsystems.

Power during pre-boot diagnostic operations may be sourced from various sources depending on the availability of power sources, the power requirements of the diagnostic operations, and the operational constraints of the diagnostic scenario.

In some cases, power during pre-boot diagnostics may be sourced from an internal battery of the user device. The internal battery may be a rechargeable battery that is integrated into the user device and that provides power for normal device operation. When the user device enters a pre-boot diagnostic environment, the internal battery may supply power to the power domains that are enabled for diagnostic operations. Sourcing power from the internal battery may enable pre-boot diagnostic operations to be performed without requiring connection to an external power source, which may be beneficial for diagnostic scenarios where external power is not available or where the diagnostic operations need to be performed in locations where external power connections are not convenient. When power is sourced from the internal battery during pre-boot diagnostics, the power management subsystem may monitor the battery charge level and may limit or terminate diagnostic operations if the battery charge level falls below a threshold value, which may help ensure that sufficient battery charge remains for subsequent device operation or for completing the diagnostic session.

In some cases, power during pre-boot diagnostics may be sourced from an auxiliary device through USB Power Delivery. USB Power Delivery is a specification that defines a protocol for negotiating power delivery over USB connections, enabling devices to receive power at various voltage and current levels through a USB connection. When an auxiliary device that supports USB Power Delivery is connected to the user device, the auxiliary device may supply power to the user device through the USB connection. The user device may negotiate with the auxiliary device to establish a power delivery configuration that provides sufficient power for the pre-boot diagnostic operations being performed. Sourcing power from the auxiliary device through USB Power Delivery may enable pre-boot diagnostic operations to be performed even when the internal battery of the user device is depleted or when the internal battery is unable to supply sufficient power for the diagnostic operations. USB Power Delivery may also enable the auxiliary device to supply power at higher levels than may be available from the internal battery, which may enable diagnostic operations that require more power than the internal battery can provide. When power is sourced from the auxiliary device through USB Power Delivery, the user device may draw power from the auxiliary device while simultaneously transferring diagnostic data to the auxiliary device over the same USB connection.

In some cases, power during pre-boot diagnostics may be sourced from an external power supply. An external power supply may be a power adapter, a power station, or another power source that is separate from the user device and from the auxiliary device. The external power supply may connect to the user device through a charging port, a power input connector, or another power interface of the user device. Sourcing power from an external power supply may provide a stable and consistent power source for pre-boot diagnostic operations, which may be beneficial for diagnostic scenarios that involve extended diagnostic sessions or diagnostic operations that have high power requirements. An external power supply may provide power at levels that exceed what is available from the internal battery or from USB Power Delivery, which may enable diagnostic operations that require substantial power consumption. When power is sourced from an external power supply, the power management subsystem may configure the user device to draw power from the external power supply while the internal battery remains in a standby state or while the internal battery is being charged by the external power supply.

In some cases, power during pre-boot diagnostics may be sourced from a combination of sources. The power management subsystem may draw power from multiple sources simultaneously or may switch between power sources based on availability and power requirements. For example, the power management subsystem may draw power from an external power supply when available and may fall back to drawing power from the internal battery when an external power supply is not connected. The power management subsystem may supplement power from the internal battery with power from an auxiliary device through USB Power Delivery when the diagnostic operations require more power than the internal battery alone can provide. Combining power from multiple sources may provide flexibility in diagnostic scenarios where power availability varies or where different diagnostic operations have different power requirements.

In some cases, the system may implement power budgeting that limits the total power consumption during pre-boot operations. Power budgeting may involve establishing a power budget that specifies a maximum amount of power that may be consumed during pre-boot diagnostic operations, and the power management subsystem may monitor and control power consumption to ensure that the power budget is not exceeded. The power budget may be established based on the capacity of the power source being used, the thermal dissipation capabilities of the user device, and the operational constraints of the diagnostic scenario. When power is sourced from the internal battery, the power budget may be set to limit power consumption to a level that prevents excessive battery drain during the diagnostic session, which may help ensure that sufficient battery charge remains after the diagnostic session for subsequent device operation or for user needs. When power is sourced from an external source, the power budget may be set based on the power delivery capability of the external source to ensure that the user device does not attempt to draw more power than the external source can provide.

Power budgeting may help prevent thermal issues during pre-boot diagnostic operations. When power is consumed by components of the user device, the consumed power is converted to heat, and excessive heat generation may cause thermal issues such as component overheating, thermal throttling, or thermal damage. The power budget may be set to limit power consumption to a level that keeps heat generation within the thermal dissipation capabilities of the user device, which may help prevent thermal issues during diagnostic operations. The power management subsystem may monitor temperature sensors of the user device during pre-boot diagnostic operations and may reduce power consumption or pause diagnostic operations if temperature readings indicate that thermal limits are being approached.

When power budgeting is implemented, the power management subsystem may allocate portions of the power budget to different power domains or different diagnostic operations. The power management subsystem may prioritize power allocation to power domains that are performing active diagnostic operations and may reduce or eliminate power allocation to power domains that are idle or that are performing lower-priority operations. The power management subsystem may schedule diagnostic operations to avoid simultaneous execution of multiple high-power operations that would exceed the power budget if performed concurrently. Power budgeting may enable the system to perform comprehensive diagnostic operations within the constraints of available power and thermal limits by managing the timing and power allocation of individual diagnostic operations.

In some cases, wake-on-connection functionality may be implemented to enable the user device to detect connection of an auxiliary device while the user device is in a low-power state. Wake-on-connection functionality may use dedicated low-power monitoring circuits that detect auxiliary device connection while a main processor of the user device remains in a deep sleep state. The low-power monitoring circuits may be hardware circuits that are designed to operate with minimal power consumption and that can monitor connection interfaces of the user device for indications that an auxiliary device has been connected. The low-power monitoring circuits may monitor electrical signals on a USB port, a proprietary diagnostic port, or another physical connection interface for signal transitions or voltage levels that indicate that an auxiliary device has been connected to the port. When the low-power monitoring circuits detect that an auxiliary device has been connected, the low-power monitoring circuits may generate a wake signal that causes the main processor to exit the deep sleep state and to begin executing pre-boot diagnostic operations.

The deep sleep state in which the main processor remains while the low-power monitoring circuits monitor for auxiliary device connection may be a low-power state in which the main processor is not executing instructions and in which most subsystems of the user device are unpowered. The deep sleep state may consume minimal power, which may enable the user device to remain in the deep sleep state for extended periods while waiting for an auxiliary device to be connected. When the wake signal is generated by the low-power monitoring circuits, the main processor may transition from the deep sleep state to an active state in which the main processor can execute instructions for pre-boot diagnostic operations. The transition from the deep sleep state to the active state may involve powering on additional power domains, initializing hardware components, and loading diagnostic software from a non-volatile memory portion.

The low-power monitoring circuits may be implemented using dedicated hardware components that are separate from the main processor and that have independent power supplies. The dedicated hardware components may include comparators, voltage detectors, or other circuits that can detect connection events with minimal power consumption. The low-power monitoring circuits may be powered by a small portion of the internal battery or by a dedicated low-power supply that remains active even when the main processor and most other components of the user device are unpowered. By using dedicated low-power monitoring circuits for wake-on-connection functionality, the system may enable detection of auxiliary device connection without requiring the main processor or other high-power components to remain active, which may minimize power consumption while the user device waits for a diagnostic session to be initiated.

The automated tests performed during pre-boot diagnostic operations may be configured in various arrangements depending on the particular diagnostic objectives, the types of anomalies being investigated, and the operational constraints of the diagnostic session.

In some cases, test suites may be organized hierarchically with quick screening tests followed by detailed diagnostic tests only if anomalies are detected. A hierarchical test suite organization may structure automated tests into multiple tiers or levels, where tests at higher levels of the hierarchy are designed to quickly identify potential problem areas, and tests at lower levels of the hierarchy are designed to perform more thorough investigation of specific subsystems or conditions. Quick screening tests at the top level of the hierarchy may be designed to execute rapidly and to provide broad coverage across multiple subsystems of the user device. Quick screening tests may check basic functionality of subsystems, may verify that subsystems respond to simple test stimuli, and may identify obvious failures or anomalies that indicate subsystem malfunction. Quick screening tests may be designed to complete within a short time period, which may enable rapid initial assessment of device health during pre-boot diagnostic operations. When quick screening tests complete without detecting anomalies, the diagnostic session may conclude without executing detailed diagnostic tests, which may reduce the overall duration of the diagnostic session for user devices that do not exhibit detectable problems. When quick screening tests detect anomalies or potential issues, detailed diagnostic tests may be executed to investigate the detected anomalies more thoroughly. Detailed diagnostic tests may perform more comprehensive testing of specific subsystems, may apply more rigorous test stimuli, may collect more detailed measurements, and may take longer to execute than quick screening tests. Detailed diagnostic tests may be targeted at the specific subsystems or conditions where quick screening tests detected anomalies, which may focus diagnostic effort on areas where problems are most likely to exist. Hierarchical organization of test suites may enable efficient use of diagnostic time by performing comprehensive testing only where initial screening indicates that such testing is warranted.

In some cases, tests may be prioritized based on specific anomalies stored in a protected memory portion of the user device. When device anomaly information is stored in a non-volatile memory portion that is accessible during pre-boot diagnostic operations, the stored anomaly information may indicate specific subsystems, conditions, or failure modes that were predicted or detected during normal operation of the user device. The automated test configuration may use the stored anomaly information to prioritize tests that are relevant to the stored anomalies, focusing diagnostic effort on suspected problem areas. When a diagnostic session begins, the automated test system may retrieve device anomaly information from the protected memory portion and may analyze the retrieved anomaly information to identify which subsystems are associated with stored anomalies, which types of anomalies have been predicted or detected, and which conditions or failure modes are indicated by the stored anomaly information. Based on the analysis of stored anomaly information, the automated test system may select tests that are relevant to the identified subsystems and anomaly types, and may prioritize execution of the selected tests ahead of other tests that are not directly related to the stored anomalies. Prioritizing tests based on stored anomaly information may enable the diagnostic session to focus on areas where problems have already been indicated by behavioral analysis during normal device operation, which may increase the likelihood of confirming or characterizing the indicated problems during the diagnostic session. Prioritization based on stored anomaly information may also reduce diagnostic time by ensuring that tests relevant to known or suspected issues are performed early in the diagnostic session, which may enable faster identification of problems that require attention.

In some cases, the system may support conditional test execution where certain tests are performed only if prerequisite conditions are met or if previous tests indicate potential issues. Conditional test execution may involve defining dependencies between tests, where execution of a particular test is contingent on the results of other tests or on the satisfaction of specified conditions. A prerequisite condition for a test may be a requirement that must be satisfied before the test can be meaningfully executed. Prerequisite conditions may include requirements that specific hardware components are present and functional, requirements that previous tests have completed successfully, requirements that specific subsystems are in particular states, or requirements that specific environmental conditions are present. When a test has prerequisite conditions defined, the automated test system may evaluate the prerequisite conditions before attempting to execute the test. If the prerequisite conditions are satisfied, the test may be executed. If the prerequisite conditions are not satisfied, the test may be skipped, deferred, or marked as not applicable. Conditional test execution may also be triggered by results of previous tests. When a previous test indicates a potential issue with a particular subsystem or component, additional tests that investigate the indicated issue in more detail may be conditionally executed. When a previous test completes without indicating issues, follow-up tests that would investigate issues related to the previous test may be skipped as unnecessary. Conditional test execution may enable the automated test system to adapt the diagnostic session based on information gathered during the session, which may enable more efficient and targeted diagnostic testing compared to executing a fixed sequence of tests regardless of intermediate results.

In some cases, test parameters such as duration, intensity, and pass/fail thresholds may be configurable. Test parameters may be values that control how a test is executed and how test results are evaluated. Duration parameters may specify how long a test runs, how many iterations of a test procedure are performed, or how long the test system waits for responses from subsystems under test. Intensity parameters may specify the magnitude of test stimuli applied to subsystems under test, such as signal levels, frequencies, or rates at which test operations are performed. Pass/fail thresholds may specify criteria for determining whether test results indicate normal operation or anomalous behavior, such as acceptable ranges for measured values, maximum error rates, or minimum performance levels. Configurable test parameters may enable the automated test system to be adapted for different diagnostic scenarios, different user device configurations, or different diagnostic objectives. Test parameters may be configurable through an auxiliary device that is connected to the user device during the diagnostic session. The auxiliary device may store configuration data that specifies test parameter values, and the auxiliary device may transmit the configuration data to the user device when a diagnostic session is initiated. The user device may apply the received configuration data to configure the automated tests that are executed during the diagnostic session. Configuration through the auxiliary device may enable technicians or diagnostic systems to customize test behavior for particular diagnostic scenarios without requiring modification of software stored on the user device. Test parameters may also be configurable through stored configuration data on the user device. Configuration data specifying test parameter values may be stored in a non-volatile memory portion of the user device, and the automated test system may read the stored configuration data when preparing to execute tests. Stored configuration data may be updated through software updates, through configuration operations performed during previous diagnostic sessions, or through other configuration mechanisms. Configuration through stored configuration data may enable test parameters to be established in advance of diagnostic sessions and may enable consistent test configurations across multiple diagnostic sessions performed on the same user device.

In some cases, test results may be stored alongside anomaly data in a protected memory portion of the user device for later analysis. When automated tests are executed during a pre-boot diagnostic session, the tests may generate result data that indicates the outcomes of the tests, measurements collected during the tests, and other information about test execution. Test result data may include pass/fail indications for individual tests, measured values for parameters that were tested, timestamps indicating when tests were executed, and diagnostic codes or messages that provide additional detail about test outcomes. Test result data may be stored in a non-volatile memory portion of the user device that is protected from deletion during factory reset operations, which may enable test results to be retained and accessed during subsequent diagnostic sessions or by external systems that retrieve diagnostic data from the user device. Storing test results alongside anomaly data may enable correlation between predicted or detected anomalies and the results of diagnostic tests that investigated those anomalies. When test results are stored in the protected memory portion, the stored test results may be retrieved during subsequent diagnostic sessions to provide historical context about previous diagnostic testing performed on the user device. Stored test results may also be retrieved by auxiliary devices or remote systems for analysis, reporting, or tracking of device diagnostic history. Storage of test results in protected memory may enable accumulation of diagnostic information over multiple diagnostic sessions, which may support identification of patterns or trends in device behavior that may not be apparent from a single diagnostic session.

In some cases, the automated tests may exercise certain functionality to identify anomalies that may be difficult to determine behaviorally. Behavioral analysis during normal device operation may detect many types of anomalies by monitoring subsystem interactions and identifying deviations from expected behavior patterns. However, some types of anomalies may not produce detectable behavioral signatures during normal device operation, or the behavioral signatures of some anomalies may be subtle or intermittent such that behavioral analysis may not reliably detect the anomalies. Automated tests executed during pre-boot diagnostic operations may apply specific test procedures that are designed to reveal anomalies that are difficult to detect through behavioral analysis alone. The automated tests may apply controlled test stimuli to subsystems, may place subsystems in specific states or configurations, and may collect measurements under controlled conditions that may reveal anomalies that are not apparent during normal device operation.

In some cases, the automated tests may cycle a screen of the user device through a number of patterns to enable detection of dead pixels. A dead pixel is a pixel on a display that does not function correctly, such as a pixel that remains permanently dark, permanently lit, or stuck at a particular color regardless of the image being displayed. Dead pixels may be difficult to detect through behavioral analysis during normal device operation because dead pixels may not produce distinctive behavioral signatures that can be detected by monitoring subsystem interactions. A dead pixel may affect only a small portion of the display area, and the visual impact of a dead pixel may depend on the content being displayed, which may make behavioral detection unreliable. Automated tests for dead pixel detection may cycle the display through a series of test patterns that are designed to make dead pixels visible. Test patterns for dead pixel detection may include solid color patterns where the entire display is filled with a single color, such as solid red, solid green, solid blue, solid white, or solid black patterns. When a solid color pattern is displayed, a dead pixel may appear as a point that differs from the surrounding pixels, such as a dark point on a solid white background or a bright point on a solid black background. Test patterns may also include checkerboard patterns, gradient patterns, or other patterns that may reveal pixels that are stuck at particular values or that do not respond correctly to changes in displayed content. The automated test may cycle through multiple test patterns in sequence, displaying each pattern for a duration that is sufficient to enable observation or measurement of pixel behavior.

In some cases, the automated tests may be performed on the user device while an auxiliary device attached to the user device detects the presence of dead pixels. When the user device cycles the display through test patterns for dead pixel detection, an auxiliary device that is connected to the user device may observe the display and may detect pixels that do not display the expected color or brightness for the current test pattern. The auxiliary device may include an optical sensor, a camera, or another imaging component that can capture images of the display while test patterns are being displayed. The auxiliary device may analyze the captured images to identify pixels that differ from expected values, which may indicate dead pixels or other display anomalies. The auxiliary device may compare pixel values in captured images against expected values for the current test pattern, and the auxiliary device may flag pixels where the captured values differ from expected values by more than a threshold amount. Detection of dead pixels by the auxiliary device may enable identification of display anomalies that may not be detectable by the user device itself, as the user device may not have the capability to observe its own display output in the manner that an external imaging device can. The auxiliary device may record the locations and characteristics of detected dead pixels, and the auxiliary device may store or transmit the dead pixel detection results for inclusion in diagnostic reports or for storage alongside other diagnostic data. Coordination between the user device executing display test patterns and the auxiliary device performing dead pixel detection may enable comprehensive display testing that identifies pixel-level anomalies that may affect display quality or user experience.

The predictive-analysis-related updates described herein may be delivered to user devices through various mechanisms depending on the network connectivity of the user device, the availability of update infrastructure, and the operational requirements of the diagnostic system.

In some cases, the predictive-analysis-related updates may be delivered through push notifications from a cloud server when updates are available. A cloud server may monitor for new predictive-analysis-related updates and may initiate delivery of the updates to user devices when the updates become available. When a new update is available, the cloud server may send a push notification to user devices that are registered to receive updates. The push notification may inform the user device that a new update is available, and the user device may respond to the push notification by initiating a download of the update from the cloud server. Push notification delivery may enable timely distribution of updates to user devices, as the cloud server may initiate the update delivery process as soon as updates become available rather than waiting for user devices to check for updates. Push notification delivery may be suitable for updates that address newly discovered anomaly patterns, updates that respond to emerging device issues, or updates that provide time-sensitive improvements to predictive analysis capabilities.

In some cases, the predictive-analysis-related updates may be delivered through periodic polling by the user device to check for updates. Periodic polling may involve the user device contacting a remote server at regular intervals to inquire whether new updates are available. The user device may be configured to poll for updates at specified intervals, such as daily, weekly, or at other intervals that are appropriate for the particular diagnostic application. When the user device polls for updates, the user device may send a request to the remote server that includes information identifying the current version of predictive analysis components installed on the user device. The remote server may compare the version information provided by the user device against the versions of available updates and may respond to the user device with information about updates that are available for download. If updates are available, the user device may download the updates from the remote server. Periodic polling may enable user devices to receive updates even when push notification infrastructure is not available or when the user device is not continuously connected to a network that supports push notifications.

In some cases, the predictive-analysis-related updates may be delivered bundled with operating system updates. Operating system updates may be software updates that are distributed by an operating system vendor to update the operating system software running on user devices. When predictive-analysis-related updates are bundled with operating system updates, the predictive-analysis-related updates may be included as part of the operating system update package and may be installed on the user device when the operating system update is installed. Bundling predictive-analysis-related updates with operating system updates may leverage existing update distribution infrastructure that is used for operating system updates, which may simplify the distribution of predictive-analysis-related updates and may ensure that predictive-analysis-related updates are delivered to user devices through a trusted update channel. Bundling with operating system updates may be suitable for predictive-analysis-related updates that are coordinated with changes to operating system components or that are intended to be deployed broadly across user devices that receive operating system updates.

In some cases, the predictive-analysis-related updates may be delivered through application store update mechanisms. Application stores may be software distribution platforms that enable users to download and install applications on user devices. Application stores may include update mechanisms that enable applications to be updated after initial installation. When predictive-analysis-related updates are delivered through application store update mechanisms, the updates may be packaged as updates to a diagnostic application or a predictive analysis application that is distributed through the application store. The application store may notify users when updates are available for installed applications, and users may initiate download and installation of the updates through the application store interface. Application store delivery may leverage existing application update infrastructure and may provide a familiar update experience for users who are accustomed to receiving application updates through application stores.

In some cases, the predictive-analysis-related updates may be delivered through peer-to-peer distribution among devices on the same local network. Peer-to-peer distribution may involve user devices sharing updates with other user devices that are connected to the same local network, such as a home network, an office network, or another local area network. When a user device receives a predictive-analysis-related update, the user device may make the update available to other user devices on the same local network. Other user devices on the local network may discover that the update is available from a peer device and may download the update from the peer device rather than downloading the update from a remote server. Peer-to-peer distribution may reduce bandwidth consumption on external network connections by enabling updates to be shared among devices on a local network after a single device has downloaded the update from a remote source. Peer-to-peer distribution may also enable update delivery in environments where external network connectivity is limited or where downloading updates from remote servers for each individual device would be impractical.

In some cases, the predictive-analysis-related updates may be delivered via an auxiliary device during diagnostic sessions. When an auxiliary device is connected to a user device for diagnostic operations, the auxiliary device may transfer predictive-analysis-related updates to the user device as part of the diagnostic session. The auxiliary device may store predictive-analysis-related updates that have been loaded onto the auxiliary device, and the auxiliary device may transfer the stored updates to user devices that are connected to the auxiliary device for diagnostics. Delivery via the auxiliary device may enable predictive-analysis-related updates to be installed on user devices that do not have network connectivity or that have not received updates through other delivery mechanisms. Delivery via the auxiliary device may also enable technicians or service personnel to ensure that user devices have current predictive analysis capabilities as part of diagnostic or service procedures.

The predictive-analysis-related updates may be delivered in various formats depending on the size of the updates, the nature of the changes included in the updates, and the bandwidth and storage constraints of the update delivery mechanism.

In some cases, updates may be delivered as complete replacement files. A complete replacement file may contain the entire content of a predictive analysis component, such as a complete specification file, a complete model file, or a complete configuration file. When an update is delivered as a complete replacement file, the user device may replace the existing version of the component with the new version contained in the complete replacement file. Delivery as complete replacement files may simplify the update installation process, as the user device may install the update by replacing the existing file with the new file without needing to apply changes to the existing file. Complete replacement files may be suitable for updates where the changes are extensive or where the updated component is relatively small such that delivering the complete file does not impose significant bandwidth or storage overhead.

In some cases, updates may be delivered as incremental patches. An incremental patch may contain instructions or data for modifying an existing version of a component to produce an updated version. Incremental patches may specify additions, deletions, or modifications to be applied to the existing component content. When an update is delivered as an incremental patch, the user device may apply the patch to the existing version of the component to produce the updated version. Incremental patches may be smaller than complete replacement files when the changes between versions are limited, which may reduce bandwidth consumption for update delivery and may reduce storage requirements for storing updates before installation. Incremental patches may be suitable for updates that make targeted changes to specific portions of a component while leaving other portions unchanged.

In some cases, updates may be delivered as differential updates that include only changed portions of the component. A differential update may be generated by comparing a previous version of a component with a new version and identifying the differences between the versions. The differential update may contain only the portions of the new version that differ from the previous version, along with information that enables the user device to reconstruct the new version by combining the unchanged portions of the previous version with the changed portions from the differential update. Differential updates may be smaller than complete replacement files when a significant portion of the component content remains unchanged between versions. Differential updates may enable efficient delivery of updates for large components where only a subset of the content has changed. The user device may apply a differential update by identifying the unchanged portions of the existing component, retrieving the changed portions from the differential update, and combining the unchanged and changed portions to produce the updated component.

In some cases, the system may implement staged rollouts where updates are delivered to a subset of devices initially before broader deployment. A staged rollout may involve releasing an update to a limited number of user devices or to a specific subset of user devices before releasing the update to all user devices. The initial subset of devices that receive the update during a staged rollout may be selected based on various criteria, such as device configuration, geographic location, user enrollment in early access programs, or random selection. During the initial stage of a staged rollout, the system may monitor the devices that have received the update for indications of problems or issues caused by the update. If the update performs as expected on the initial subset of devices without causing problems, the staged rollout may proceed to deliver the update to additional devices or to all remaining devices. If problems are detected during the initial stage of the staged rollout, the rollout may be paused or halted to prevent the problematic update from being delivered to additional devices. Staged rollouts may reduce the impact of updates that contain defects or that cause unexpected issues by limiting the number of devices affected before problems are detected and addressed.

In some cases, the system may include rollback capabilities if updates cause issues. Rollback capabilities may enable a user device to revert to a previous version of a predictive analysis component if an update causes problems after installation. When an update is installed on a user device, the user device may retain a copy of the previous version of the component that was replaced by the update. If the update causes issues, such as incorrect anomaly predictions, degraded diagnostic performance, or other problems, the user device may restore the previous version of the component by replacing the updated version with the retained copy of the previous version. Rollback capabilities may be triggered automatically when the system detects that an update has caused problems, or rollback capabilities may be triggered manually by a user, technician, or remote administrator. Automatic rollback may be triggered when the system detects error conditions, performance degradation, or other indicators that suggest the update is not functioning correctly. Manual rollback may be initiated through a user interface, through commands received from an auxiliary device, or through commands received from a remote server. Rollback capabilities may provide a safety mechanism that enables recovery from problematic updates without requiring complete reinstallation of diagnostic software or intervention by service personnel.

The diagnostic system described herein may be extended to coordinate across multiple user devices. In some cases, the diagnostic system may coordinate across multiple user devices that are associated with the same user. A user may own or operate multiple user devices, such as a smartphone, a tablet, a laptop computer, and a wearable device, and the diagnostic system may coordinate diagnostic operations and anomaly analysis across the multiple user devices associated with the user. Coordination across multiple user devices associated with the same user may enable identification of anomaly patterns that affect multiple devices used by the same user, which may indicate user-specific factors such as usage patterns, environmental conditions, or application configurations that contribute to device anomalies. In some cases, the diagnostic system may coordinate across multiple user devices within the same organizational fleet. An organizational fleet may comprise multiple user devices that are owned, managed, or deployed by an organization such as a business, an educational institution, a government agency, or another entity. Organizations may deploy fleets of user devices to employees, students, or other users, and the diagnostic system may coordinate diagnostic operations and anomaly analysis across the user devices within the organizational fleet. Coordination across user devices within an organizational fleet may enable identification of anomaly patterns that affect multiple devices within the fleet, which may indicate fleet-wide factors such as common device configurations, common software deployments, common usage environments, or common operational conditions that contribute to device anomalies.

In some cases, a central management server may aggregate anomaly data from multiple user devices. The central management server may receive device anomaly information from user devices that are enrolled in a coordinated diagnostic system. User devices may transmit device anomaly information to the central management server periodically, upon occurrence of specified events, or in response to requests from the central management server. The central management server may collect and store the received device anomaly information in a centralized data repository that aggregates anomaly data from multiple user devices. The aggregated anomaly data may include anomaly records from user devices associated with the same user, from user devices within the same organizational fleet, or from user devices across multiple users and organizations that participate in the coordinated diagnostic system.

The central management server may analyze the aggregated anomaly data to identify common failure patterns across multiple user devices. Common failure patterns may be anomaly patterns that occur on multiple user devices and that share common characteristics such as affected subsystems, anomaly types, timing patterns, or associated conditions. When the central management server identifies a common failure pattern, the identification may indicate that the pattern represents a systematic issue that affects multiple devices rather than an isolated issue affecting a single device. Common failure patterns may indicate design defects, manufacturing defects, or other issues that affect a population of devices. Identification of common failure patterns may enable device manufacturers, service providers, or fleet administrators to take corrective actions that address the underlying causes of the patterns, such as issuing software updates, initiating hardware recalls, or modifying device configurations.

The central management server may analyze the aggregated anomaly data to identify firmware issues that affect device reliability. Firmware issues may be defects, bugs, or other problems in firmware software that runs on user devices. Firmware issues may cause device anomalies that manifest across multiple user devices that are running the affected firmware version. The central management server may correlate anomaly data with firmware version information reported by user devices to identify associations between specific firmware versions and elevated rates of particular anomaly types. When the central management server identifies an association between a firmware version and elevated anomaly rates, the identification may indicate that the firmware version contains an issue that contributes to the observed anomalies. Identification of firmware issues may enable firmware developers to investigate and address the issues in subsequent firmware releases, and may enable fleet administrators to prioritize firmware updates for devices running affected firmware versions.

The central management server may analyze the aggregated anomaly data to identify environmental factors affecting device reliability. Environmental factors may include temperature conditions, humidity conditions, atmospheric conditions, geographic locations, network conditions, or other environmental characteristics that may influence device behavior and reliability. The central management server may correlate anomaly data with environmental context data reported by user devices to identify associations between specific environmental conditions and elevated rates of particular anomaly types. When the central management server identifies an association between an environmental condition and elevated anomaly rates, the identification may indicate that the environmental condition contributes to the observed anomalies. Identification of environmental factors affecting device reliability may enable device manufacturers to improve device designs for operation in challenging environmental conditions, may enable users to take precautions when operating devices in conditions associated with elevated anomaly rates, and may enable diagnostic systems to adjust anomaly detection thresholds based on environmental conditions.

In some cases, the system may implement comparative analysis that flags devices exhibiting anomalous behavior relative to peer devices. Peer devices may be user devices that have similar configurations, similar usage patterns, or other similar characteristics that make the peer devices suitable for comparison. Comparative analysis may involve comparing the behavior or anomaly patterns of a particular user device against the behavior or anomaly patterns of peer devices to identify whether the particular user device is exhibiting behavior that differs from the behavior of peer devices. When a user device exhibits behavior that differs from the behavior of peer devices by more than a threshold amount, the comparative analysis may flag the user device as exhibiting anomalous behavior relative to peer devices.

Peer devices for comparative analysis may be selected based on similar configurations. Similar configurations may include similar hardware configurations such as device model, hardware revision, component specifications, or manufacturing batch. Similar configurations may include similar software configurations such as operating system version, firmware version, installed applications, or configuration settings. Devices with similar configurations may be expected to exhibit similar behavior under similar conditions, and deviations from the behavior of peer devices with similar configurations may indicate device-specific issues that warrant investigation.

Peer devices for comparative analysis may be selected based on similar usage patterns. Similar usage patterns may include similar patterns of application usage, similar patterns of feature usage, similar patterns of network connectivity, or similar patterns of device activity over time. Devices with similar usage patterns may be expected to exhibit similar anomaly patterns, as similar usage may expose devices to similar operational stresses and conditions. Deviations from the anomaly patterns of peer devices with similar usage patterns may indicate device-specific issues that are not attributable to usage differences.

Comparative analysis may enable identification of devices that are experiencing issues that are not apparent from analysis of the individual device in isolation. A device may exhibit anomaly patterns that appear normal when analyzed individually but that appear anomalous when compared against the anomaly patterns of peer devices. Comparative analysis may identify devices that are experiencing elevated rates of particular anomaly types relative to peer devices, devices that are experiencing anomalies that are not occurring on peer devices, or devices that are not experiencing anomalies that are occurring on peer devices. Flagging devices that exhibit anomalous behavior relative to peer devices may enable prioritization of diagnostic attention for devices that may be experiencing device-specific issues.

In some cases, fleet-wide predictive models may be trained on aggregated data from multiple user devices. A fleet-wide predictive model may be a machine learning model or other predictive model that is trained using anomaly data, behavioral data, or other data aggregated from multiple user devices within a fleet or across multiple fleets. Training a predictive model on aggregated data from multiple user devices may enable the model to learn from a larger and more diverse dataset than would be available from any single user device. The larger and more diverse training dataset may enable the fleet-wide predictive model to recognize a broader range of anomaly patterns, to achieve higher prediction accuracy, and to generalize more effectively to new conditions or anomaly types that were not represented in data from any single device.

Fleet-wide predictive models may be deployed to individual user devices to improve local anomaly detection accuracy. After a fleet-wide predictive model is trained on aggregated data, the trained model may be distributed to individual user devices for use by predictive analysis components on the user devices. The predictive analysis component on each user device may use the deployed fleet-wide predictive model to predict device anomalies based on device-related information obtained from subsystems of the user device. Because the fleet-wide predictive model was trained on data from multiple user devices, the deployed model may provide improved anomaly detection accuracy compared to models that were trained only on data from the individual user device. Deployment of fleet-wide predictive models to individual user devices may enable each user device to benefit from collective learning across the fleet while performing anomaly prediction locally on the user device.

In some cases, privacy-preserving techniques may be employed to enable collective learning while protecting individual device data. Privacy-preserving techniques may enable the diagnostic system to train fleet-wide predictive models or to perform other collective analysis operations using data from multiple user devices without exposing the underlying data from individual user devices to the central management server or to other parties. Privacy-preserving techniques may address privacy concerns that may arise when diagnostic data from user devices is aggregated or shared for collective analysis.

In some cases, federated learning may be employed as a privacy-preserving technique for training fleet-wide predictive models. Federated learning is a machine learning approach in which a model is trained across multiple decentralized devices or servers holding local data samples, without exchanging the local data samples. In a federated learning approach for training fleet-wide predictive models, each user device may train a local version of a predictive model using device-related information and anomaly data that is stored locally on the user device. The user device may compute model updates, such as gradient updates or parameter updates, based on the local training performed on the user device. The user device may transmit the computed model updates to a central server without transmitting the underlying local data that was used to compute the updates. The central server may aggregate model updates received from multiple user devices to produce an updated global model. The updated global model may be distributed back to the user devices, and the process may be repeated iteratively to train the global model using data from multiple user devices. Federated learning may enable training of fleet-wide predictive models using data from multiple user devices while keeping the underlying data on each user device, which may protect the privacy of device-specific data.

In some cases, differential privacy may be employed as a privacy-preserving technique for collective analysis of diagnostic data. Differential privacy is a mathematical framework for quantifying and limiting the privacy loss that occurs when information is released about a dataset. Differential privacy techniques may add controlled amounts of noise to data or to computations performed on data such that the released information does not reveal whether any particular individual or device contributed to the dataset. When differential privacy is applied to collective analysis of diagnostic data, the diagnostic system may add noise to anomaly data, to aggregated statistics, or to model updates before the data or statistics are shared or released. The added noise may be calibrated to provide a specified level of privacy protection while still enabling useful analysis of the aggregated data. Differential privacy may enable the diagnostic system to release aggregate statistics about anomaly patterns, to train predictive models on aggregated data, or to perform other collective analysis operations while providing mathematical guarantees that the released information does not reveal sensitive information about individual user devices or users.

In some cases, federated learning and differential privacy may be combined to provide enhanced privacy protection for collective learning operations. When federated learning is combined with differential privacy, model updates computed by individual user devices may have noise added before the updates are transmitted to a central server. The added noise may provide differential privacy guarantees that limit the information about individual device data that can be inferred from the transmitted model updates. Combining federated learning with differential privacy may provide multiple layers of privacy protection: federated learning may keep raw data on individual devices, and differential privacy may limit the information that can be inferred from the model updates that are shared. The combination of federated learning and differential privacy may enable training of fleet-wide predictive models with strong privacy guarantees while still enabling the trained models to benefit from collective learning across multiple user devices.

The system described herein may include various mechanisms for notifying users about detected anomalies and for enabling user interaction with diagnostic information. Notifications about detected anomalies may inform users of potential issues with user devices, may provide information about the nature and severity of detected anomalies, and may guide users toward appropriate actions for addressing the detected anomalies.

In some cases, notifications about detected anomalies may be delivered through operating system notification frameworks. An operating system notification framework may be a software component of an operating system that provides standardized mechanisms for applications and system services to present notifications to users. Operating system notification frameworks may display notifications in notification areas, notification centers, lock screens, or other user interface locations that are designated for presenting notifications to users. When a predictive analysis component detects or predicts an anomaly, the predictive analysis component may generate a notification that is delivered to the user through the operating system notification framework. The notification may include information about the detected anomaly, such as an indication of the affected subsystem, a description of the anomaly, a severity level, or recommended actions. Notifications delivered through operating system notification frameworks may appear alongside other notifications from applications and system services, which may provide a consistent notification experience for users who are accustomed to receiving notifications through the operating system notification framework. Operating system notification frameworks may support various notification presentation options, such as banners, alerts, badges, or sounds, and the diagnostic system may configure notification presentation based on the severity or urgency of the detected anomaly.

In some cases, notifications about detected anomalies may be delivered through dedicated diagnostic applications. A dedicated diagnostic application may be a software application that is installed on a user device and that provides user interface functionality for interacting with diagnostic features of the user device. The dedicated diagnostic application may include a notification interface that presents notifications about detected anomalies to users. When a predictive analysis component detects or predicts an anomaly, the predictive analysis component may communicate the anomaly information to the dedicated diagnostic application, and the dedicated diagnostic application may present a notification to the user through the application’s user interface. The dedicated diagnostic application may provide more detailed information about detected anomalies than may be practical to include in operating system notifications, and the dedicated diagnostic application may provide interactive features that enable users to explore anomaly details, view historical anomaly data, or initiate diagnostic actions. The dedicated diagnostic application may maintain a history of notifications about detected anomalies, which may enable users to review past notifications and to track anomaly patterns over time.

In some cases, notifications about detected anomalies may be delivered through email alerts. An email alert may be an electronic mail message that is sent to a user’s email address to notify the user about a detected anomaly. When a predictive analysis component detects or predicts an anomaly, the diagnostic system may generate an email message that contains information about the detected anomaly and may send the email message to an email address associated with the user or with the user device. Email alerts may be suitable for notifications that do not require immediate user attention or for notifications that users may want to retain for future reference. Email alerts may include detailed information about detected anomalies, links to additional resources or support information, and instructions for addressing the detected anomalies. Email alerts may be sent by a remote server that receives anomaly information from user devices, or email alerts may be sent directly by user devices that have email sending capabilities configured.

In some cases, notifications about detected anomalies may be delivered through SMS messages. An SMS (Short Message Service) message may be a text message that is sent to a user’s mobile phone number to notify the user about a detected anomaly. When a predictive analysis component detects or predicts an anomaly, the diagnostic system may generate an SMS message that contains information about the detected anomaly and may send the SMS message to a phone number associated with the user. SMS messages may be suitable for notifications that require timely delivery to users who may not be actively using the user device or who may not have access to email. SMS messages may have character length limitations, and notifications delivered through SMS messages may include concise summaries of detected anomalies with links or instructions for obtaining additional information. SMS messages may be sent by a remote server that receives anomaly information from user devices and that has SMS sending capabilities.

In some cases, notifications about detected anomalies may be delivered through integration with device manufacturer support portals. A device manufacturer support portal may be a web-based or application-based platform operated by a device manufacturer that provides support services, information, and resources to users of the manufacturer’s devices. When a predictive analysis component detects or predicts an anomaly, the diagnostic system may transmit anomaly information to the device manufacturer support portal. The support portal may process the received anomaly information and may generate notifications that are presented to users when users access the support portal. Notifications delivered through support portal integration may be presented within the support portal user interface, may be included in support portal dashboards or status displays, or may trigger other notification mechanisms provided by the support portal. Support portal integration may enable coordination between anomaly notifications and other support services provided through the support portal, such as warranty information, repair services, or technical support resources.

In some cases, the system may offer guided troubleshooting workflows that help users address detected issues. A guided troubleshooting workflow may be a structured sequence of steps, instructions, or interactive prompts that guide a user through a process for diagnosing or resolving a detected issue. When a predictive analysis component detects or predicts an anomaly, the diagnostic system may present a guided troubleshooting workflow to the user that is tailored to the specific anomaly that was detected. The guided troubleshooting workflow may include steps for verifying the presence of the issue, steps for performing basic remediation actions, steps for collecting additional diagnostic information, and steps for escalating to professional service if the issue cannot be resolved through user actions. Guided troubleshooting workflows may be presented through a dedicated diagnostic application, through operating system interfaces, or through web-based interfaces accessed via links in notifications. Guided troubleshooting workflows may adapt based on user responses and actions, presenting different steps or branches depending on the outcomes of previous steps. Guided troubleshooting workflows may enable users to address certain detected issues without requiring professional service, which may reduce inconvenience for users and may reduce service costs for device manufacturers or service providers.

In some cases, the system may provide recommendations for preventive actions based on detected anomalies. A preventive action recommendation may be a suggestion for an action that a user can take to prevent a detected anomaly from worsening, to prevent related issues from occurring, or to maintain device health and reliability. When a predictive analysis component detects or predicts an anomaly, the diagnostic system may analyze the anomaly and may generate recommendations for preventive actions that are relevant to the detected anomaly. Preventive action recommendations may include suggestions for changing device settings, suggestions for updating software, suggestions for modifying usage patterns, suggestions for environmental precautions, or suggestions for maintenance actions. Preventive action recommendations may be presented to users through notifications, through dedicated diagnostic applications, or through other user interface mechanisms. Preventive action recommendations may help users take proactive steps to maintain device health and to avoid more serious issues that might result if detected anomalies are not addressed.

In some cases, the system may provide direct links to schedule service appointments based on detected anomalies. A direct link to schedule a service appointment may be a hyperlink, button, or other user interface element that, when activated by a user, initiates a process for scheduling a service appointment with a service provider, repair facility, or device manufacturer service center. When a predictive analysis component detects or predicts an anomaly that may require professional service to address, the diagnostic system may include a direct link to schedule a service appointment in notifications or in diagnostic application interfaces presented to the user. Activation of the direct link may open a scheduling interface, may navigate to a service appointment scheduling website, or may initiate communication with a service scheduling system. The scheduling interface or system may be pre-populated with information about the detected anomaly, the user device, and the user, which may streamline the appointment scheduling process. Direct links to schedule service appointments may reduce friction for users who need professional service by providing a convenient path from anomaly notification to service scheduling.

In some cases, user consent mechanisms may be implemented to control what diagnostic data is collected, stored, and shared with service providers. A user consent mechanism may be a user interface element, setting, or process through which a user can indicate consent or refusal of consent for particular data collection, storage, or sharing activities. User consent mechanisms may enable users to make informed decisions about how diagnostic data from user devices is handled. User consent mechanisms may be presented to users during initial device setup, during installation of diagnostic applications, or at other times when consent decisions are relevant. User consent mechanisms may provide information to users about what diagnostic data is collected, how the diagnostic data is stored, with whom the diagnostic data may be shared, and for what purposes the diagnostic data may be used. Users may be able to grant or withhold consent for different categories of diagnostic data collection, storage, or sharing. For example, a user may consent to collection and local storage of diagnostic data while withholding consent for sharing diagnostic data with remote servers or service providers. User consent mechanisms may enable users to change consent decisions over time, allowing users to grant consent that was previously withheld or to withdraw consent that was previously granted. The diagnostic system may respect user consent decisions by collecting, storing, and sharing diagnostic data only in accordance with the consent that has been granted by the user. User consent mechanisms may help ensure that users retain control over diagnostic data from user devices and may address privacy concerns that users may have about diagnostic data collection and sharing.

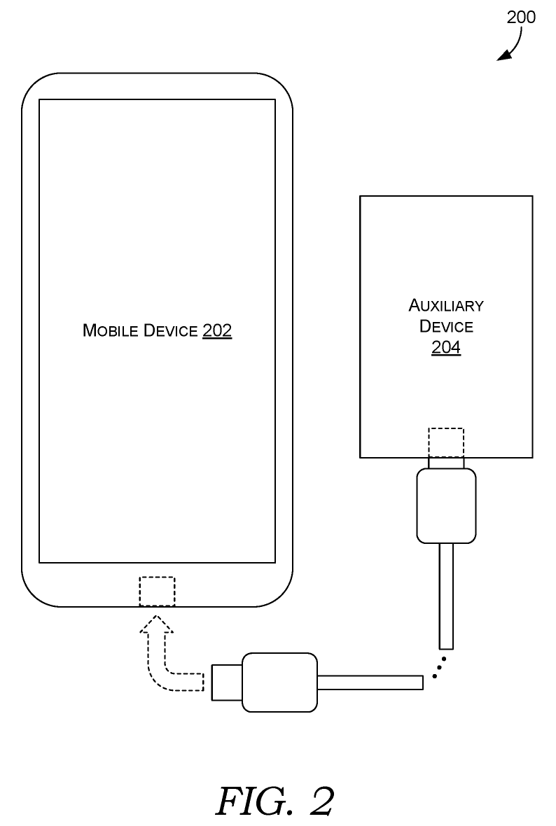

Referring to FIG. 2, a system 200 for facilitating diagnostics related to a user device is illustrated in accordance with one or more embodiments. The system 200 depicts a device diagnostics use case in which a mobile device 202 interacts with an auxiliary device 204 during a diagnostic session. The mobile device 202 may be a user device such as a smartphone, tablet, or other portable electronic device that includes a display screen and a housing. The auxiliary device 204 may be a diagnostic tool, storage device, or other device that is configured to retrieve diagnostic data from the mobile device 202.

As shown in FIG. 2, the auxiliary device 204 may be connected to the mobile device 202 through a cable connection that extends from a bottom portion of the mobile device 202 to the auxiliary device 204. The cable connection may establish a physical communication link between the mobile device 202 and the auxiliary device 204. The connection may be established through a connector such as a USB connector, a Lightning connector, a proprietary diagnostic connector, or another type of physical connector that enables data transfer and communication between the mobile device 202 and the auxiliary device 204.

With continued reference to FIG. 2, the mobile device 202 may initially be in a powered-off state or in a low-power state in which a portion of non-volatile memory of the mobile device 202 and a majority of components of the mobile device 202 are unpowered. When the auxiliary device 204 is connected to the mobile device 202, such as by plugging the auxiliary device 204 into a port of the mobile device 202 via the cable connection, the mobile device 202 may detect the presence of the auxiliary device 204. Detection of the auxiliary device 204 may be performed by monitoring circuits of the mobile device 202 that are capable of detecting electrical signals or connection events on the port interface even while the mobile device 202 is in a low-power state.

Responsive to detection of the auxiliary device 204, the mobile device 202 may establish a connection with the auxiliary device 204. The connection establishment may involve initialization of communication protocols, exchange of identification information between the mobile device 202 and the auxiliary device 204, and configuration of data transfer parameters. In some cases, the connection establishment may involve authentication procedures to verify that the auxiliary device 204 is authorized to access diagnostic data stored on the mobile device 202.

Upon detection of the auxiliary device 204 and establishment of the connection, the mobile device 202 may cause a non-volatile memory portion to be powered while most components of the mobile device 202 remain unpowered. The non-volatile memory portion that is powered may be a protected memory region where device anomaly information has been stored during previous operation of the mobile device 202 in a post-boot environment. By selectively powering the non-volatile memory portion while keeping most other components of the mobile device 202 unpowered, the mobile device 202 may enable retrieval of diagnostic data while minimizing overall power consumption during the diagnostic session.

The components of the mobile device 202 that remain unpowered during the diagnostic session may include display subsystems, communication subsystems such as cellular and Wi-Fi radios, sensor subsystems, and other subsystems that are not required for the retrieval and transfer of device anomaly information. By keeping these components unpowered, the mobile device 202 may conserve battery power and may avoid potential interference from subsystem operations that are not relevant to the diagnostic data retrieval process.

As further shown in FIG. 2, the mobile device 202 may obtain device anomaly information that is stored on the non-volatile memory portion. The device anomaly information may include predicted device anomalies that were detected and stored by a predictive analysis component of the mobile device 202 while the mobile device 202 was previously operating in a post-boot environment. The device anomaly information may include anomaly identifiers, timestamps indicating when anomalies were detected or predicted, affected subsystem identifiers, severity levels, confidence scores, and other data that characterizes the predicted anomalies.

The mobile device 202 may cause the obtained device anomaly information to be stored on the auxiliary device 204. The auxiliary device 204 may comprise an auxiliary memory that receives and stores the device anomaly information transferred from the mobile device 202. Transfer of the device anomaly information from the mobile device 202 to the auxiliary device 204 may be performed through the cable connection that links the two devices. The transfer may use data transfer protocols that are supported by the connection interface, such as USB data transfer protocols or other protocols appropriate for the type of connection established between the mobile device 202 and the auxiliary device 204.

In some cases, the device anomaly information transferred to the auxiliary device 204 may be encrypted. The mobile device 202 may have encrypted the device anomaly information prior to storage in the non-volatile memory portion, and the encrypted device anomaly information may be transferred to the auxiliary device 204 in encrypted form. The auxiliary device 204 may store the encrypted device anomaly information and may subsequently transmit the encrypted device anomaly information to a remote server for decryption and analysis. In some cases, the auxiliary device 204 may have decryption capabilities that enable the auxiliary device 204 to decrypt the device anomaly information locally, depending on the encryption scheme used and the availability of appropriate decryption keys.

With continued reference to FIG. 2, the auxiliary device 204 may store computer program instructions for automated tests that are executed when the mobile device 202 establishes connection with the auxiliary device 204. When the connection is established between the mobile device 202 and the auxiliary device 204, the automated test instructions may be obtained at the mobile device 202 from the auxiliary device 204. The mobile device 202 may execute the automated test instructions to perform automated tests on the mobile device 202 while the mobile device 202 is running in a pre-boot environment and while the device anomaly information is being obtained from the non-volatile memory portion.

The automated tests performed during the diagnostic session may exercise functionality of the mobile device 202 to identify anomalies that may be difficult to determine through behavioral analysis alone. In some cases, the automated tests may cycle a display of the mobile device 202 through test patterns that enable detection of display anomalies such as dead pixels. The auxiliary device 204 may include sensors or imaging components that observe the display of the mobile device 202 during the test pattern display and that detect pixels exhibiting anomalous behavior. Results of the automated tests may be stored on the auxiliary device 204 alongside the device anomaly information retrieved from the non-volatile memory portion of the mobile device 202.

The diagnostic session illustrated in FIG. 2 may enable retrieval of device anomaly information from the mobile device 202 even when the mobile device 202 has undergone a factory reset. Because the device anomaly information is stored in a non-volatile memory portion that is protected from deletion during factory reset operations, the device anomaly information may remain available for retrieval during the diagnostic session regardless of whether a factory reset has been performed on the mobile device 202. The diagnostic session may provide technicians or automated diagnostic systems with access to predicted anomaly information that was captured during normal operation of the mobile device 202, which may assist in diagnosing issues that led to the mobile device 202 being submitted for service or repair.

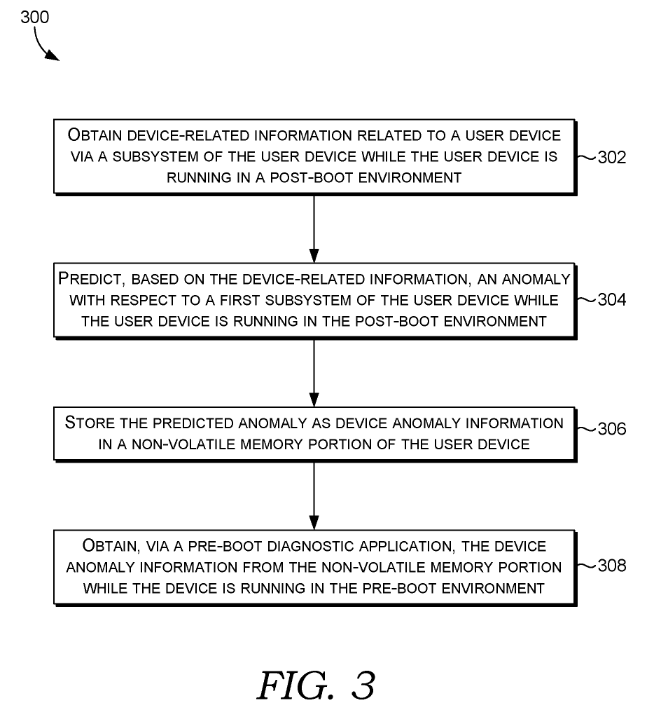

Referring to FIG. 3, a method 300 of facilitating diagnostics related to a user device is illustrated in accordance with one or more embodiments. The method 300 may be implemented by a processor executing computer program instructions, and the method 300 may be performed by components of a user device such as the user device 104a described with reference to FIG. 1. The method 300 includes a sequence of steps that enable collection of behavioral data during normal device operation, prediction of potential anomalies based on the collected data, preservation of predicted anomaly information in protected storage, and subsequent retrieval of the stored information during a pre-boot diagnostic session.

The method 300 begins with a step 302, where device-related information related to the user device is obtained from a subsystem of the user device while the user device is operating in a post-boot environment. The post-boot environment may be a normal operating state of the user device after a boot process has completed and an operating system of the user device is loaded and executing. In the post-boot environment, the operating system may be managing hardware resources and running applications, and higher-level software such as diagnostic applications, background monitoring processes, or predictive analysis algorithms may be executing within the operating system environment. The device-related information may be obtained via the predictive analysis component 116 described with reference to FIG. 1, and the predictive analysis component 116 may obtain the device-related information from the subsystem, work with the subsystem to obtain the device-related information, or otherwise obtain the device-related information via the subsystem.

With continued reference to FIG. 3, the device-related information obtained at the step 302 may comprise various types of information depending on the particular subsystem from which the information is obtained and the types of anomalies being detected. In some cases, the device-related information may comprise one or more outputs from the subsystem, such as subsystem outputs related to one or more inputs provided to a first subsystem of the user device, or subsystem outputs resulting from one or more inputs provided to the subsystem by the first subsystem. In some cases, the device-related information may comprise one or more outputs of the first subsystem, such as first subsystem outputs that were provided as inputs to one or more other subsystems of the user device. In some cases, the device-related information may comprise information indicating one or more artifacts in the first subsystem outputs. In some cases, the device-related information may comprise information indicating one or more errors, such as errors in the first subsystem outputs or errors resulting from one or more other subsystem’s processing of the first subsystem outputs. In some cases, the device-related information may comprise information indicating one or more potential causes of artifacts, anomalies, errors, or pattern changes.

The subsystem from which the device-related information is obtained at the step 302 may be a subsystem other than the first subsystem for which anomalies are predicted. In some cases, the subsystem may be a subsystem that provides input to, processes outputs from, or responds to the first subsystem for which anomalies are predicted. By obtaining device-related information from subsystems that interact with the first subsystem, the method 300 may enable detection of anomalies in the first subsystem based on how other subsystems respond to or interact with the first subsystem, even when the first subsystem does not directly report an anomaly. In some cases, the subsystem from which the device-related information is obtained may comprise the first subsystem for which anomalies are predicted, such that the first subsystem provides device-related information about its own operation.

As further shown in FIG. 3, the method 300 proceeds from the step 302 to a step 304, where an anomaly with respect to a first subsystem of the user device is predicted based on the device-related information while the user device is running in the post-boot environment. The prediction at the step 304 may be performed by the predictive analysis component 116 described with reference to FIG. 1. The predicted anomaly may comprise a software-related issue, a hardware-related issue, or another type of anomaly with respect to the first subsystem of the user device. In some cases, the predicted anomaly may be a user interface anomaly related to a user interface subsystem of the user device. In some cases, the predicted anomaly may be a camera anomaly related to a camera subsystem of the user device. In some cases, the predicted anomaly may be a touch screen anomaly related to a touch screen subsystem of the user device.

The prediction at the step 304 may be based on various analytical approaches depending on the type of device-related information obtained at the step 302 and the type of anomaly being predicted. In some cases, the prediction may be based on processing an output of the first subsystem that is provided as an input to the subsystem from which the device-related information is obtained. The device-related information may be obtained based on the processing of the output received from the first subsystem at the subsystem. In some cases, the prediction may be based on detection of an artifact in the input to the subsystem, where the device-related information is obtained based on the detection of the artifact.

In some cases, the prediction at the step 304 may be based on determining an inconsistency between an output of the subsystem and an action or an inaction of the first subsystem. When the device-related information comprises an output from the subsystem, the predictive analysis component 116 may determine an inconsistency between the output of the subsystem and an action or an inaction of the first subsystem, and the anomaly with respect to the first subsystem may be predicted based on the determined inconsistency while the user device is running in the post-boot environment. Inconsistencies between subsystem outputs and first subsystem actions or inactions may indicate that the first subsystem is not responding as expected to conditions or inputs that are indicated by the outputs of other subsystems.

In some cases, the prediction at the step 304 may be based on determining a difference between action or inaction patterns related to the first subsystem. The predictive analysis component 116 may determine a difference between a first action pattern or a first inaction pattern and a second action pattern or a second inaction pattern related to the first subsystem. The first action pattern or the first inaction pattern may reflect the most recent actions or most recent inactions related to the first subsystem, and the second action pattern or the second inaction pattern may reflect prior actions or prior inactions related to the first subsystem. The anomaly with respect to the first subsystem may be predicted based on the device-related information and the determined difference while the user device is running in the post-boot environment. In some cases, the device-related information may comprise an output from the subsystem, and the anomaly with respect to the first subsystem may be predicted based on the output of the subsystem and the determined difference. In some cases, the output of the subsystem may indicate a potential cause of the determined difference, and the anomaly with respect to the first subsystem may be predicted based on the potential cause indication and the determined difference while the user device is running in the post-boot environment.

With continued reference to FIG. 3, the method 300 proceeds from the step 304 to a step 306, where the predicted anomaly is stored as device anomaly information in a portion of non-volatile memory of the user device. The storage at the step 306 may be performed by the diagnostics storage component 118 described with reference to FIG. 1. The non-volatile memory portion in which the device anomaly information is stored may be a memory portion that is accessible in a pre-boot environment in which a pre-boot diagnostic application executes. By storing the predicted anomaly in a non-volatile memory portion that is accessible in a pre-boot environment, the method 300 may enable the device anomaly information to be retrieved during subsequent diagnostic operations even when the user device is not fully booted into the operating system.

The non-volatile memory portion in which the device anomaly information is stored at the step 306 may be a restricted memory portion that provides protection for the stored device anomaly information. In some cases, information stored on the non-volatile memory portion may be preserved during a factory reset of the user device, such that the device anomaly information remains available for retrieval even after a factory reset has been performed. In some cases, the user device may be programmed to restrict read access to the non-volatile memory portion, such as preventing read access by any application or user while the user device is in a post-boot environment in which an operating system of the user device executes, or limiting read access to applications or users with root permission. In some cases, the user device may be programmed to restrict write access to the non-volatile memory portion, such as preventing write access by any application or user while the user device is in a post-boot environment, or limiting write access to applications or users with root permissions.

As further shown in FIG. 3, the method 300 proceeds from the step 306 to a step 308, where the device anomaly information is obtained from the non-volatile memory portion. The obtainment at the step 308 may be performed via a pre-boot diagnostic application while the user device is running in a pre-boot environment. The pre-boot environment may be an early execution phase before the operating system starts or when running in a specialized diagnostic mode that does not rely on the operating system. In the pre-boot environment, the user device may be running at a firmware level, such as within a bootloader, recovery mode, or a pre-boot diagnostic tool. The operating system may not be active in the pre-boot environment, but limited functions such as accessing non-volatile memory to retrieve stored anomaly data may be available. The obtainment at the step 308 may be performed by the pre-boot diagnostics component 120 described with reference to FIG. 1.

The pre-boot diagnostic application that obtains the device anomaly information at the step 308 may be a diagnostic application that executes in the pre-boot environment and that is capable of accessing the non-volatile memory portion where the device anomaly information is stored. The pre-boot diagnostic application may retrieve the device anomaly information from the non-volatile memory portion and may make the device anomaly information available for diagnostic analysis, for transfer to an auxiliary device such as the auxiliary device 106a described with reference to FIG. 1, or for other diagnostic purposes. Because the device anomaly information was predicted and stored while the user device was running in the post-boot environment, the device anomaly information obtained at the step 308 may reflect anomalies that were detected in the context of normal device operation, which may provide diagnostic insights that would not be available from tests performed only in the pre-boot environment.

In some cases, the method 300 may include performing an automated test on the user device while obtaining the device anomaly information from the non-volatile memory portion in the pre-boot environment. The automated test may exercise functionality of the user device to identify anomalies that may be difficult to determine through behavioral analysis alone. The automated test may be performed concurrently with or sequentially with the obtainment of the device anomaly information at the step 308, and results of the automated test may be combined with the device anomaly information to provide a more comprehensive diagnostic assessment of the user device.

In some cases, the method 300 may include reducing overall power consumption via a power management subsystem while the user device is running in the pre-boot environment such that most components of the user device are unpowered. The power management subsystem may be the power management component 122 described with reference to FIG. 1. By reducing overall power consumption during the pre-boot environment, the method 300 may enable diagnostic operations to be performed with minimal power draw, which may be beneficial when the user device has limited battery charge or when power conservation during diagnostic operations is desired.

In some cases, the method 300 may include providing power to the non-volatile memory portion via a power management subsystem while a second non-volatile memory portion and most components of the user device remain unpowered, enabling retrieval of the device anomaly information from the non-volatile memory portion. Selective powering of the non-volatile memory portion while other components remain unpowered may enable the device anomaly information to be retrieved with minimal overall power consumption. In some cases, the method 300 may include detecting an auxiliary device while the non-volatile memory portion and most components of the user device remain unpowered, and upon detecting the auxiliary device, power may be provided to the non-volatile memory portion while the second non-volatile memory portion and most components remain unpowered, enabling retrieval of the device anomaly information. Detection of the auxiliary device may trigger the selective powering of the non-volatile memory portion, which may enable automated initiation of diagnostic data retrieval when an auxiliary device is connected to the user device.

In some cases, the auxiliary device may comprise an auxiliary memory, and the method 300 may include storing the device anomaly information on the auxiliary memory via the pre-boot diagnostic application while the user device is running in the pre-boot environment. Storage of the device anomaly information on the auxiliary memory may enable the device anomaly information to be transferred from the user device to the auxiliary device for subsequent analysis, reporting, or transmission to remote diagnostic systems.

In some cases, the method 300 may include detecting installation or retrieval of an application for installation on the user device, obtaining a predictive-analysis-related update related to the application from a remote computer system via a network in response to the detection, and predicting the anomaly based on the device-related information and the predictive-analysis-related update while the user device is running in the post-boot environment. The predictive-analysis-related update may provide updated behavioral analysis parameters, updated anomaly detection rules, or other updates that are tailored to the installed or retrieved application. By obtaining predictive-analysis-related updates in response to application installation or retrieval, the method 300 may enable the predictive analysis capabilities of the user device to be updated to account for new applications and the subsystem interactions that the new applications may involve.

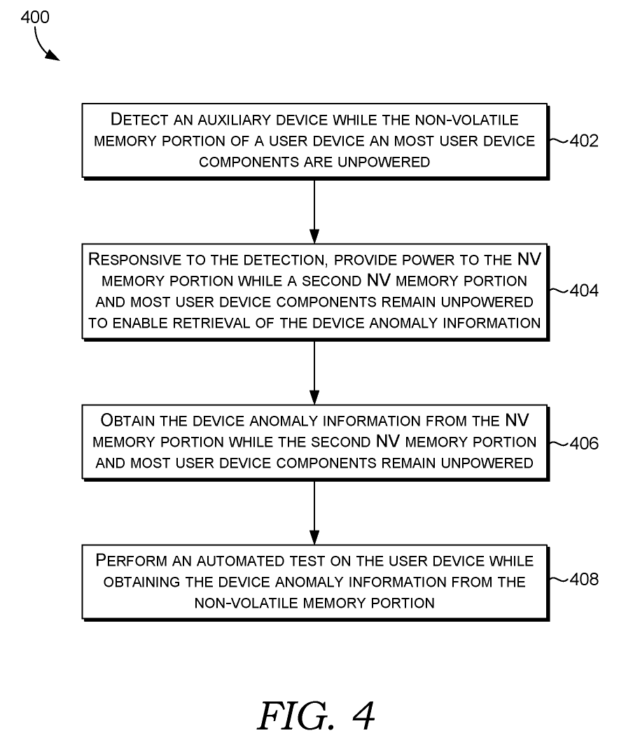

Referring to FIG. 4, a method 400 of obtaining device anomaly information from a portion of non-volatile memory of a user device while another portion of the non-volatile memory and most user device components remain unpowered is illustrated in accordance with one or more embodiments. The method 400 may be implemented by a processor executing computer program instructions, and the method 400 may be performed by components of a user device such as the user device 104a described with reference to FIG. 1. The method 400 includes a sequence of steps that enable retrieval of device anomaly information from a protected non-volatile memory portion while minimizing overall power consumption by keeping most components of the user device unpowered during the retrieval process.

The method 400 begins with a step 402, where an auxiliary device is detected while a non-volatile memory portion of the user device and most components of the user device are unpowered. The detection at the step 402 may be performed by monitoring circuits of the user device that are capable of detecting the presence of an auxiliary device even while the user device is in a low-power state in which the non-volatile memory portion and most components are unpowered. The monitoring circuits may be low-power circuits that operate with minimal power consumption and that can detect connection events or proximity of an auxiliary device without requiring the main processor or other high-power components of the user device to be active.

With continued reference to FIG. 4, the auxiliary device detected at the step 402 may be detected as being physically connected to the user device. Physical connection detection may involve monitoring electrical signals on a port interface of the user device, such as a USB port, a proprietary diagnostic port, or another physical connection interface. When an auxiliary device is physically connected to the port, the monitoring circuits may detect signal transitions, voltage levels, or other electrical characteristics that indicate the presence of the connected auxiliary device. In some cases, the auxiliary device detected at the step 402 may be detected as being in proximity to the user device. Proximity detection may involve monitoring for wireless communication signals from an auxiliary device that is within a communication range of the user device. The auxiliary device may be detected as being within a Bluetooth communication range, a Near Field Communication (NFC) range, some other short wireless communication range, or other proximity to the user device. Proximity-based detection may enable the user device to detect the presence of an auxiliary device without requiring a physical cable connection between the auxiliary device and the user device.

The detection at the step 402 may be performed by the pre-boot diagnostics component 120 described with reference to FIG. 1. The pre-boot diagnostics component 120 may include or interface with the monitoring circuits that detect the auxiliary device while the non-volatile memory portion and most components of the user device are unpowered. The pre-boot diagnostics component 120 may receive detection signals from the monitoring circuits and may initiate subsequent steps of the method 400 responsive to detection of the auxiliary device.

As further shown in FIG. 4, the method 400 proceeds from the step 402 to a step 404, where power is provided to the non-volatile memory portion responsive to the detection of the auxiliary device while another portion of the non-volatile memory and most components of the user device remain unpowered to enable obtainment of device anomaly information from the non-volatile memory portion. The power provision at the step 404 may be performed by the power management component 122 described with reference to FIG. 1. Responsive to the detection of the auxiliary device at the step 402, the power management component 122 may selectively enable power to the non-volatile memory portion where device anomaly information is stored while keeping other portions of non-volatile memory and most components of the user device in an unpowered state.

With continued reference to FIG. 4, the selective power provision at the step 404 may enable retrieval of the device anomaly information while minimizing overall power consumption during the diagnostic data retrieval process. Most of the non-volatile memory of the user device may remain unpowered at the step 404, such that only the portion of non-volatile memory where device anomaly information is stored receives power. Most components of the user device may remain unpowered at the step 404, such that components that are not required for the retrieval and transfer of device anomaly information do not consume power during the retrieval process. In some cases, substantially more of the non-volatile memory and substantially more components of the user device may remain unpowered as respectively compared to the parts of the non-volatile memory and components of the user device that are powered at the step 404.

The components of the user device that are powered at the step 404 may include the non-volatile memory portion where device anomaly information is stored, components that are used for operations related to obtaining and transmitting device anomaly information from the non-volatile memory portion to a destination such as the auxiliary device, components that are used for operations related to performing power management, and components that are used for operations related to one or more automated tests to be performed on the user device. Components of the user device that are not required for these operations may remain unpowered at the step 404, which may conserve battery power and may enable diagnostic data retrieval to proceed even when the user device has limited battery charge available.

As further shown in FIG. 4, the method 400 proceeds from the step 404 to a step 406, where the device anomaly information is obtained from the non-volatile memory portion while the other non-volatile memory portion and most components of the user device remain unpowered. The obtainment at the step 406 may be performed by the pre-boot diagnostics component 120 described with reference to FIG. 1. The pre-boot diagnostics component 120 may access the non-volatile memory portion that was powered at the step 404 and may read the device anomaly information that is stored in the non-volatile memory portion.

With continued reference to FIG. 4, the device anomaly information obtained at the step 406 may indicate one or more device anomalies that were predicted and caused to be stored in the non-volatile memory portion while the user device was running in a post-boot environment in which an operating system of the user device executes. The prediction of the device anomalies and the storage of the device anomaly information may have been performed via the steps 302 through 306 of the method 300 described with reference to FIG. 3. Because the device anomaly information was predicted and stored during normal operation of the user device in the post-boot environment, the device anomaly information obtained at the step 406 may reflect anomalies that were detected in the context of actual device usage, which may provide diagnostic insights that would not be available from tests performed only during the diagnostic session.

The device anomaly information obtained at the step 406 may be transferred to the auxiliary device that was detected at the step 402. The auxiliary device may comprise an auxiliary memory, and the device anomaly information may be stored on the auxiliary memory for subsequent analysis, reporting, or transmission to remote diagnostic systems. Transfer of the device anomaly information to the auxiliary device may be performed through the physical connection or wireless communication link that was established when the auxiliary device was detected. The transfer may occur while the other non-volatile memory portion and most components of the user device remain unpowered, which may enable the diagnostic data retrieval to complete with minimal overall power consumption.

As further shown in FIG. 4, the method 400 proceeds from the step 406 to a step 408, where one or more automated tests are performed on the user device while obtaining the device anomaly information from the non-volatile memory portion. The automated tests at the step 408 may be performed by the pre-boot diagnostics component 120 described with reference to FIG. 1. The automated tests may exercise functionality of the user device to identify anomalies that may be difficult to determine through behavioral analysis alone, and the automated tests may be performed concurrently with or sequentially with the obtainment of the device anomaly information at the step 406.

With continued reference to FIG. 4, computer program instructions for the automated tests performed at the step 408 may be stored on the auxiliary device. Upon establishing a connection with the auxiliary device, the automated test instructions may be obtained at the user device from the auxiliary device and executed at the user device to perform the automated tests on the user device while obtaining the device anomaly information from the non-volatile memory portion. Storage of the automated test instructions on the auxiliary device may enable technicians or diagnostic systems to customize the automated tests that are performed during diagnostic sessions without requiring modification of software stored on the user device. The auxiliary device may store different sets of automated test instructions for different diagnostic scenarios, and the appropriate set of automated test instructions may be transferred to the user device based on the particular diagnostic objectives of the session.

In some cases, computer program instructions for the automated tests performed at the step 408 may be stored on the user device. The automated test instructions may be stored in the non-volatile memory portion where device anomaly information is stored, or the automated test instructions may be stored in another non-volatile memory portion of the user device. The automated test instructions may be stored on the user device prior to the obtainment of the device anomaly information from the non-volatile memory portion and prior to an establishment of a connection with the auxiliary device. When the automated test instructions are stored on the user device, the user device may execute the stored automated test instructions to perform the automated tests without requiring transfer of test instructions from the auxiliary device.

The automated tests performed at the step 408 may exercise certain functionality to identify anomalies that may be difficult to determine behaviorally. In some cases, the automated tests may cycle a display of the user device through test patterns that enable detection of display anomalies such as dead pixels. The auxiliary device may include sensors or imaging components that observe the display of the user device during the test pattern display and that detect pixels exhibiting anomalous behavior. In some cases, the automated tests may test input subsystems such as touchscreen subsystems or button subsystems by applying test stimuli and measuring responses. In some cases, the automated tests may test communication subsystems by attempting to establish connections or by measuring signal characteristics. Results of the automated tests performed at the step 408 may be stored on the auxiliary device alongside the device anomaly information obtained at the step 406, which may provide a comprehensive diagnostic assessment that combines behavioral analysis results from normal device operation with test results from the diagnostic session.

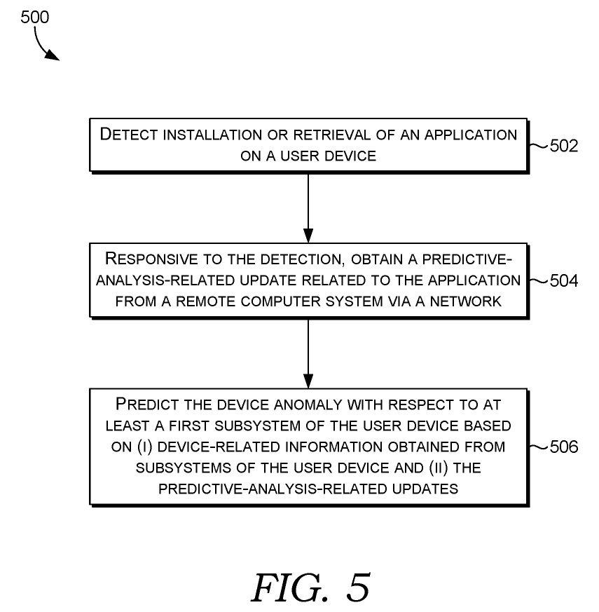

Referring to FIG. 5, a method 500 of facilitating diagnostics related to a user device via predictive-analysis-related updates is illustrated in accordance with one or more embodiments. The method 500 may be implemented by a processor executing computer program instructions, and the method 500 may be performed by components of a user device such as the user device 104a described with reference to FIG. 1. The method 500 includes a sequence of steps that enable the predictive analysis capabilities of a user device to be updated in response to installation or retrieval of applications, which may improve the accuracy of anomaly predictions for subsystems that interact with the installed or retrieved applications.

The method 500 begins with a step 502, where installation or retrieval of an application for installation on the user device is detected. The detection at the step 502 may be performed by the predictive analysis component 116 described with reference to FIG. 1. The predictive analysis component 116 may monitor for events that indicate an application is being installed on the user device or that an application is being retrieved for installation on the user device. Installation events may include completion of an application installation process, registration of a new application with an operating system of the user device, or other events that indicate an application has been installed. Retrieval events may include initiation of an application download from an application store, receipt of an application package from a remote source, or other events that indicate an application is being obtained for installation.

With continued reference to FIG. 5, the application detected at the step 502 may be any type of application that is installed on or retrieved for installation on the user device. In some cases, the application may be a camera application that interacts with a camera subsystem of the user device. In some cases, the application may be a communication application that interacts with communication subsystems such as cellular, Wi-Fi, or Bluetooth subsystems of the user device. In some cases, the application may be a gaming application that interacts with display subsystems, audio subsystems, and input subsystems of the user device. In some cases, the application may be a productivity application that interacts with user interface subsystems and storage subsystems of the user device. Different types of applications may interact with different subsystems of the user device in different ways, and the predictive analysis capabilities of the user device may benefit from updates that are tailored to the specific applications that are installed on the user device.

As further shown in FIG. 5, the method 500 proceeds from the step 502 to a step 504, where a predictive-analysis-related update related to the application is obtained from a remote computer system via a network responsive to the installation-related detection. The obtainment at the step 504 may be performed by the predictive analysis component 116 described with reference to FIG. 1. Responsive to the detection of the application installation or retrieval at the step 502, the predictive analysis component 116 may communicate with a remote computer system such as the server 102 described with reference to FIG. 1 via the network 150 to obtain a predictive-analysis-related update that is related to the detected application.

With continued reference to FIG. 5, the predictive-analysis-related update obtained at the step 504 may comprise various types of information that enable the predictive analysis component 116 to more accurately predict device anomalies related to subsystems with which the detected application interacts. In some cases, the predictive-analysis-related update may comprise behavioral or predictive specification files that define expected behavioral patterns for subsystems when the detected application is in use. In some cases, the predictive-analysis-related update may comprise supplemental behavioral or predictive specification files that augment existing specification files with additional rules or parameters specific to the detected application. In some cases, the predictive-analysis-related update may comprise threshold values or parameters that are used by anomaly detection algorithms when analyzing subsystem behavior during operation of the detected application. In some cases, the predictive-analysis-related update may comprise machine learning model updates that improve the accuracy of anomaly predictions for subsystems that interact with the detected application.

The remote computer system from which the predictive-analysis-related update is obtained at the step 504 may be the server 102 described with reference to FIG. 1. The server 102 may include the server predictive analysis component 112, which may manage predictive-analysis-related updates for various applications. The server predictive analysis component 112 may maintain a repository of predictive-analysis-related updates that are associated with different applications, and the server predictive analysis component 112 may provide the appropriate predictive-analysis-related update to the user device responsive to a request from the predictive analysis component 116 of the user device. In some cases, the server predictive analysis component 112 may detect the installation or download of the application on the user device and may cause the predictive-analysis-related update related to the installed or downloaded application to be pushed to the user device without requiring a request from the user device.

The predictive-analysis-related update obtained at the step 504 may be stored at the user device for use by the predictive analysis component 116 in subsequent anomaly prediction operations. The predictive-analysis-related update may be stored in a non-volatile memory portion of the user device, which may enable the update to persist across device restarts and to remain available for use by the predictive analysis component 116 during normal device operation in the post-boot environment.

As further shown in FIG. 5, the method 500 proceeds from the step 504 to a step 506, where a device anomaly is predicted with respect to at least a first subsystem of the user device based on device-related information obtained from one or more subsystems of the user device and the predictive-analysis-related updates. The prediction at the step 506 may be performed by the predictive analysis component 116 described with reference to FIG. 1. The predictive analysis component 116 may obtain device-related information from subsystems of the user device while the user device is running in a post-boot environment in which an operating system of the user device executes. The predictive analysis component 116 may analyze the obtained device-related information using the predictive-analysis-related updates obtained at the step 504 to predict device anomalies with respect to subsystems of the user device.

With continued reference to FIG. 5, the device anomaly predicted at the step 506 may be predicted based on the device-related information and the predictive-analysis-related updates while the user device is running in the post-boot environment. The predictive-analysis-related updates may enable the predictive analysis component 116 to more accurately predict device anomalies related to subsystems with which the detected application interacts. In some cases, where the detected application is a camera application, the predictive-analysis-related updates may enable the predictive analysis component 116 to more accurately predict device anomalies related to a camera subsystem, a user interface subsystem, or other subsystems of the user device with which the camera application interacts. The predictive-analysis-related updates may provide application-specific behavioral patterns, threshold values, or other parameters that enable the predictive analysis component 116 to distinguish between normal subsystem behavior during operation of the detected application and anomalous subsystem behavior that may indicate a device issue.

The device anomaly predicted at the step 506 may be stored as device anomaly information in a portion of non-volatile memory of the user device, as described with reference to the step 306 of the method 300 shown in FIG. 3. The stored device anomaly information may subsequently be obtained from the non-volatile memory portion during a pre-boot diagnostic session, as described with reference to the step 308 of the method 300 shown in FIG. 3 or the step 406 of the method 400 shown in FIG. 4. By obtaining predictive-analysis-related updates in response to application installation or retrieval and using the updates to predict device anomalies, the method 500 may enable the diagnostic system to adapt to changes in the applications installed on the user device and to provide more accurate anomaly predictions that account for the specific subsystem interactions associated with the installed applications.

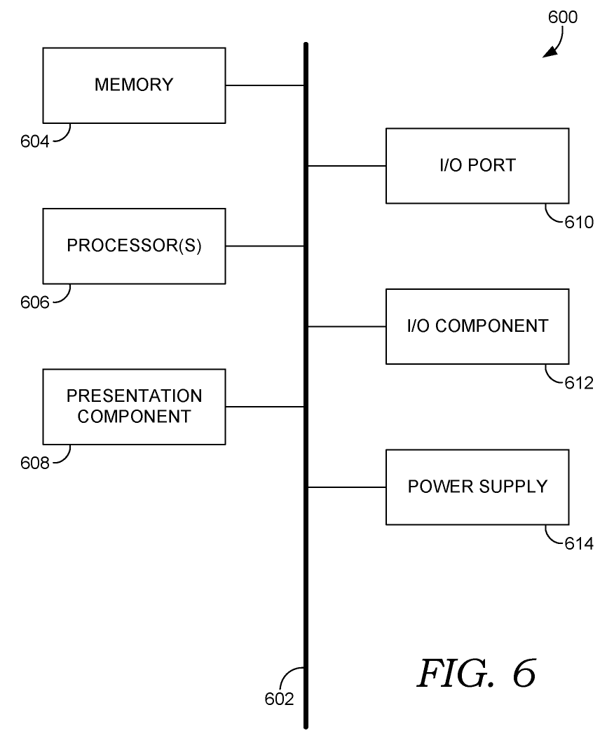

With reference to FIG. 6, computing device 600 includes bus 602, which directly or indirectly couples the following devices: memory 604, one or more processors 606, one or more presentation components 608, input/output (I/O) ports 610, input/output components 612, and illustrative power supply 614. Bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 6 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM (random access memory), ROM (read-only memory), EEPROM (electronically erasable programmable read-only memory), flash memory, or other memory technology; CD (compact disc)-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 600. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 604 includes computer storage media in the form of volatile or non-volatile memory. The memory may be removable, non-removable, or a combination thereof. Example hardware devices include solid-state memory, hard drives, optical-disc drives, etc. Computing device 600 includes one or more processors that read data from various entities, such as memory 604 or I/O components 612. Presentation component(s) 608 presents data indications to a user or other device. Example presentation components include a display device, speaker, printing component, vibrating component, etc.

I/O ports 610 allow computing device 600 to be logically coupled to other devices, including I/O components 612, some of which may be built-in. Illustrative components include a microphone, joystick, game pad, satellite dish, scanner, printer, wireless device, etc. The I/O components 612 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 600. Computing device 600 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 600 may be equipped with accelerometers or gyroscopes that enable detection of motion. The output of the accelerometers or gyroscopes may be provided to the display of computing device 600 to render immersive augmented reality or virtual reality. Power supply 614 may supply power to computing device 600 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

The diagnostic system described herein operates through coordinated interactions between multiple components that enable behavioral analysis during normal device operation, preservation of diagnostic information through factory reset events, and retrieval of diagnostic information during pre-boot diagnostic sessions while maintaining user privacy through encryption mechanisms.

During normal operation of a user device in a post-boot environment, a predictive analysis component of the user device continuously monitors device-related information from various subsystems of the user device. The predictive analysis component may obtain outputs from subsystems that provide input to, process outputs from, or respond to other subsystems of the user device. The predictive analysis component may analyze the obtained device-related information to identify behavioral patterns, to detect deviations from expected behavior, and to predict device anomalies based on the analysis. The predictive analysis component may employ various algorithmic approaches for anomaly prediction, including rule-based systems, statistical methods, machine learning classifiers, time-series analysis techniques, or ensemble methods that combine multiple approaches. The predictive analysis component may compare current subsystem behavior against historical baselines, may detect inconsistencies between outputs of different subsystems, and may identify changes in action or inaction patterns that may indicate emerging anomalies.

When the predictive analysis component predicts a device anomaly, a diagnostics storage component of the user device may cause the predicted anomaly to be stored as device anomaly information in a protected portion of non-volatile memory of the user device. The protected non-volatile memory portion may be configured such that information stored in the protected portion is preserved during a factory reset of the user device. The protected non-volatile memory portion may be subject to access restrictions that prevent unauthorized read or write access while the user device is operating in the post-boot environment. The diagnostics storage component may store device anomaly information that includes anomaly identifiers, timestamps, affected subsystem identifiers, severity levels, confidence scores, raw sensor readings, and references to related anomalies. The diagnostics storage component may compress the device anomaly information using lossless or lossy compression algorithms to maximize the amount of diagnostic information that can be retained within the available storage space of the protected non-volatile memory portion.

The diagnostics storage component may encrypt the device anomaly information before storing the device anomaly information in the protected non-volatile memory portion. Encryption of the device anomaly information may protect user privacy by ensuring that the device anomaly information is not accessible to unauthorized parties. The diagnostics storage component may generate an on-device public/private keypair that is used to encrypt the device anomaly information. A public key of the on-device keypair may be transmitted to a remote server via a network, while a private key of the on-device keypair may be stored in a secure memory location on the user device. Upon factory reset of the user device, the private key may be deleted from the user device, which may ensure that device anomaly information that was encrypted prior to the factory reset cannot be decrypted locally by a subsequent user of the user device. The remote server may retain the public key, which may enable the remote server to decrypt and analyze device anomaly information that was encrypted prior to the factory reset.

In some cases, the diagnostics storage component may employ a dual-key encryption model that provides different levels of access to device anomaly information. Under the dual-key encryption model, a first encryption mechanism may use a cloud-based public key that allows only the remote server to decrypt device anomaly information. The cloud-based public key may be associated with a corresponding private key that is stored securely on the remote server and that is not stored on the user device. Device anomaly information encrypted using the cloud-based public key may be decryptable only by the remote server, which may enable the remote server to decrypt and analyze device anomaly information dating back to when the user device was first manufactured, regardless of factory resets or user changes that have occurred on the user device. A second encryption mechanism may use an on-device public/private keypair that is regenerated on every factory reset or user change. Device anomaly information encrypted with the on-device keypair may be accessible to a current user of the user device, while device anomaly information encrypted with previous on-device keypairs may not be accessible to the current user because the private keys associated with the previous keypairs may have been deleted upon factory reset or user change.

The remote server may coordinate with user devices to manage predictive-analysis-related updates that improve the accuracy of anomaly predictions performed by predictive analysis components on the user devices. A server predictive analysis component of the remote server may maintain a repository of predictive-analysis-related updates that include behavioral or predictive specification files, threshold values, machine learning model updates, or other information that enables predictive analysis components on user devices to more accurately predict device anomalies. The server predictive analysis component may push predictive-analysis-related updates to user devices via a network, or the server predictive analysis component may provide predictive-analysis-related updates in response to requests from user devices. In some cases, the server predictive analysis component may detect installation or download of applications on user devices and may cause predictive-analysis-related updates related to the installed or downloaded applications to be pushed to the respective user devices. The predictive-analysis-related updates may enable predictive analysis components on user devices to adapt to changes in installed applications and to provide more accurate anomaly predictions that account for subsystem interactions associated with the installed applications.

The remote server may also coordinate with user devices to manage encryption keys and to provide decryption services for encrypted device anomaly information. A server encryption component of the remote server may securely store public keys that are associated with individual user devices. The server encryption component may receive public keys from user devices when the user devices generate on-device keypairs, and the server encryption component may store the received public keys in association with identifiers of the respective user devices. When encrypted device anomaly information is transmitted to the remote server, the server encryption component may retrieve the appropriate public key associated with the user device from which the encrypted device anomaly information was obtained, and the server encryption component may use the retrieved public key to decrypt the device anomaly information. The decrypted device anomaly information may be stored in a diagnostics database of the remote server for analysis, reporting, or other diagnostic purposes.

When a user device enters a pre-boot environment for diagnostic operations, a pre-boot diagnostics component of the user device may retrieve device anomaly information from the protected non-volatile memory portion. The pre-boot environment may be an early execution phase before an operating system of the user device starts, such as within a bootloader, recovery mode, or a pre-boot diagnostic tool. The pre-boot diagnostics component may include a pre-boot diagnostic application that executes in the pre-boot environment and that is capable of accessing the protected non-volatile memory portion where device anomaly information is stored. The pre-boot diagnostic application may retrieve the device anomaly information from the protected non-volatile memory portion and may make the device anomaly information available for diagnostic analysis or for transfer to an auxiliary device.

A power management component of the user device may coordinate with the pre-boot diagnostics component to selectively power components of the user device during pre-boot diagnostic operations. The power management component may provide power to the protected non-volatile memory portion while keeping other portions of non-volatile memory and most components of the user device unpowered. Selective powering of the protected non-volatile memory portion may enable retrieval of device anomaly information while minimizing overall power consumption during the diagnostic session. The power management component may power additional components of the user device as needed for specific diagnostic operations, such as powering communication interfaces for transferring device anomaly information to an auxiliary device or powering display subsystems for performing automated display tests.

An auxiliary device may interact with the user device during pre-boot diagnostic operations to retrieve device anomaly information and to facilitate diagnostic analysis. The auxiliary device may be connected to the user device through a physical connection such as a USB connection, or the auxiliary device may communicate with the user device through a wireless connection such as a Bluetooth connection. When the auxiliary device is connected to or detected by the user device, the pre-boot diagnostics component may initiate retrieval of device anomaly information from the protected non-volatile memory portion and may transfer the retrieved device anomaly information to the auxiliary device. The auxiliary device may comprise an auxiliary memory that stores the device anomaly information received from the user device.

In some cases, the auxiliary device may store computer program instructions for automated tests that are executed on the user device during the pre-boot diagnostic session. When the auxiliary device is connected to the user device, the automated test instructions may be transferred from the auxiliary device to the user device, and the user device may execute the automated test instructions to perform automated tests on subsystems of the user device. The automated tests may exercise functionality of the user device to identify anomalies that may be difficult to determine through behavioral analysis alone, such as display anomalies that are detected by cycling a display through test patterns. Results of the automated tests may be stored on the auxiliary device alongside the device anomaly information retrieved from the protected non-volatile memory portion of the user device.

In some cases, the auxiliary device may transmit encrypted device anomaly information to the remote server for decryption and analysis. When device anomaly information stored on the user device is encrypted, the auxiliary device may retrieve the encrypted device anomaly information from the user device and may transmit the encrypted device anomaly information to the remote server via a network connection. The remote server may decrypt the device anomaly information using encryption keys that are stored on the remote server, and the remote server may analyze the decrypted device anomaly information to identify anomaly patterns, to generate diagnostic reports, or to provide diagnostic insights to technicians or service personnel. The auxiliary device may act as a relay between the user device and the remote server, enabling retrieval of encrypted device anomaly information from user devices that do not have direct network connectivity to the remote server.

The coordination between the user device, the auxiliary device, and the remote server enables diagnostic information to persist through factory reset events while protecting user privacy. Device anomaly information that is predicted and stored during normal operation of the user device in the post-boot environment remains available in the protected non-volatile memory portion even after a factory reset is performed on the user device. The device anomaly information may be retrieved during a subsequent pre-boot diagnostic session, which may enable technicians or automated diagnostic systems to access diagnostic insights that were captured during normal device operation prior to the factory reset. Encryption of the device anomaly information ensures that the diagnostic information is not accessible to unauthorized parties, and the deletion of private keys upon factory reset ensures that device anomaly information from previous users is not accessible to subsequent users of the user device. The remote server may retain access to encrypted device anomaly information through cloud-based encryption keys, which may enable long-term diagnostic analysis while maintaining privacy protections for individual users.

The diagnostic system may also coordinate across multiple user devices to enable fleet-wide diagnostic analysis and collective learning. A central management server may aggregate device anomaly information from multiple user devices and may analyze the aggregated information to identify common failure patterns, firmware issues, or environmental factors that affect device reliability across a population of devices. The central management server may implement comparative analysis that identifies user devices exhibiting anomalous behavior relative to peer devices with similar configurations or usage patterns. Fleet-wide predictive models may be trained on aggregated data from multiple user devices and may be deployed to individual user devices to improve local anomaly detection accuracy. Privacy-preserving techniques such as federated learning or differential privacy may be employed to enable collective learning while protecting the privacy of diagnostic data from individual user devices.

The following examples pertain to further embodiments.

Clause 1: A user device, comprising: a processor configured to execute instructions that cause the user device to: obtain device-related information from a subsystem of the user device while the user device is operating in a post-boot environment; predict, based on the device-related information from the subsystem of the user device, an anomaly with respect to a first subsystem of the user device while the user device is operating in the post-boot environment; store the predicted anomaly as device anomaly information in a portion of non-volatile memory of the user device, the non-volatile memory portion being accessible in a pre-boot environment in which a pre-boot diagnostic application executes; and obtain, via the pre-boot diagnostic application, the device anomaly information from the non-volatile memory portion while the user device is running in the pre-boot environment.

Clause 2: Clause 1, wherein the subsystem provides input to, processes outputs from, or responds to the first subsystem.

Clause 3: Any of Clauses 1-2, wherein the processor is further configured to execute instructions that cause the user device to process an output of the first subsystem, the output provided as an input to the subsystem, and wherein the device-related information is obtained based on the processing of the input received from the first subsystem at the subsystem.

Clause 4: Clause 3, wherein the processor is further configured to execute instructions that cause the user device to detect, based on the processed output, an artifact in the input to the subsystem, wherein the device-related information is obtained based on the detection of the artifact.

Clause 5: Any of Clauses 1-4, wherein the device-related information comprises an output from the subsystem, and wherein the processor is further configured to execute instructions that cause the user device to determine an inconsistency between the output of the subsystem and an action or an inaction of the first subsystem, wherein the anomaly with respect to the first subsystem is predicted based on the determined inconsistency while the user device is running in the post-boot environment.

Clause 6: Any of Clauses 1-5, wherein the processor is further configured to execute instructions that cause the user device to determine a difference between a first action pattern or a first inaction pattern and a second action pattern or a second inaction pattern related to the first subsystem, wherein the first action pattern or the first inaction pattern reflects most recent actions or most recent inactions related to the first subsystem, and the second action pattern or the second inaction pattern reflects prior actions or prior inactions related to the first subsystem, wherein the anomaly with respect to the first subsystem is predicted based on the device-related information and the determined difference while the user device is running in the post-boot environment.

Clause 7: Clause 6, wherein the device-related information comprises an output from the subsystem that indicates a potential cause of the determined difference, wherein the anomaly with respect to the first subsystem is predicted based on the potential cause and the determined difference while the user device is running in the post-boot environment.

Clause 8: Any of Clauses 1-7, wherein the processor is further configured to execute instructions that cause the user device to perform an automated test on the user device while obtaining the device anomaly information from the non-volatile memory portion in the pre-boot environment.

Clause 9: Any of Clauses 1-8, wherein the processor is further configured to execute instructions that cause the user device to provide, via a power management subsystem, power to the non-volatile memory portion while a second non-volatile memory portion and most components of the user device remain unpowered, enabling retrieval of the device anomaly information from the non-volatile memory portion.

Clause 10: Clause 9, wherein the processor is further configured to execute instructions that cause the user device to detect an auxiliary device while the non-volatile memory portion and most components of the user device remain unpowered, wherein, upon detecting the auxiliary device, power is provided to the non-volatile memory portion while the second non-volatile memory portion and most components of the user device remain unpowered, enabling retrieval of the device anomaly information.

Clause 11: Clause 10, wherein the auxiliary device comprises an auxiliary memory, and wherein the processor is further configured to execute instructions that cause the user device to store, via the pre-boot diagnostic application, the device anomaly information on the auxiliary memory while running in the pre-boot environment.

Clause 12: A method of facilitating diagnostics related to a user device, the method being implemented by a processor executing computer program instructions, the method comprising: obtaining device-related information from a subsystem of the user device while the user device is operating in a post-boot environment; predicting, based on the device-related information, an anomaly with respect to a first subsystem of the user device while the user device is running in the post-boot environment; storing the predicted anomaly as device anomaly information in a portion of non-volatile memory accessible in a pre-boot environment in which a pre-boot diagnostic application executes; and obtaining, via the pre-boot diagnostic application, the device anomaly information from the non-volatile memory while the user device is running in the pre-boot environment.

Clause 13: Clause 12, wherein the subsystem provides input to, processes outputs from, or responds to the first subsystem.

Clause 14: Any of Clauses 12-13, further comprising processing an output of the first subsystem that is provided as an input to the subsystem, wherein the device-related information is obtained based on the processing of the output received from the first subsystem at the subsystem.

Clause 15: Any of Clauses 12-14, wherein the device-related information comprises an output from the subsystem, the method further comprising determining an inconsistency between the output of the subsystem and an action or an inaction of the first subsystem, wherein the anomaly with respect to the first subsystem is predicted based on the determined inconsistency while the user device is running in the post-boot environment.

Clause 16: Any of Clauses 12-15, further comprising: detecting an auxiliary device while the non-volatile memory portion and most components of the user device remain unpowered; and providing, responsive to detecting the auxiliary device, power to the non-volatile memory portion while a second non-volatile memory portion and most components of the user device remain unpowered, enabling retrieval of the device anomaly information from the non-volatile memory portion.

Clause 17: Clause 16, wherein the auxiliary device comprises an auxiliary memory, the method further comprising storing, via the pre-boot diagnostic application, the device anomaly information on the auxiliary memory while the user device is running in the pre-boot environment.

Clause 18: A non-transitory computer-readable medium storing instructions that, when executed by a processor of a user device, cause the user device to: obtain device-related information from a subsystem of the user device while the user device is operating in a post-boot environment; predict, based on the device-related information, an anomaly with respect to a first subsystem of the user device while the user device is operating in the post-boot environment; store the predicted anomaly as device anomaly information in a portion of non-volatile memory of the user device, the non-volatile memory portion being preserved during a factory reset of the user device; and obtain the device anomaly information from the non-volatile memory portion via a pre-boot diagnostic application while the user device is running in a pre-boot environment.

Clause 19: Clause 18, wherein the instructions further cause the user device to encrypt the device anomaly information prior to storing the device anomaly information in the non-volatile memory portion, wherein the device anomaly information is encrypted using a public key of a public/private keypair generated on the user device.

Clause 20: Clause 19, wherein a private key of the public/private keypair is deleted from the user device upon the factory reset of the user device, and wherein the public key is transmitted to a remote server that retains access to decrypt the device anomaly information after the factory reset.

Clause 21: Any of Clauses 1-20, wherein the subsystem is a subsystem different from the first subsystem for which the anomaly is predicted.

Clause 22: Any of Clauses 1-21, wherein the subsystem comprises the first subsystem for which the anomaly is predicted.

Clause 23: Any of Clauses 1-22, wherein the processor is further configured to execute instructions that cause the user device to reduce overall power consumption via a power management subsystem while the user device is running in the pre-boot environment such that most components of the user device are unpowered.

Clause 24: Any of Clauses 1-23, wherein the processor is further configured to execute instructions that cause the user device to detect installation or retrieval of an application for installation on the user device, obtain, in response, a predictive-analysis-related update related to the application from a remote computer system via a network, and predict the anomaly based on the device-related information and the predictive-analysis-related update while running in the post-boot environment.

Clause 25: Any of Clauses 1-24, wherein the non-volatile memory portion is implemented using embedded Multi-Media Controller (eMMC) flash memory technology.

Clause 26: Any of Clauses 1-24, wherein the non-volatile memory portion is implemented using Universal Flash Storage (UFS) technology.

Clause 27: Any of Clauses 1-24, wherein the non-volatile memory portion is implemented using NOR flash memory technology.

Clause 28: Any of Clauses 1-24, wherein the non-volatile memory portion is implemented using NAND flash memory technology.

Clause 29: Any of Clauses 1-24, wherein the non-volatile memory portion is implemented using Magnetoresistive Random Access Memory (MRAM) technology.

Clause 30: Any of Clauses 1-24, wherein the non-volatile memory portion is implemented using Ferroelectric RAM (FeRAM) technology.

Clause 31: Any of Clauses 1-24, wherein the non-volatile memory portion is implemented using Resistive RAM (ReRAM) technology.

Clause 32: Any of Clauses 1-31, wherein the non-volatile memory portion is configured as a dedicated hardware partition that is physically isolated from main storage of the user device.

Clause 33: Any of Clauses 1-31, wherein the non-volatile memory portion is configured as a logically partitioned region within the same storage medium with hardware-enforced access controls.

Clause 34: Any of Clauses 1-31, wherein the non-volatile memory portion is implemented as a separate discrete memory chip on a printed circuit board of the user device.

Clause 35: Any of Clauses 1-34, wherein the processor is further configured to execute instructions that cause the user device to predict the anomaly using rule-based systems that compare subsystem outputs against predefined threshold values.

Clause 36: Any of Clauses 1-34, wherein the processor is further configured to execute instructions that cause the user device to predict the anomaly using statistical methods including moving averages, standard deviation analysis, or regression models to identify deviations from baseline behavior.

Clause 37: Any of Clauses 1-34, wherein the processor is further configured to execute instructions that cause the user device to predict the anomaly using machine learning classifiers including decision trees, random forests, support vector machines, or neural networks trained on known anomaly patterns.

Clause 38: Any of Clauses 1-34, wherein the processor is further configured to execute instructions that cause the user device to predict the anomaly using time-series analysis techniques including autoregressive integrated moving average (ARIMA) models or exponential smoothing for detecting temporal anomalies.

Clause 39: Any of Clauses 1-34, wherein the processor is further configured to execute instructions that cause the user device to predict the anomaly using unsupervised clustering algorithms that group behavioral patterns and flag outliers.

Clause 40: Any of Clauses 1-34, wherein the processor is further configured to execute instructions that cause the user device to predict the anomaly using ensemble methods that combine multiple algorithmic approaches to improve prediction accuracy and reduce false positives.

Clause 41: Any of Clauses 1-40, wherein the processor is further configured to execute instructions that cause the user device to implement hierarchical monitoring where primary subsystems are continuously monitored while secondary subsystems are monitored only when triggered by specific events.

Clause 42: Any of Clauses 1-40, wherein the processor is further configured to execute instructions that cause the user device to employ adaptive monitoring that adjusts the frequency and depth of subsystem analysis based on device usage patterns, battery level, or processor load.

Clause 43: Any of Clauses 1-42, wherein the first subsystem comprises an input subsystem including a touchscreen, buttons, or microphone.

Clause 44: Any of Clauses 1-42, wherein the first subsystem comprises an output subsystem including a display, speakers, or haptic feedback.

Clause 45: Any of Clauses 1-42, wherein the first subsystem comprises a communication subsystem including cellular, Wi-Fi, Bluetooth, NFC, or GPS.

Clause 46: Any of Clauses 1-42, wherein the first subsystem comprises a sensor subsystem including an accelerometer, gyroscope, magnetometer, barometer, proximity sensor, or ambient light sensor.

Clause 47: Any of Clauses 1-42, wherein the first subsystem comprises a power subsystem including battery management, charging circuitry, or power distribution.

Clause 48: Any of Clauses 1-47, wherein the processor is further configured to execute instructions that cause the user device to compare the first action pattern or the first inaction pattern and the second action pattern or the second inaction pattern using direct numerical comparison of pattern metrics including frequency, duration, or intensity.

Clause 49: Any of Clauses 1-47, wherein the processor is further configured to execute instructions that cause the user device to compare the first action pattern or the first inaction pattern and the second action pattern or the second inaction pattern using statistical hypothesis testing to determine if observed differences are significant.

Clause 50: Any of Clauses 1-47, wherein the processor is further configured to execute instructions that cause the user device to compare the first action pattern or the first inaction pattern and the second action pattern or the second inaction pattern using dynamic time warping for comparing patterns that may be temporally shifted or scaled.

Clause 51: Any of Clauses 1-47, wherein the processor is further configured to execute instructions that cause the user device to compare the first action pattern or the first inaction pattern and the second action pattern or the second inaction pattern using correlation analysis to identify relationships between patterns across different subsystems.

Clause 52: Any of Clauses 1-47, wherein the processor is further configured to execute instructions that cause the user device to compare the first action pattern or the first inaction pattern and the second action pattern or the second inaction pattern using trend analysis to detect gradual changes over extended time periods.

Clause 53: Any of Clauses 1-52, wherein the processor is further configured to execute instructions that cause the user device to maintain multiple historical baselines representing different usage contexts and select an appropriate baseline for comparison based on current context.

Clause 54: Any of Clauses 1-53, wherein the processor is further configured to execute instructions that cause the user device to incorporate environmental context data including ambient temperature measured by device sensors into the behavioral analysis.

Clause 55: Any of Clauses 1-53, wherein the processor is further configured to execute instructions that cause the user device to incorporate environmental context data including atmospheric pressure into the behavioral analysis.

Clause 56: Any of Clauses 1-53, wherein the processor is further configured to execute instructions that cause the user device to incorporate environmental context data including humidity levels inferred from sensor behavior into the behavioral analysis.

Clause 57: Any of Clauses 1-53, wherein the processor is further configured to execute instructions that cause the user device to incorporate environmental context data including geographic location into the behavioral analysis.

Clause 58: Any of Clauses 1-53, wherein the processor is further configured to execute instructions that cause the user device to incorporate environmental context data including altitude into the behavioral analysis.

Clause 59: Any of Clauses 1-53, wherein the processor is further configured to execute instructions that cause the user device to incorporate environmental context data including network connectivity conditions into the behavioral analysis.

Clause 60: Any of Clauses 1-53, wherein the processor is further configured to execute instructions that cause the user device to incorporate environmental context data including time of day into the behavioral analysis.

Clause 61: Any of Clauses 1-60, wherein the processor is further configured to execute instructions that cause the user device to correlate anomalies with environmental conditions to identify environment-specific issues.

Clause 62: Any of Clauses 1-61, wherein the processor is further configured to execute instructions that cause the user device to store historical environmental data alongside anomaly information to provide context for diagnostic analysis.

Clause 63: Any of Clauses 1-62, wherein the processor is further configured to execute instructions that cause the user device to adjust anomaly detection thresholds based on current environmental conditions to reduce false positives.

Clause 64: Any of Clauses 1-63, wherein the processor is further configured to execute instructions that cause the user device to encrypt the device anomaly information using symmetric encryption with Advanced Encryption Standard (AES) with 128-bit, 192-bit, or 256-bit key lengths.

Clause 65: Any of Clauses 1-63, wherein the processor is further configured to execute instructions that cause the user device to encrypt the device anomaly information using elliptic curve cryptography (ECC) for more efficient key generation and storage.

Clause 66: Any of Clauses 1-63, wherein the processor is further configured to execute instructions that cause the user device to encrypt the device anomaly information using hybrid encryption schemes that combine symmetric and asymmetric encryption for improved performance.

Clause 67: Any of Clauses 1-63, wherein the processor is further configured to execute instructions that cause the user device to encrypt the device anomaly information using homomorphic encryption that allows certain computations to be performed on encrypted data without decryption.

Clause 68: Any of Clauses 1-67, wherein key derivation utilizes hardware-based secure elements for encryption key management.

Clause 69: Any of Clauses 1-67, wherein key derivation utilizes Trusted Platform Modules (TPM) for encryption key management.

Clause 70: Any of Clauses 1-67, wherein key derivation utilizes ARM TrustZone technology for encryption key management.

Clause 71: Any of Clauses 1-70, wherein the processor is further configured to execute instructions that cause the user device to implement key rotation policies where encryption keys are periodically regenerated.

Clause 72: Any of Clauses 1-71, wherein the processor is further configured to execute instructions that cause the user device to implement hierarchical key structures where master keys protect session-specific encryption keys.

Clause 73: Any of Clauses 1-72, wherein the processor is further configured to execute instructions that cause the user device to generate an on-device public/private keypair after each factory reset of the user device.

Clause 74: Any of Clauses 1-72, wherein the processor is further configured to execute instructions that cause the user device to generate an on-device public/private keypair separately for each user on the user device.

Clause 75: Any of Clauses 73-74, wherein upon factory reset or user change, a private key of the on-device public/private keypair is deleted from the user device.

Clause 76: Any of Clauses 73-75, wherein a public key of the on-device public/private keypair is also deleted from the user device upon reset.

Clause 77: Any of Clauses 1-76, wherein the processor is further configured to execute instructions that cause the user device to employ a dual-key encryption model where a first encryption mechanism uses a cloud-based public key that allows only a remote computer system to decrypt behavioral data, and a second encryption mechanism uses an on-device public/private keypair that is regenerated on every factory reset or user change.

Clause 78: Any of Clauses 1-77, wherein the device anomaly information is structured using binary-encoded records with fixed-length fields for efficient storage and retrieval.

Clause 79: Any of Clauses 1-77, wherein the device anomaly information is structured using variable-length records with type-length-value (TLV) encoding for flexibility.

Clause 80: Any of Clauses 1-77, wherein the device anomaly information is structured using JSON format for interoperability.

Clause 81: Any of Clauses 1-77, wherein the device anomaly information is structured using Protocol Buffers format for interoperability.

Clause 82: Any of Clauses 1-77, wherein the device anomaly information is structured using MessagePack format for interoperability.

Clause 83: Any of Clauses 1-82, wherein the device anomaly information is stored using circular buffer implementations that automatically overwrite oldest entries when storage is full.

Clause 84: Any of Clauses 1-82, wherein the device anomaly information is stored using indexed database structures that enable efficient querying of specific anomaly types.

Clause 85: Any of Clauses 1-84, wherein the stored device anomaly information includes anomaly identifiers that uniquely identify each anomaly record.

Clause 86: Any of Clauses 1-85, wherein the stored device anomaly information includes timestamps with millisecond or microsecond precision that indicate when anomalies were detected or predicted.

Clause 87: Any of Clauses 1-86, wherein the stored device anomaly information includes affected subsystem identifiers that indicate which subsystem or subsystems are associated with each anomaly.

Clause 88: Any of Clauses 1-87, wherein the stored device anomaly information includes severity levels that indicate the seriousness or urgency of each anomaly.

Clause 89: Any of Clauses 1-88, wherein the stored device anomaly information includes confidence scores that indicate the certainty or reliability of anomaly predictions.

Clause 90: Any of Clauses 1-89, wherein the stored device anomaly information includes raw sensor readings at the time of anomaly detection.

Clause 91: Any of Clauses 1-90, wherein the stored device anomaly information includes references to related anomalies.

Clause 92: Any of Clauses 1-91, wherein the processor is further configured to execute instructions that cause the user device to compress the device anomaly information using lossless compression algorithms including LZ4, Zstandard, or DEFLATE for preserving complete data fidelity.

Clause 93: Any of Clauses 1-91, wherein the processor is further configured to execute instructions that cause the user device to compress the device anomaly information using lossy compression for sensor data where some precision loss is acceptable.

Clause 94: Any of Clauses 1-91, wherein the processor is further configured to execute instructions that cause the user device to compress the device anomaly information using delta encoding that stores only changes from previous records.

Clause 95: Any of Clauses 1-91, wherein the processor is further configured to execute instructions that cause the user device to compress the device anomaly information using dictionary-based compression optimized for the specific vocabulary of anomaly descriptions.

Clause 96: Any of Clauses 1-91, wherein the processor is further configured to execute instructions that cause the user device to compress the device anomaly information using semantic compression that extracts and stores only the most diagnostically relevant features from raw data.

Clause 97: Any of Clauses 1-96, wherein the processor is further configured to execute instructions that cause the user device to implement adaptive compression that selects algorithms based on data characteristics and available storage space.

Clause 98: Any of Clauses 1-97, wherein the pre-boot diagnostic environment is implemented within a primary bootloader of the user device.

Clause 99: Any of Clauses 1-97, wherein the pre-boot diagnostic environment is implemented within a secondary bootloader of the user device.

Clause 100: Any of Clauses 1-97, wherein the pre-boot diagnostic environment is implemented within a dedicated diagnostic partition that loads before a main operating system of the user device.

Clause 101: Any of Clauses 1-97, wherein the pre-boot diagnostic environment is implemented within UEFI (Unified Extensible Firmware Interface) applications.

Clause 102: Any of Clauses 1-97, wherein the pre-boot diagnostic environment is implemented within a minimal recovery operating system.

Clause 103: Any of Clauses 1-102, wherein the pre-boot diagnostic environment is entered through specific hardware button combinations.

Clause 104: Any of Clauses 1-102, wherein the pre-boot diagnostic environment is entered through detection of the auxiliary device.

Clause 105: Any of Clauses 1-102, wherein the pre-boot diagnostic environment is entered through receipt of specific commands over a communication interface.

Clause 106: Any of Clauses 1-102, wherein the pre-boot diagnostic environment is entered through automatic entry upon detection of critical system failures.

Clause 107: Any of Clauses 1-106, wherein the processor is further configured to execute instructions that cause the user device to implement multiple power domains that can be independently controlled, allowing selective powering of specific subsystems required for particular diagnostic tests.

Clause 108: Any of Clauses 1-107, wherein power during pre-boot diagnostics is sourced from an internal battery of the user device.

Clause 109: Any of Clauses 1-107, wherein power during pre-boot diagnostics is sourced from the auxiliary device through USB Power Delivery.

Clause 110: Any of Clauses 1-107, wherein power during pre-boot diagnostics is sourced from an external power supply.

Clause 111: Any of Clauses 1-107, wherein power during pre-boot diagnostics is sourced from a combination of sources.

Clause 112: Any of Clauses 1-111, wherein the processor is further configured to execute instructions that cause the user device to implement power budgeting that limits the total power consumption during pre-boot operations to prevent battery drain or thermal issues.

Clause 113: Any of Clauses 1-112, wherein wake-on-connection functionality is implemented using dedicated low-power monitoring circuits that detect auxiliary device connection while a main processor of the user device remains in a deep sleep state.

Clause 114: Any of Clauses 1-113, wherein test suites are organized hierarchically with quick screening tests followed by detailed diagnostic tests only if anomalies are detected.

Clause 115: Any of Clauses 1-114, wherein tests are prioritized based on specific anomalies stored in the non-volatile memory portion, focusing diagnostic effort on suspected problem areas.

Clause 116: Any of Clauses 1-115, wherein the processor is further configured to execute instructions that cause the user device to support conditional test execution where certain tests are performed only if prerequisite conditions are met or if previous tests indicate potential issues.

Clause 117: Any of Clauses 1-116, wherein test parameters including duration, intensity, and pass/fail thresholds are configurable through the auxiliary device or through stored configuration data.

Clause 118: Any of Clauses 1-117, wherein test results are stored alongside anomaly data in the non-volatile memory portion for later analysis.

Clause 119: Any of Clauses 1-118, wherein the automated test cycles a screen of the user device through a number of patterns that enables the auxiliary device attached to the user device to detect the presence of dead pixels.

Clause 120: Any of Clauses 1-119, wherein the auxiliary device is implemented as a dedicated diagnostic tool.

Clause 121: Any of Clauses 1-119, wherein the auxiliary device is implemented as a general-purpose computer with diagnostic software.

Clause 122: Any of Clauses 1-119, wherein the auxiliary device is implemented as a specialized docking station.

Clause 123: Any of Clauses 1-119, wherein the auxiliary device is implemented as a handheld diagnostic scanner.

Clause 124: Any of Clauses 1-119, wherein the auxiliary device is implemented as a cloud-connected gateway device.

Clause 125: Any of Clauses 1-124, wherein the auxiliary device connects to the user device through a USB Type-A physical connection.

Clause 126: Any of Clauses 1-124, wherein the auxiliary device connects to the user device through a USB Type-C physical connection.

Clause 127: Any of Clauses 1-124, wherein the auxiliary device connects to the user device through a Lightning connector physical connection.

Clause 128: Any of Clauses 1-124, wherein the auxiliary device connects to the user device through proprietary diagnostic ports.

Clause 129: Any of Clauses 1-124, wherein the auxiliary device connects to the user device through JTAG/SWD debug interfaces.

Clause 130: Any of Clauses 1-124, wherein the auxiliary device connects to the user device through a Bluetooth Low Energy (BLE) wireless connection.

Clause 131: Any of Clauses 1-124, wherein the auxiliary device connects to the user device through a Bluetooth Classic wireless connection.

Clause 132: Any of Clauses 1-124, wherein the auxiliary device connects to the user device through a Wi-Fi Direct wireless connection.

Clause 133: Any of Clauses 1-124, wherein the auxiliary device connects to the user device through a Zigbee wireless connection.

Clause 134: Any of Clauses 1-124, wherein the auxiliary device connects to the user device through proprietary short-range radio protocols.

Clause 135: Any of Clauses 1-134, wherein connection establishment between the auxiliary device and the user device requires authentication through hardware tokens.

Clause 136: Any of Clauses 1-134, wherein connection establishment between the auxiliary device and the user device requires authentication through cryptographic challenges.

Clause 137: Any of Clauses 1-134, wherein connection establishment between the auxiliary device and the user device requires authentication through biometric verification.

Clause 138: Any of Clauses 1-137, wherein predictive-analysis-related updates are delivered through push notifications from a cloud server when updates are available.

Clause 139: Any of Clauses 1-137, wherein predictive-analysis-related updates are delivered through periodic polling by the user device to check for updates.

Clause 140: Any of Clauses 1-137, wherein predictive-analysis-related updates are delivered bundled with operating system updates.

Clause 141: Any of Clauses 1-137, wherein predictive-analysis-related updates are delivered through application store update mechanisms.

Clause 142: Any of Clauses 1-137, wherein predictive-analysis-related updates are delivered through peer-to-peer distribution among devices on the same local network.

Clause 143: Any of Clauses 1-137, wherein predictive-analysis-related updates are delivered via the auxiliary device during diagnostic sessions.

Clause 144: Any of Clauses 1-143, wherein updates are delivered as complete replacement files.

Clause 145: Any of Clauses 1-143, wherein updates are delivered as incremental patches.

Clause 146: Any of Clauses 1-143, wherein updates are delivered as differential updates that include only changed portions.

Clause 147: Any of Clauses 1-146, wherein the processor is further configured to execute instructions that cause the user device to implement staged rollouts where updates are delivered to a subset of devices initially before broader deployment.

Clause 148: Any of Clauses 1-147, wherein the processor is further configured to execute instructions that cause the user device to include rollback capabilities if updates cause issues.

Clause 149: Any of Clauses 1-148, wherein a central management server aggregates anomaly data from multiple user devices to identify common failure patterns, firmware issues, or environmental factors affecting device reliability.

Clause 150: Any of Clauses 1-149, wherein the system implements comparative analysis that flags devices exhibiting anomalous behavior relative to peer devices with similar configurations or similar usage patterns.

Clause 151: Any of Clauses 1-150, wherein fleet-wide predictive models are trained on aggregated data from multiple user devices and deployed to individual user devices to improve local anomaly detection accuracy.

Clause 152: Any of Clauses 1-151, wherein privacy-preserving techniques are employed to enable collective learning while protecting individual device data.

Clause 153: Clause 152, wherein federated learning is employed, wherein each user device trains a local version of a predictive model using locally stored data and transmits model updates to a central server without transmitting the underlying local data.

Clause 154: Clause 152 or 153, wherein differential privacy is employed by adding controlled amounts of noise to data or computations to provide mathematical guarantees that released information does not reveal sensitive information about individual user devices.

Clause 155: Any of Clauses 1-154, wherein notifications about detected anomalies are delivered through operating system notification frameworks.

Clause 156: Any of Clauses 1-154, wherein notifications about detected anomalies are delivered through dedicated diagnostic applications.

Clause 157: Any of Clauses 1-154, wherein notifications about detected anomalies are delivered through email alerts.

Clause 158: Any of Clauses 1-154, wherein notifications about detected anomalies are delivered through SMS messages.

Clause 159: Any of Clauses 1-154, wherein notifications about detected anomalies are delivered through integration with device manufacturer support portals.

Clause 160: Any of Clauses 1-159, wherein the system offers guided troubleshooting workflows that help users address detected issues.

Clause 161: Any of Clauses 1-160, wherein the system provides recommendations for preventive actions based on detected anomalies.

Clause 162: Any of Clauses 1-161, wherein the system provides direct links to schedule service appointments based on detected anomalies.

Clause 163: Any of Clauses 1-162, wherein user consent mechanisms are implemented to control what diagnostic data is collected, stored, and shared with service providers.

A number of implementations have been described. Nevertheless, it will be understood that various modifications may be made without departing from the spirit and scope of the disclosure. Accordingly, other implementations are within the scope of the following claims.

1. A user device, comprising:
a processor configured to execute instructions that cause the user device to:
obtain device-related information from a subsystem of the user device while the user device is operating in a post-boot environment;
predict, based on the device-related information from the subsystem of the user device, an anomaly with respect to a first subsystem of the user device while the user device is operating in the post-boot environment;
store the predicted anomaly as device anomaly information in a portion of non-volatile memory of the user device, the non-volatile memory portion being accessible in a pre-boot environment in which a pre-boot diagnostic application executes; and
obtain, via the pre-boot diagnostic application, the device anomaly information from the non-volatile memory portion while the user device is running in the pre-boot environment.

2. The user device of claim 1, wherein the subsystem provides input to, processes outputs from, or responds to the first subsystem.

3. The user device of claim 1, wherein the processor is further configured to execute instructions that cause the user device to process an output of the first subsystem, the output provided as an input to the subsystem, and wherein the device-related information is obtained based on the processing of the input received from the first subsystem at the subsystem.

4. The user device of claim 3, wherein the processor is further configured to execute instructions that cause the user device to detect, based on the processed output, an artifact in the input to the subsystem, wherein the device-related information is obtained based on the detection of the artifact.

5. The user device of claim 1, wherein the device-related information comprises an output from the subsystem, and wherein the processor is further configured to execute instructions that cause the user device to determine an inconsistency between the output of the subsystem and an action or an inaction of the first subsystem, wherein the anomaly with respect to the first subsystem is predicted based on the determined inconsistency while the user device is running in the post-boot environment.

6. The user device of claim 1, wherein the processor is further configured to execute instructions that cause the user device to determine a difference between a first action pattern or a first inaction pattern and a second action pattern or a second inaction pattern related to the first subsystem, wherein the first action pattern or the first inaction pattern reflects most recent actions or most recent inactions related to the first subsystem, and the second action pattern or the second inaction pattern reflects prior actions or prior inactions related to the first subsystem, wherein the anomaly with respect to the first subsystem is predicted based on the device-related information and the determined difference while the user device is running in the post-boot environment.

7. The user device of claim 6, wherein the device-related information comprises an output from the subsystem that indicates a potential cause of the determined difference, wherein the anomaly with respect to the first subsystem is predicted based on the potential cause and the determined difference while the user device is running in the post-boot environment.

8. The user device of claim 1, wherein the processor is further configured to execute instructions that cause the user device to perform an automated test on the user device while obtaining the device anomaly information from the non-volatile memory portion in the pre-boot environment.

9. The user device of claim 1, wherein the processor is further configured to execute instructions that cause the user device to provide, via a power management subsystem, power to the non-volatile memory portion while a second non-volatile memory portion and most components of the user device remain unpowered, enabling retrieval of the device anomaly information from the non-volatile memory portion.

10. The user device of claim 9, wherein the processor is further configured to execute instructions that cause the user device to detect an auxiliary device while the non-volatile memory portion and most components of the user device remain unpowered, wherein, upon detecting the auxiliary device, power is provided to the non-volatile memory portion while the second non-volatile memory portion and most components of the user device remain unpowered, enabling retrieval of the device anomaly information.

11. The user device of claim 10, wherein the auxiliary device comprises an auxiliary memory, and wherein the processor is further configured to execute instructions that cause the user device to store, via the pre-boot diagnostic application, the device anomaly information on the auxiliary memory while running in the pre-boot environment.

12. A method of facilitating diagnostics related to a user device, the method being implemented by a processor executing computer program instructions, the method comprising:
obtaining device-related information from a subsystem of the user device while the user device is operating in a post-boot environment;
predicting, based on the device-related information, an anomaly with respect to a first subsystem of the user device while the user device is running in the post-boot environment;
storing the predicted anomaly as device anomaly information in a portion of non-volatile memory accessible in a pre-boot environment in which a pre-boot diagnostic application executes; and
obtaining, via the pre-boot diagnostic application, the device anomaly information from the non-volatile memory while the user device is running in the pre-boot environment.

13. The method of claim 12, wherein the subsystem provides input to, processes outputs from, or responds to the first subsystem.

14. The method of claim 12, further comprising processing an output of the first subsystem that is provided as an input to the subsystem, wherein the device-related information is obtained based on the processing of the output received from the first subsystem at the subsystem.

15. The method of claim 12, wherein the device-related information comprises an output from the subsystem, the method further comprising determining an inconsistency between the output of the subsystem and an action or an inaction of the first subsystem, wherein the anomaly with respect to the first subsystem is predicted based on the determined inconsistency while the user device is running in the post-boot environment.

16. The method of claim 12, further comprising:
detecting an auxiliary device while the non-volatile memory portion and most components of the user device remain unpowered; and
providing, responsive to detecting the auxiliary device, power to the non-volatile memory portion while a second non-volatile memory portion and most components of the user device remain unpowered, enabling retrieval of the device anomaly information from the non-volatile memory portion.

17. The method of claim 16, wherein the auxiliary device comprises an auxiliary memory, the method further comprising storing, via the pre-boot diagnostic application, the device anomaly information on the auxiliary memory while the user device is running in the pre-boot environment.

18. A non-transitory computer-readable medium storing instructions that, when executed by a processor of a user device, cause the user device to:
obtain device-related information from a subsystem of the user device while the user device is operating in a post-boot environment;
predict, based on the device-related information, an anomaly with respect to a first subsystem of the user device while the user device is operating in the post-boot environment;
store the predicted anomaly as device anomaly information in a portion of non-volatile memory of the user device, the non-volatile memory portion being preserved during a factory reset of the user device; and
obtain the device anomaly information from the non-volatile memory portion via a pre-boot diagnostic application while the user device is running in a pre-boot environment.

19. The non-transitory computer-readable medium of claim 18, wherein the instructions further cause the user device to encrypt the device anomaly information prior to storing the device anomaly information in the non-volatile memory portion, wherein the device anomaly information is encrypted using a public key of a public/private keypair generated on the user device.

20. The non-transitory computer-readable medium of claim 19, wherein a private key of the public/private keypair is deleted from the user device upon the factory reset of the user device, and wherein the public key is transmitted to a remote server that retains access to decrypt the device anomaly information after the factory reset.
